(19) United States
(12) Patent Application Publication
(10) Pub. No.: US 2018/0327668 A1
(43) Pub. Date: Nov. 15, 2018

(54) COMPOUND CONTAINING MESOGENIC GROUP AND COMPOSITION CONTAINING THE COMPOUND, AND POLYMER OBTAINED BY POLYMERIZING POLYERMIZABLE COMPOSITION, OPTICALLY ANISOTROPIC BODY, AND PHASE DIFFERENCE FILM

(71) Applicant: DIC Corporation, Tokyo (JP)

(72) Inventors: Masahiro Horiguchi, Kita-adachi-gun (JP); Mika Takasaki, Kita-adachi-gun (JP); Yasuhiro Kuwana, Kita-adachi-gun (JP)

(73) Assignee: DIC Corporation, Tokyo (JP)

(21) Appl. No.: 15/757,409

(22) PCT Filed: Jul. 14, 2016
(86) PCT No.: PCT/JP2016/070830

§ 371 Date: Jul. 20, 2018

(30) Foreign Application Priority Data
Sep. 3, 2015 (JP) 2015-173757

(51) Int. Cl. C09K 19/38

(52) U.S. Cl. CPC C09K 19/3814; C09K 2019/0448

(57) ABSTRACT

The polymerizable composition includes a compound which is reverse wavelength dispersive or low wavelength dispersive and has at least one mesogenic group, the mixture satisfying Expression (1). In the expression (1), YI represents a yellowness index of the compound and Δn represents a refractive index anisotropy at a wavelength of 550 nm in the case of being formed into a film: 0.5≤YI/Δn≤500 Expression (1).

### TECHNICAL FIELD

The present invention relates to a mixture having a value of YI/An falling within a specific range, a composition containing the mixture, a polymer obtained by polymerizing a polymerizable composition, an optically anisotropic body obtained by polymerizing the polymerizable composition, and a phase difference film obtained by polymerizing the polymerizable composition, and relates to a display device, an optical element, a light-emitting device, a printed material, an optical information recording apparatus, and the like, which have the optically anisotropic body.

### BACKGROUND ART

A compound having a mesogenic group is used for various optical materials. A polymer having uniform alignment is prepared by, for example, aligning apolymerizable composition containing a compound having a mesogenic group in a liquid crystal state and then polymerizing (PTL 1). Such a polymer can be used for a polarizing plate, a phase difference plate, and the like which are necessary for a display. In many cases, in order to satisfy required optical properties, polymerization rate, solubility, melting point, glass transition temperature, polymer transparency, mechanical strength, surface hardness, heat resistance, and light resistance, a polymerizable composition containing two or more compounds having a mesogenic group is used. At that time, it is required for the compound having a mesogenic group to be used to provide favorable physical properties to the polymerizable composition without adversely affecting other properties.

In order to improve a viewing angle of a liquid crystal display, it is required to reduce wavelength dispersibility of birefringence of a phase difference film or to reverse the wavelength dispersibility. As a material for the above purpose, various compounds having a mesogenic group which have reverse wavelength dispersibility or low wavelength dispersibility have been developed. Such compounds having a mesogenic group have problems in that repellence is likely to be generated in the case where the compound is added to a polymerizable composition, and the resultant is applied onto a substrate and then polymerized, and that alignment defects are likely to occur in the case where the obtained film-like polymer is irradiated with ultraviolet light. In the case where a film in which the repellence and alignment defects occurred is used, for example, in a display, there are problems that unevenness in the brightness of a screen is generated, a color tone is unnatural, intended optical characteristics cannot be obtained, thus greatly deteriorating the quality of a display product. Therefore, there has been a demand for development of the compounds having a mesogenic group which have reverse wavelength dispersibility or low wavelength dispersibility and by which such problems can be solved.

### CITATION LIST

### Patent Literature

[PTL 1] JP-A-2006-39164

### SUMMARY OF INVENTION

### Technical Problem

An object of the present invention is to provide a polymerizable composition in which the repellence is unlikely to be generated in the case of being formed into a film-like polymer, and in which the alignment defects are unlikely to occur in the case where the obtained film-like polymer is irradiated with ultraviolet light. Furthermore, another object of the present invention is to provide a polymer obtained by polymerizing the polymerizable composition and an optically anisotropic body using the polymer.

### Solution to Problem

According to the present invention, there is provided a mixture including a compound which is reverse wavelength dispersive or low wavelength dispersive and has at least one mesogenic group, the mixture satisfying Expression (1):

0.5≤YI/Δn≤500 Expression (1)

(in the expression, YI represents a yellowness index of the compound and Δn represents a refractive index anisotropy at a wavelength of 550 nm in the case of being formed into a film).

According to the present invention, there is further provided a composition containing the mixture, a polymer, an optically anisotropic body, and a phase difference film.

### Advantageous Effects of Invention

In the mixture of the present invention, the repellence is unlikely to be generated in the case where the composition is constituted so as to prepare the optically anisotropic body. The optically anisotropic body using the composition containing the mixture of the present invention is useful for optical materials such as phase difference films from the viewpoint that the alignment defects are unlikely to occur in the case of irradiation with ultraviolet light.

### DESCRIPTION OF EMBODIMENTS

A best embodiment of the present invention will be described below.

In the present invention, the term “mixture” refers to a mixture containing a compound which is reverse wavelength dispersive or low wavelength dispersive and has at least one mesogenic group (hereinafter, will be referred to as a compound having a mesogenic group) and containing impurities which are inevitably mixed at the time of preparing the compound having a mesogenic group. The impurities mean components other than the compound having a mesogenic group in the mixture. In general, the compound having a mesogenic group is prepared through a purification step, but it is difficult to completely remove the impurities to zero even if the compound is subjected to the purification step. Therefore, in practice, few impurities are contained in accordance with a purification degree and the like. In the present invention, such a compound containing impurities is referred to as the “mixture” in order to clearly distinguish from a compound itself which does not contain impurities.

The mixture contains impurities, and a content of the compound in the mixture is 70.0% by mass or higher, preferably 80.0% by mass or higher, more preferably 85.0% by mass or higher, and particularly preferably 90.0% by mass or higher.

The term “composition” in the present invention means a composition containing one or two or more of the mixtures and containing a compound not containing a mesogenic group, stabilizers, organic solvents, polymerization inhibitors, antioxidants, photopolymerization initiators, thermal polymerization initiators, surfactants, and the like, if necessary. The composition is distinguished from the mixture in that the mixture of the present invention consists of the compound having a single mesogenic group and the impurities, whereas the composition of the present invention contains one mixture and one or two or more of additives or contains two or more mixtures and, if necessary, additives. In the following description, the polymerizable composition is sometimes referred to as a polymerizable liquid crystal composition, and the term “liquid crystal” means that the polymerizable composition exhibits liquid crystallinity in the case where the polymerizable composition is applied, printed, or dropped on a substrate, or injected into a cell, or the like, and the composition itself does not necessarily exhibit liquid crystallinity.

The impurities are removed from the mixture in the purification step, but there is a problem that a yield is deteriorated by undergoing the purification step. It is considered that the reasons thereof are that the compound is removed together with the impurities from the mixture by undergoing the purification step, and the compound is adsorbed to the purification agent. It is also considered that the reasons thereof are that a large amount of the compound is incorporated into the impurities in the purification step, and in the case where the mixture contains a compound having a polymerizable group, polymer components of the impurities contained in the mixture in a small amount aggregate to each other, which leads to complicated filtration.

When a yellowness index (YI) of the mixture of the present invention is measured, the more refined the mixture is, the lower the yellowness index tends to be. The inventors of the present invention focused attention on the mixture containing the compound having a mesogenic group and as a result of extensive studies, the inventors have found that the yellowness index (YI) of the mixture and a value of a refractive index anisotropy (Δn) of the compound are related to a yield. As a result of further studies on the yellowness index (YI) of the mixture and the value of the refractive index anisotropy (Δn) of the compound, the inventors of the present invention have found that these values have an influence on the generation of the repellence in the case where the composition containing the mixture is applied onto a substrate, and on the alignment defects in the case of using the composition for an optically anisotropic body and performing irradiation with ultraviolet light.

That is, the mixture of the present invention is a mixture satisfying an expression represented by 0.5≤YI/Δn≤500 Expression (1) (in the expression, YI represents a yellowness index of the mixture and Δn represents a refractive index anisotropy of the compound having a mesogenic group).

If the mixture is a mixture satisfying Expression (1), a high yield can be obtained since a purification degree is within an appropriate range. If the mixture is a mixture satisfying Expression (1), it is possible to obtain an optically anisotropic body in which the repellence occurs less and the alignment defects are less in the case of irradiation with ultraviolet light. There is a possibility that an amount of polymer components in the composition, a molecular structure of the compound, and the like affect the generation of the repellence, but it is considered that the mixture within the above range has appropriate polymer components and rigidity of the compound. In addition, as a cause of affecting alignment properties, there is a function of a polymer which is formed by partial polymerization of a compound and which has a mesogenic skeleton similar to that of the compound, but in the mixture within the above range, it is considered that the polymer components are uniformly dispersed, or the rigidity is not excessively high in terms of the structure of the mesogenic skeleton and there is intermolecular interaction between a mesogenic site in the polymer components and a mesogenic site of the compound, and thus, an alignment effect by the polymer components is effectively obtained.

From the viewpoint of obtaining a high yield, a value of YI/Δn of the mixture is preferably 0.9 or more, more preferably 1.2 or more, and still more preferably 1.5 or more, still more preferably 2.0 or more, and particularly preferably 3.0 or more. In addition, the value is preferably 450 or less, more preferably 400 or less, still more preferably 150 or less, still more preferably 50 or less, and particularly preferably 10 or less.

From the viewpoint of obtaining the mixture having favorable repellence and alignment properties, a value of YI/Δn of the mixture is preferably 450 or less, more preferably 400 or less, still more preferably 150 or less, still more preferably 50 or less, and particularly preferably 10 or less.

A yellowness index (YI) of the mixture is measured by means of a spectrophotometer using an acetonitrile solution containing the mixture of the present invention in a proportion of 20 ppm as a measurement object. A solution other than acetonitrile may be used as long as it is a solution in which sufficient solubility of the mixture can be obtained. Examples thereof include tetrahydrofuran, cyclopentanone, chloroform, and the like. The obtained measurement value is measured using a cell having an optical path length of 1 cm while a concentration of a material solution is set to 20 ppm, and thus, a yellowness index (YI) of the mixture can be calculated.

A refractive index anisotropy of the compound is measured as follows. A compound (10% by mass, 20% by mass, or 30% by mass) having a mesogenic group is mixed to a host liquid crystal consisting of a compound represented by Formula (a) (25% by mass), a compound represented by Formula (b) (25% by mass), a compound represented by Formula (c) (25% by mass), and a compound represented by Formula (d) (25% by mass) to prepare a liquid crystal composition.

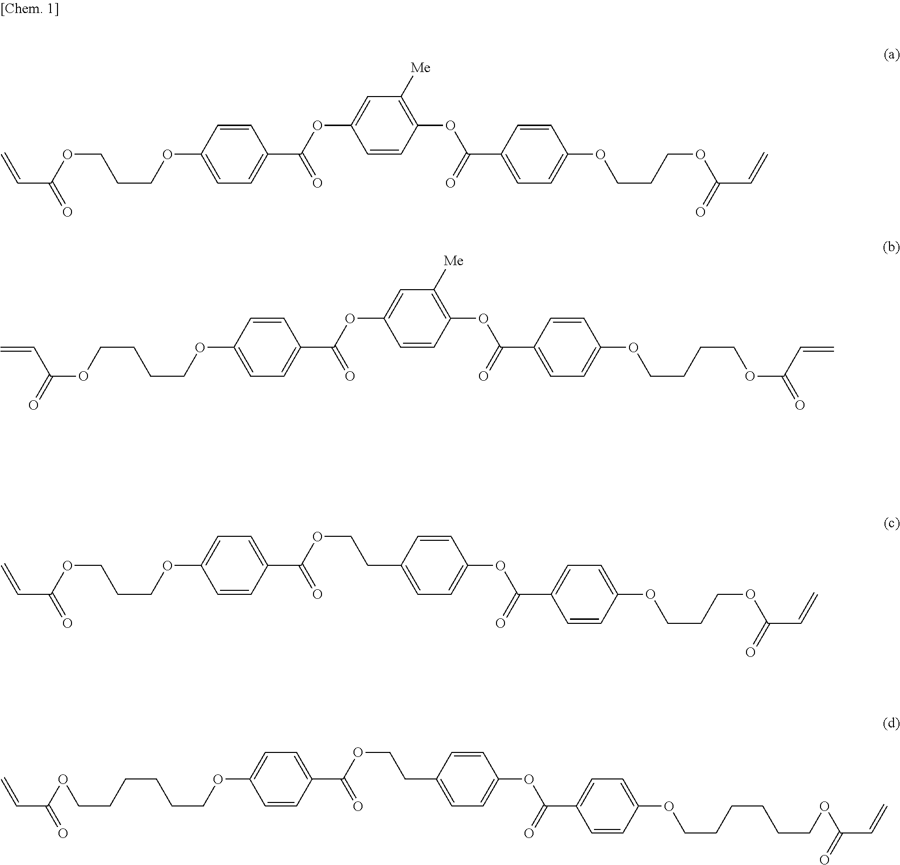

A glass substrate provided with a polyimide alignment film is used and two glass substrates were combined so that rubbing directions of the polyimide alignment films become parallel to each other, thereby preparing a glass cell. After injecting the liquid crystal composition into the glass cell, the film is cured by irradiation with ultraviolet light (illuminance: 800 mJ/cm²), and then the film is peeled off from the glass cell. Thereafter, “ne” and “no” of the film are measured with an Abbe refractometer, and a refractive index anisotropy (Δn) extrapolated such that the compound having a mesogenic group becomes 100% by mass is calculated.

The yellowness index (YI) of the mixture is divided by the refractive index anisotropy of the compound having a mesogenic group, thereby obtaining a value of YI/Δn.

(Reverse Wavelength Dispersive or Low Wavelength Dispersive Compound)

A liquid crystal compound having one or more mesogenic groups of the present invention has a characteristic that birefringence of the compound is larger on a long wavelength side than on a short wavelength side in a visible light region. Specifically, as long as Expression (2) is satisfied, the birefringence is not required to be larger on the long wavelength side than on the short wavelength side in an ultraviolet region and an infrared region.

Re(450 nm)/Re(550 nm)<1.05 Expression(2)

(In the expression, Re (450 nm) represents an in-plane phase difference at a wavelength of 450 nm in the case where the molecules of the liquid crystal compound having one or more mesogenic groups are aligned on a substrate such that a major axis direction of each molecule is aligned substantially horizontally with respect to the substrate, and Re (550 nm) represents an in-plane phase difference at a wavelength of 550 nm in the case where the molecules of the liquid crystal compound having one mesogenic group are aligned on a substrate such that a major axis direction of each molecule is aligned substantially horizontally with respect to the substrate.)

In regard to the compound which has one mesogenic group, which satisfies Expression (2) and has one mesogenic group, Expression (2) is preferably less than 1.05, more preferably less than 1.00, still more preferably less than 0.95, and particularly preferably less than 0.90 from the viewpoint of exhibiting reverse wavelength dispersibility.

In a graph in which a wavelength λ of incident light on a phase difference film is plotted on a transverse axis and a birefringence Δn is plotted on a vertical axis, it is generally referred by those skilled in the art that the film is “positively dispersive” in the case where the birefringence Δn becomes larger as the wavelength λ becomes shorter, and the film is “reverse wavelength dispersive” or “reverse dispersive” in the case where the birefringence Δn becomes smaller as the wavelength, becomes shorter. In the present invention, a compound constituting a phase difference film in which a value Re (450)/Re (550) obtained by dividing an in-plane phase difference (Re (450)) at a wavelength of 450 nm by an in-plane phase difference Re (550) at a wavelength of 550 nm is 0.95 or less, is referred to as a reverse dispersive compound. A compound constituting a phase difference film in which Re (450)/Re (550) is more than 0.95 and 1.05 or less is referred to as a low wavelength dispersive compound. A method for measuring the phase difference is as follows.

(Compound Having Mesogenic Group)

As the compound having at least one mesogenic group, in the related field, as long as the compound exhibits a liquid crystal phase in the case where a plurality of compounds are mixed to form a composition, a compound having one or more polymerizable functional groups in a molecule or a compound having no polymerizable functional group in a molecule may be used without particular limitation. Further, the polymerizable liquid crystal compound alone may not exhibit liquid crystallinity. Here, the mesogenic group is a group composed of two or more ring structures and a linking group which links these ring structures or a single bond, and the group means a portion in which two or more ring structures are linked by a linking group having 2 or fewer atoms having a bond site connecting the ring structure and the ring structure in the shortest path or a single bond.

Examples of the reverse wavelength dispersive or low wavelength dispersive compound having at least one mesogenic group include those described in JP-A-2010-31223, JP-A-2009-173893, JP-A-2010-30979, JP-A-2009-227667, JP-A-2009-274984, JP-A-2011-207765, JP-A-2011-42606, JP-A-2011-246381, JP-A-2012-77055, JP-A-2011-6360, JP-A-2011-6361, JP-A-2008-107767, JP-A-2008-273925, JP-A-2009-179563, JP-A-2010-84032, WO2012/141245 A1, WO2012/147904 A1, WO2013/180217 A1, WO2014/010325 A1, WO2014/065176 A1, WO2012/169424 A1, WO2012/176679 A1, WO2014/061709 A1, JP-T-2010-522892, and JP-T-2013-509458.

More specifically, as the reverse wavelength dispersive or low wavelength dispersive compound having at least one mesogenic group, a compound represented by General Formula (I) is preferable.

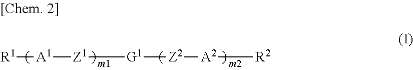

(In the formula, R¹ and R² each independently represent a hydrogen atom or a hydrocarbon group having 1 to 80 carbon atoms, the group may have a substituent, and an arbitrary carbon atom may be substituted with a hetero atom,

A¹ and A² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups may be unsubstituted or substituted with one or more of the above-described substituents L,

L represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more non-adjacent —CH₂-'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH—═CH—, —CH═CH—, —CF═CF—, or —C≡C—, an arbitrary hydrogen atom in the alkyl group may be substituted with a fluorine atom, or L may represent a group represented by P^{L}-(Sp^{L}-X^{L})_{kL}— in which P^{L} represents a polymerizable group and a preferred polymerizable group therefor is the same as in the following case of P⁰, Sp^{L} represents a spacer group or a single bond, a preferred spacer group therefor is the same as in the following case of Sp⁰ and in the case where a plurality of Sp^{L}'s are present, these may be the same as or different from each other, X^{L} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{L}'s are present, these may be the same as or different from each other, with the proviso that P^{L}-(Sp^{L}-X^{L})_{kL}— does not contain an —O—O— bond, kL represents an integer of 0 to 10, and in the case where a plurality of L's are present in the compound, these may be the same as or different from each other,

Z¹ and Z² each independently represent a group represented by —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in the case where a plurality of Z¹'s are present, these may be the same as or different from each other, and in the case where a plurality of Z²'s are present, these may be the same as or different from each other, but in the case where the plurality of Z¹'s and Z²'s are present, at least one of Z¹ and Z² each independently represent a group selected from —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —NH—O—, —O—NH—, —SCH₂—, —CH₂S—, —CF₂O—, —OCF₂—, —CF₂S—, —SCF₂—, —CH═CH—, —N═N—, —CH═N—, —N═CH—, —CF═CF—, —C≡C—, or a single bond,

G¹ represents a divalent group having at least one aromatic ring selected from the group consisting of an aromatic hydrocarbon ring or an aromatic heterocyclic ring, the number of π electrons contained in the aromatic ring in the group represented by G¹ is 12 or higher, and the group represented by G¹ may be unsubstituted or substituted with one or more substituents L^{G}'s,

L^{G} represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more non-adjacent —CH₂-'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, an arbitrary hydrogen atom in the alkyl group may be substituted with a fluorine atom, or L^{G} may represent a group represented by P^{LG}-(Sp^{LG}-X^{LG})_{kLG}— in which P^{LG} represents a polymerizable group and a preferred polymerizable group therefor is the same as that defined for P⁰ above, Sp^{LG} represents a spacer group or a single bond and a preferred spacer group therefor represents the same as that defined for Sp⁰, in the case where a plurality of Sp^{LG}'s are present, these are the same as or different from each other, X^{LG} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{LG}'s are present, these may be the same as or different from each other, with the proviso that P^{LG}-(Sp^{LG}-X^{LG})_{kLG}— does not contain an —O—O— bond, kLG represents an integer of 0 to 10, and in the case where a plurality of L^{G}'s are present in the compound, these may be the same as or different from each other, and

m1 and m2 each independently represent an integer of 0 to 6, provided that m1+m2 represents an integer of 0 to 6.)

From the viewpoint of mechanical strength in the case where the compound is a film, it is preferable that the reverse wavelength dispersive or low wavelength dispersive compound having at least one mesogenic group has at least one polymerizable group in a molecule thereof. From the viewpoint of liquid crystallinity, it is more preferable that the molecule has at least one group represented by General Formula (I-0-R).

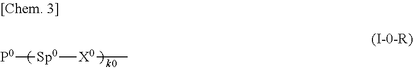

(In the formula, P⁰ represents a polymerizable group, Sp⁰ represents a spacer group or a single bond and in the case where a plurality of Sp⁰'s are present, these may be the same as or different from each other, X⁰ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X⁰'s are present, these may be the same as or different from each other, with the proviso that P⁰-(Sp⁰-X⁰)ₖ₀— does not contain an —O—O— bond, and k0 represents an integer of 0 to 10.)

In Formula (I-0-R), P⁰ represents a polymerizable group, and P⁰ preferably represents a group selected from Formulas (P-1) to (P-20).

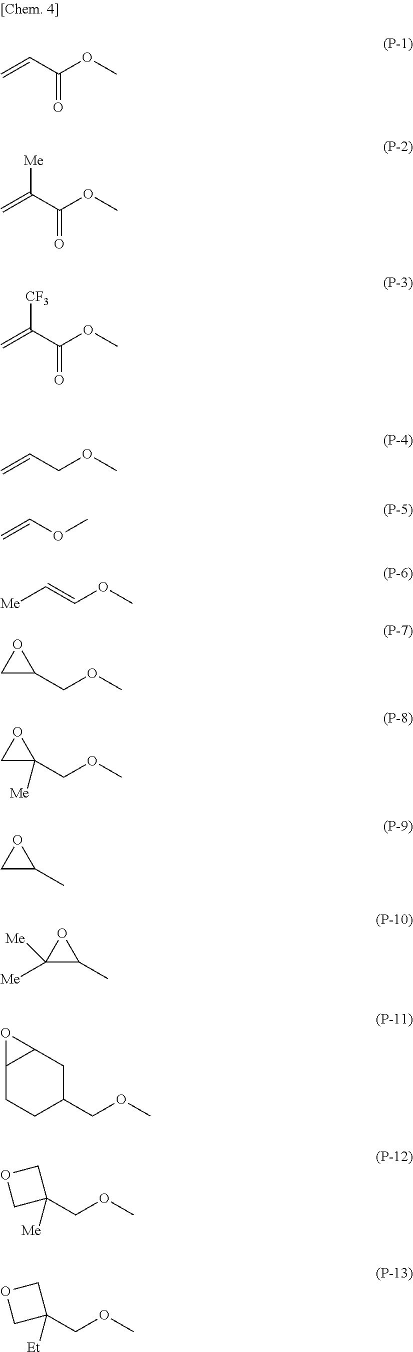

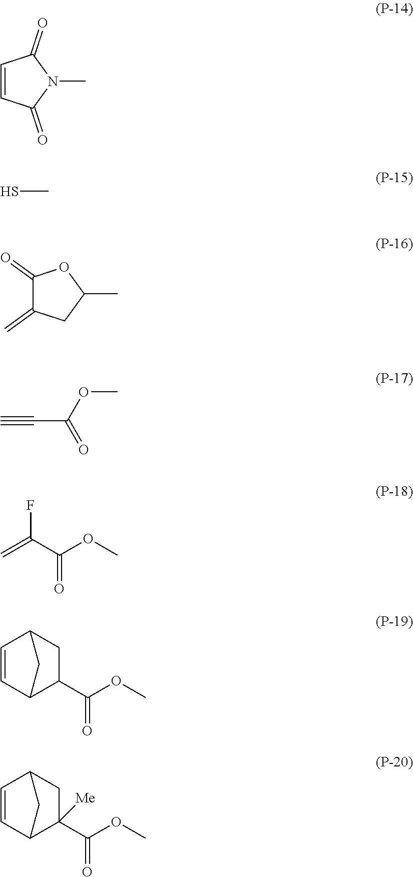

These polymerizable groups are polymerized by radical polymerization, radical addition polymerization, cationic polymerization, and anionic polymerization. In particular, in the case where ultraviolet polymerization is carried out as a polymerization method, Formula (P-1), Formula (P-2), Formula (P-3), Formula (P-4), Formula (P-5), Formula (P-7), Formula (P-11), Formula (P-13), Formula (P-15), or Formula (P-18) is preferable, Formula (P-1), Formula (P-2), Formula (P-3), Formula (P-7), Formula (P-11), or Formula (P-13) is more preferable, Formula (P-1), Formula (P-2), or Formula (P-3) is still more preferable, and Formula (P-1) or Formula (P-2) is particularly preferable.

In Formula (I-0-R), Sp⁰ represents a spacer group or a single bond and in the case where a plurality of Sp⁰'s are present, these may be the same as or different from each other. The spacer group may be unsubstituted or substituted with one or more substituents L. The spacer group may be substituted with a substituent L^{SP}, and preferably represents an alkylene group having 1 to 20 carbon atoms in which one —CH₂— or two or more non-adjacent —CH₂-'s may be independently substituted with —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, or —C≡C—. In the case where a plurality of Sp⁰'s are present from the viewpoints of easy availability of raw materials and ease of synthesis, these may be the same as or different from each other. Sp⁰'s each may be independently substituted with a substituent L^{SP} and it is preferable that Sp⁰'s each independently represent an alkylene group having 1 to 20 carbon atoms in which one —CH₂- or two or more non-adjacent —CH₂-'s may be independently substituted with —O—, —COO—, —OCO—, —OCO—O—, —CO—NH—, —NH—CO—, —CH═CH—, or —C≡C—. Sp⁰'s each may be independently substituted with a methyl group and it is more preferable that Sp⁰ each independently represent an alkylene group in which one —CH₂— or two or more non-adjacent —CH₂-'s may be independently substituted with —O—, —COO—, or —OCO—, and which has 1 to 10 carbon atoms or a single bond. It is still more preferable that Sp⁰'s each independently represent an alkylene group having 1 to 10 carbon atoms or a single bond. In the case where the plurality of Sp⁰'s are present, these may be the same as or different from each other. It is particularly preferable that Sp⁰'s each independently represent an alkylene group having 1 to 8 carbon atoms.

In Formula (I-0-R), L^{SP} represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more non-adjacent —CH₂— may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—. An arbitrary hydrogen atom in the alkyl group may be substituted with a fluorine atom, or L^{SP} may represent a group represented by P^{LSP}-(Sp^{LSP}-X^{LSP})_{kLSP}— in which P^{LSP} represents a polymerizable group and a preferred polymerizable group therefor is the same as that of the case of P⁰ above, Sp^{LSP} is a spacer group or a single bond, a preferred spacer group therefor or a single bond is the same as that of the case of Sp⁰, and in the case where a plurality of Sp^{LSP}'s are present, these may be the same as or different from each other, X^{LSP} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond and in the case where a plurality of X^{LSP}'s are present, these may be the same as or different from each other, with the proviso that P^{LSP}-(S^{LSP}-X^{LSP})_{kLSP}— does not contain an —O—O— bond, kLSP represents an integer of 0 to 10, and in the case where a plurality of L^{sp}'s are present in the compound, these may be the same as or different from each other. From the viewpoints of easy availability of raw materials and ease of synthesis, L^{SP} represents a fluorine atom, a chlorine atom, a cyano group, or a linear or branched alkyl group having 1 to 10 carbon atoms in which one —CH₂— or two or more non-adjacent —CH₂-'s may be independently substituted with —O—, —S—, —CO—, —COO—, —OCO—, —CH═CH—, or —C≡C—. An arbitrary hydrogen atom in the alkyl group may be substituted with a fluorine atom, or L^{SP} preferably represents a group represented by P^{LSP}-(sp^{LSP}-X^{LSP})_{kLSP}. L^{SP} represents a fluorine atom or a linear alkyl group having 1 to 10 carbon atoms in which one —CH₂— or two or more non-adjacent —CH₂-'s may be independently substituted with —O—, —COO—, or —OCO—. It is more preferable that an arbitrary hydrogen atom in the alkyl group represents a group which may be substituted with a fluorine atom. It is still more preferable that L^{SP} represents a fluorine atom or a methyl group. It is particularly preferable that L^{SP} represents a methyl group.

In Formula (I-0-R), X⁰ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and X⁰ may be the same as or different from each other in the case where a plurality of X⁰'s are present. From the viewpoints of easy availability of raw materials and ease of synthesis, it is preferable that X⁰ each independently represent —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂—COO—, —CH₂CH₂—OCO—, or a single bond, and in the case where a plurality of X⁰'s are present, X⁰'s may be the same as or different from each other. It is more preferable that X⁰ each independently represent —O—, —OCH₂—, —CH₂O—, —COO—, —OCO—, —COO—CH₂CH₂—, —OCO—CH₂CH₂—, —CH₂CH₂—COO—, —CH₂CH₂—OCO—, or a single bond, and X⁰'s may be the same as or different from each other in the case where a plurality of X⁰'s are present. It is particularly preferable that X⁰ each independently represent —O—, —COO—, —OCO—, or a single bond.

In Formula (I-0-R), k0 represents an integer of 0 to 10, preferably an integer of 0 to 5, more preferably an integer of 0 to 2, and particularly preferably 1.

From the viewpoints of liquid crystallinity and ease of synthesis, it is preferable that at least one of R¹ and R² in General Formula (I) represents a group represented by Formula (I-0-R). From the viewpoint of mechanical strength in the case where the compound is a film, it is more preferable that R¹ and R² each independently represent a group represented by Formula (I-0-R), and it is particularly preferable that R¹ and R² each independently represent the same group represented by Formula (I-0-R).

In General Formula (I), R¹ and R² each may independently represent a hydrogen atom or a hydrocarbon group having 1 to 80 carbon atoms which may have a substituent, in which an arbitrary carbon atom may be substituted with a hetero atom. In the case where R¹ or R² represents a group other than the group represented by Formula (I-0-R), from the viewpoints of liquid crystallinity and ease of synthesis, it is preferable that R¹ or R² each independently represent a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more non-adjacent —CH₂-'s may be independently substituted with —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, or —C≡C—. It is more preferable that R¹ or R² each independently represent a hydrogen atom, a fluorine atom, or a chlorine atom, or a linear or branched alkyl group having has 1 to 12 carbon atoms in which one —CH₂— or two or more non-adjacent —CH₂-'s may be independently substituted with —O—, —COO—, —OCO—, or —O—CO—O—. It is still more preferable that R¹ or R² each independently represent a hydrogen atom, a fluorine atom, or a chlorine atom, or a linear alkyl group or a linear alkoxy group having 1 to 12 carbon atoms. It is particularly preferable that R¹ or R² each independently represent a linear alkyl group or a linear alkoxy group having 1 to 12 carbon atoms.

In General Formula (I), A¹ and A² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group. These groups may be unsubstituted or substituted with one or more of the substituents L described above. As preferred forms, it is more preferable that A¹ and A² each independently represent a 1,4-phenylene group, a 1,4-cyclohexylene group, and a naphthalene-2,6-diyl group which may be unsubstituted or substituted with one or more of the substituents L. It is still more preferable that A¹ and A² each independently represent a group selected from Formulas (A-1) to Formula (A-11).

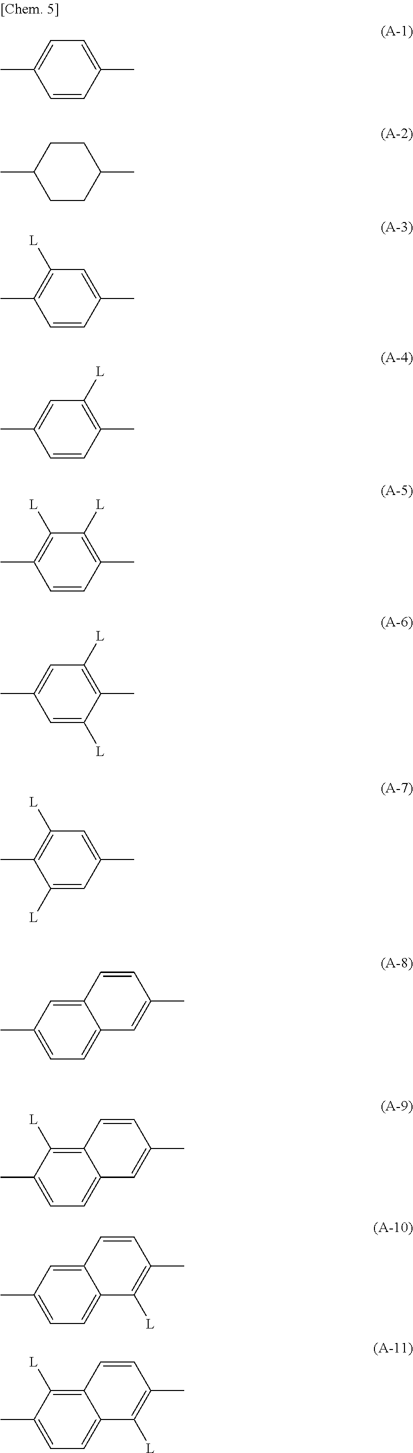

It is still more preferable that A¹ and A² each independently represent a group selected from Formulas (A-1) to (A-8). It is particularly preferable that A¹ and A² each independently represent a group selected from Formulas (A-1) to (A-4). From the viewpoint of reverse dispersibility, with respect to a group represented by A¹ bonded to a group represented by Z¹ adjacent to a group represented by G¹, and a group represented by A² bonded to a group represented by Z² adjacent to a group represented by G¹, it is preferable that A¹ and A² each independently represent a 1,4-cyclohexylene group which may be unsubstituted or substituted with one or more of the substituents L. It is more preferable that A¹ and A² each independently represent a group represented by Formula (A-2). In the case where a plurality of groups represented by A¹ and A² are present, from the viewpoints of refractive index anisotropy, ease of synthesis, and solubility in a solvent, as groups represented by A¹ and A² other than the above A¹ and the A², it is preferable that A¹ and A² each independently represent a 1,4-phenylene group or a naphthalene-2,6-diyl group which may be unsubstituted or substituted with one or more of the substituents L. It is more preferable that A¹ and A² each independently represent a group selected from Formula (A-1) and Formulas (A-3) to (A-11). It is still more preferable that A¹ and A² each independently represent a group selected from Formula (A-1) and Formulas (A-3) to (A-8). It is particularly preferable that A¹ and A² each independently represent a group selected from Formulas (A-1), (A-3), and (A-4).

In General Formula (I), L represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more non-adjacent —CH₂-'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—. An arbitrary hydrogen atom in the alkyl group may be substituted with a fluorine atom. Alternatively, L may represent a group represented by P^{L} (Sp^{L}-X^{L})_{kL}— in which P^{L} represents a polymerizable group and a preferable polymerizable group therefore is the same as that of the case of P⁰ below, Sp^{L} represents a spacer group or a single bond, a preferred spacer group therefor or a single bond is the same as that of the case of Sp⁰ above, and in the case where a plurality of Sp^{L}'s are present, these may be the same as or different from each other, X^{L} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{L}'s are present, these may be the same as or different from each other, with the proviso that P^{L}-(Sp^{L}-X^{L})_{kL}— does not contain an —O—O— bond, kL represents an integer of 0 to 10, and in the case where plurality of L's are present in the compound, these may be the same as or different from each other. From the viewpoints of liquid crystallinity and ease of synthesis, it is preferable that L represents a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which an arbitrary hydrogen atom may be substituted with a fluorine atom and one —CH₂— or two or more non-adjacent —CH₂-'s may be independently substituted with a group selected from —O—, —S—, —CO—, —COO—, —OCO—, —O—CO—O—, —CH═CH—, —CF═CF—, or —C≡C—. It is more preferable that L represents a fluorine atom, a chlorine atom, or a linear or branched alkyl group having 1 to 12 carbon atoms in which an arbitrary hydrogen atom may be substituted with a fluorine atom and one —CH₂— or two or more non-adjacent —CH₂-'s may be independently substituted with a group selected from —O—, —COO—, or —OCO—. It is still more preferable that L represents a fluorine atom, a chlorine atom, or a linear or branched alkyl group or alkoxy group having 1 to 12 carbon atoms in which an arbitrary hydrogen atom may be substituted with a fluorine atom. It is particularly preferable that L represents a fluorine atom, a chlorine atom, or a linear alkyl group or a linear alkoxy group having 1 to 8 carbon atoms.

In General Formula (I), Z¹ and Z² each independently represent a group represented by —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond. In the case where a plurality of Z¹'s are present, these may be the same as or different from each other, and in the case where a plurality of Z²'s are present, these may be the same as or different from each other. In the case where the plurality of Z¹'s and Z²'s are present, at least one of Z¹ and Z² represents a group selected from —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —NH—O—, —O—NH—, —SCH₂—, —CH₂S—, —CF₂O—, —OCF₂—, —CF₂S—, —SCF₂—, —CH═CH—, —N═N—, —CH═N—, —N═CH—, —CF═CF—, —C≡C—, or a single bond. From the viewpoints of liquid crystallinity, ease of availability of raw materials, and ease of synthesis, it is preferable that Z¹ and Z² each independently represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond. It is more preferable that Z¹ and Z² each independently represent —OCH₂—, —CH₂O—, —COO—, —OCO—, —CF₂O—, —OCF₂—, —CH₂CH₂—, —COO—CH₂CH₂—, —OCO—CH₂CH₂—, —CH₂CH₂—COO—, —CH₂CH₂—OCO—, —CH═CH—, —C≡C—, or a single bond. It is still more preferable that Z¹ and Z² each independently represent —OCH₂—, —CH₂O—, —COO—, —OCO—, —CF₂O—, —OCF₂—, or a single bond. It is particularly preferable that Z¹ and Z² each independently represent —OCH₂—, —CH₂O—, —COO—, —OCO, or a single bond.

In General Formula (I), m1 and m2 each independently represent an integer of 0 to 6, provided that m1+m2 represents an integer of 0 to 6. From the viewpoints of solubility in a solvent and liquid crystallinity, it is preferable that m1 and m2 each independently represent an integer of 1 to 3, and it is particularly preferable that m1 and m2 each independently represent 1 or 2. From the viewpoint of ease of synthesis, it is more preferable that m1 and m2 are the same.

In General Formula (I), G¹ represents a divalent group having at least one aromatic ring selected from the group consisting of an aromatic hydrocarbon ring or an aromatic heterocyclic ring, the number of π electrons contained in the aromatic ring in the group represented by G¹ is 12 or higher, and the group represented by G¹ may be unsubstituted or substituted with one or more substituents L^{G}'s. From the viewpoint of reverse wavelength dispersibility, G¹ is preferably a group having an absorption maximum from 300 nm to 900 nm and is more preferably a group having an absorption maximum from 310 nm to 500 nm. From the viewpoints of the liquid crystallinity, ease of availability of raw materials, and ease of synthesis of the compound, it is more preferable that G¹ represents a group selected from Formulas (M-1) to (M-6).

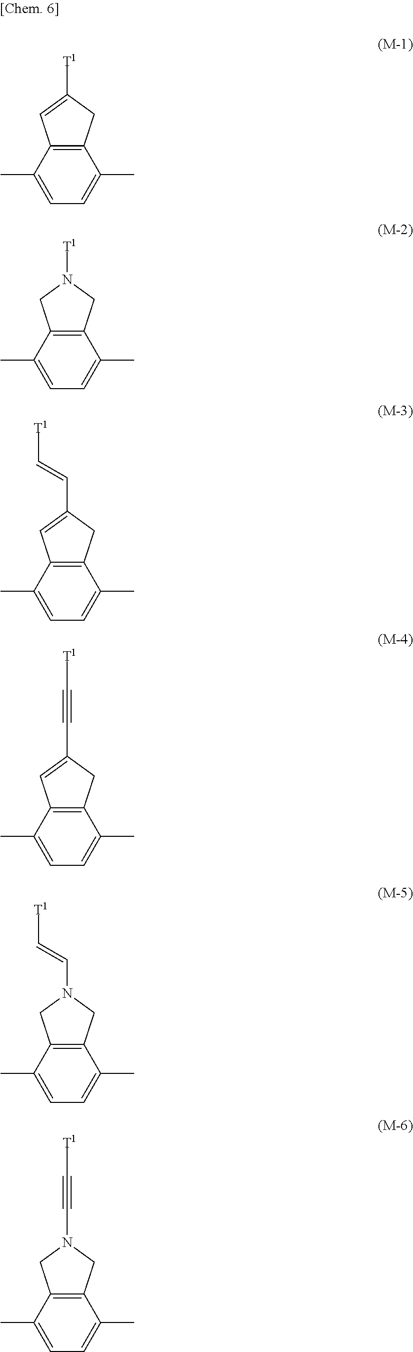

(In the formulas, these groups may be unsubstituted or substituted with one or more of the substituents L^{G}'S above, an arbitrary —CH═ may be independently substituted with —N═, —CH₂— may be independently substituted with —O—, —S—, —NR^{T}-(where R^{T} represents a hydrogen atom or an alkyl group having 1 to 20 carbon atoms), —CS—, or —CO—, and T¹ represents a group selected from Formulas (T1-1) to (T1-6).)

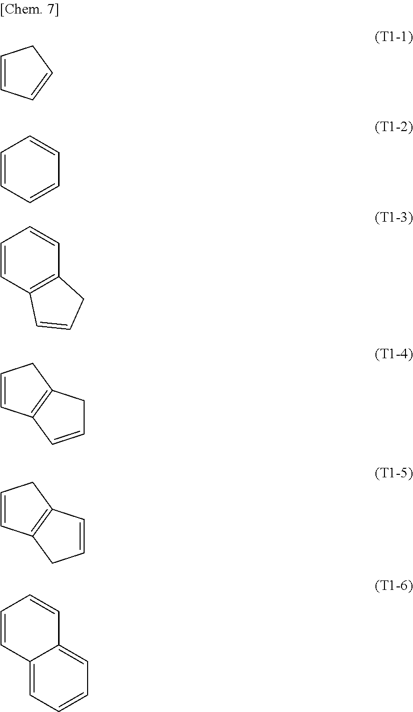

(In the formulas, a bond site may be provided at an arbitrary position, an arbitrary —CH═ may be independently substituted with —N═, and each —CH₂— may be independently substituted with —O—, —S—, —NR^{T}— (where R^{T} represents a hydrogen atom or an alkyl group having 1 to 20 carbon atoms), —CS—, or —CO—. A bond site being provided at an arbitrary position means that, for example, one bond site is provided at an arbitrary position of Formula (T1-1) in the case where Formula (T1-1) is combined with T¹ of Formulas (M-1) to (M-6) (hereinafter, in the present invention, the same meaning applies to the phrase that a bond site may be provided at an arbitrary position). In addition, these groups may be unsubstituted or substituted with one or more substituents L^{G}'s described above.) Alternatively, it is more preferable that G¹ represents a group selected from Formulas (M-7) to (M-14).

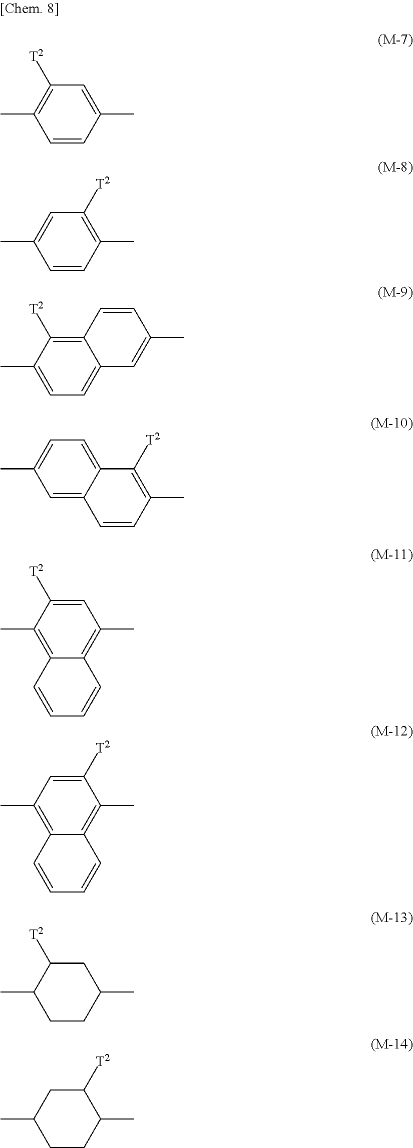

(In the formulas, these groups may be unsubstituted or substituted with one or more of the substituents L^{G}'S above, an arbitrary —CH═ may be independently substituted with —N═, —CH₂— may be independently substituted with —O—, —S—, —NR^{T}— (where R^{T} represents a hydrogen atom or an alkyl group having 1 to 20 carbon atoms), —CS—, or —CO—, and T² represents a group selected from Formula (T2-1) or (T2-2).)

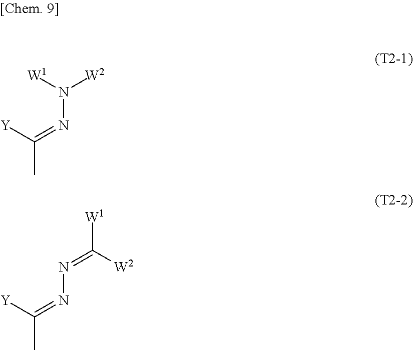

(In the formulas, W¹ represents a group containing an aromatic group and/or a non-aromatic group, which has 1 to 40 carbon atoms and may be substituted or unsubstituted, in which the aromatic group may be a hydrocarbon ring or a heterocyclic ring and the non-aromatic group may be a group in which an arbitrary carbon atom of a hydrocarbon group or a hydrocarbon group is substituted with a hetero atom (oxygen atoms do not directly bond to each other),

W² represents a hydrogen atom or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or W² may represent a group which has 2 to 30 carbon atoms and has at least one aromatic group, the group may be unsubstituted or substituted with one or more of substituents L^{W}'s, or W² may represent a group represented by P^{W}-(Sp^{W}-X^{W})_{kW}— in which P^{W} represents a polymerizable group and a preferred polymerizable group therefor is the same as that defined for P⁰ above, Sp^{W} represents a spacer group or a single bond and a preferred spacer group therefor is the same as that defined for Sp⁰ above, and in the case where a plurality of Sp^{W}'s are present, these may be the same as or different from each other, X^{W} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in the case where a plurality of X^{W}'s are present, these are the same as or different from each other, with the proviso that P^{W}-(Sp^{W}-X^{W})_{kW}— does not include an —O—O— bond, and kW represents an integer of 0 to 10,

L^{W} represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or L^{W} may represent a group represented by P^{LW}-(Sp^{LW}-X^{LW})_{kLW}—, in which P^{LW} represents a polymerizable group, Sp^{LW} represents a spacer group or a single bond and in the case where a plurality of Sp^{LW}'s are present, these may be the same as or different from each other, X^{LW} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{LW}'s are present, these may be the same as or different from each other, with the proviso that P^{LW}-(SP^{LW}-X^{LW})_{kLW}— does not contain an —O—O— bond, kLW represents an integer of 0 to 10, and in the case where a plurality of L^{W}'s are present in the compound, these may be the same as or different from each other, and

Y represents a hydrogen atom, a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or Y may represent a group represented by P^{Y}-(SP^{Y}-X^{Y})_{kY}—, P^{Y} represents a polymerizable group and a preferred polymerizable group therefor is the same as defined for the P⁰ above, Sp^{Y} represents a spacer group or a single bond and a preferred spacer group therefor is the same as defined for the Sp⁰, and in the case where a plurality of Sp^{Y}'s are present, these may be the same as or different from each other, X^{Y} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{Y}'s are present, these may be the same as or different from each other, with the proviso that P^{Y}-(Sp^{Y}-X^{Y})_{kY}— does not contain an —O—O— bond, kY represents an integer of 0 to 10, and W¹ and W² may form a ring structure together.)

From the viewpoints of solubility in a solvent and ease of synthesis, G¹ still more preferably represents a group selected from Formulas (M-1), (M-3), (M-4), (M-7), and (M-8), still more preferably represents a group selected from Formulas (M-1), (M-7), and (M-8), and particularly preferably represents a group selected from Formulas (M-7) and (M-8). More specifically, the group represented by Formula (M-1) preferably represents the groups selected from Formulas (M-1-1) to (M-1-6):

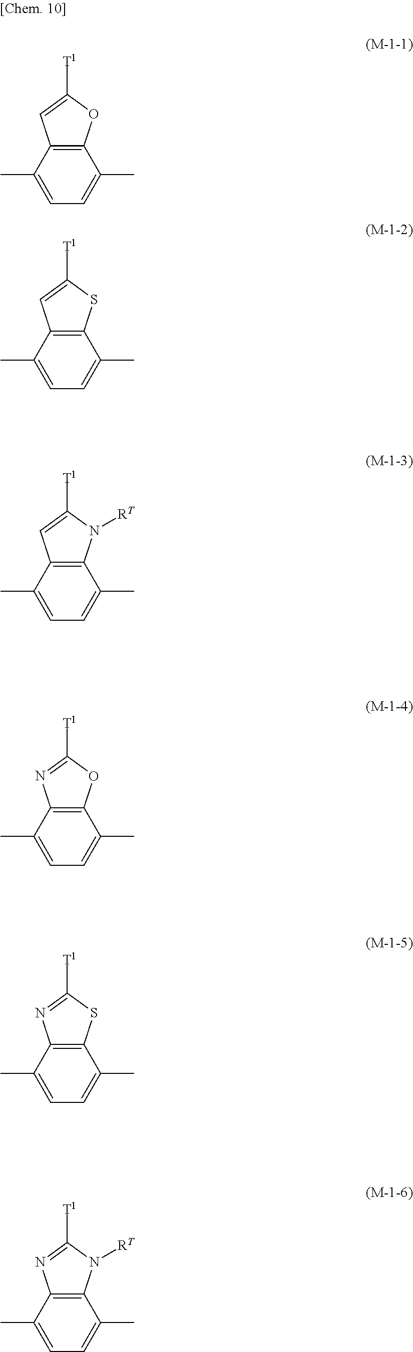

(In the formulas, T¹ represents the same meaning as defined above, and R^{T} represents a hydrogen atom or an alkyl group having 1 to 20 carbon atoms.), more preferably represents the groups selected from Formula (M-1-4) or (M-1-5), and particularly preferably represents the group selected from Formula (M-1-5)

The group represented by Formula (M-3) preferably represents the groups selected from Formulas (M-3-1) to (M-3-6):

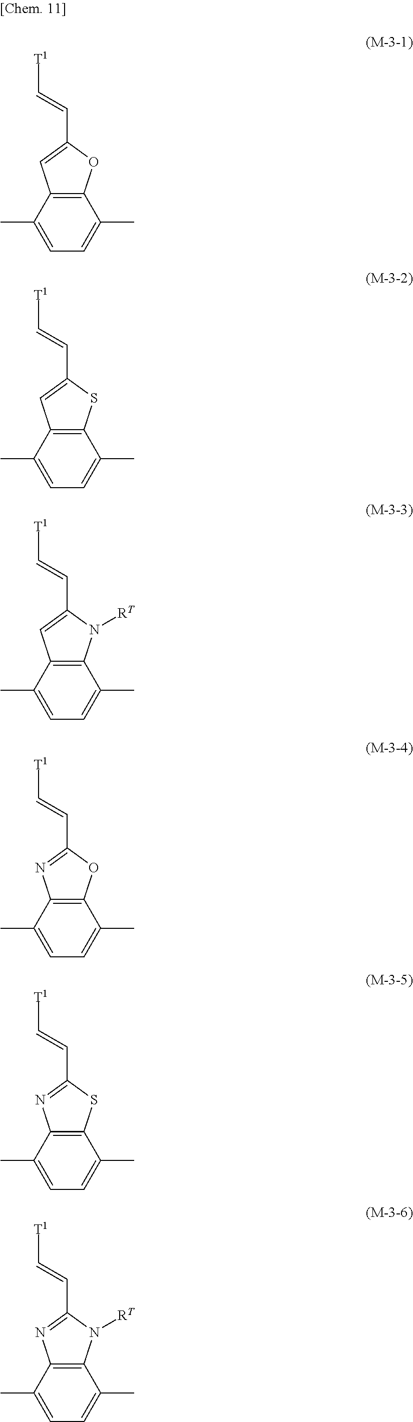

(In the formulas, T¹ represents the same meaning as defined above, and R^{T} represents a hydrogen atom or an alkyl group having 1 to 20 carbon atoms.), more preferably represents the groups selected from Formula (M-3-4) or (M-3-5), and particularly preferably represents the group selected from Formula (M-3-5).

The group represented by Formula (M-4) preferably represents the groups selected from Formulas (M-4-1) to (M-4-6):

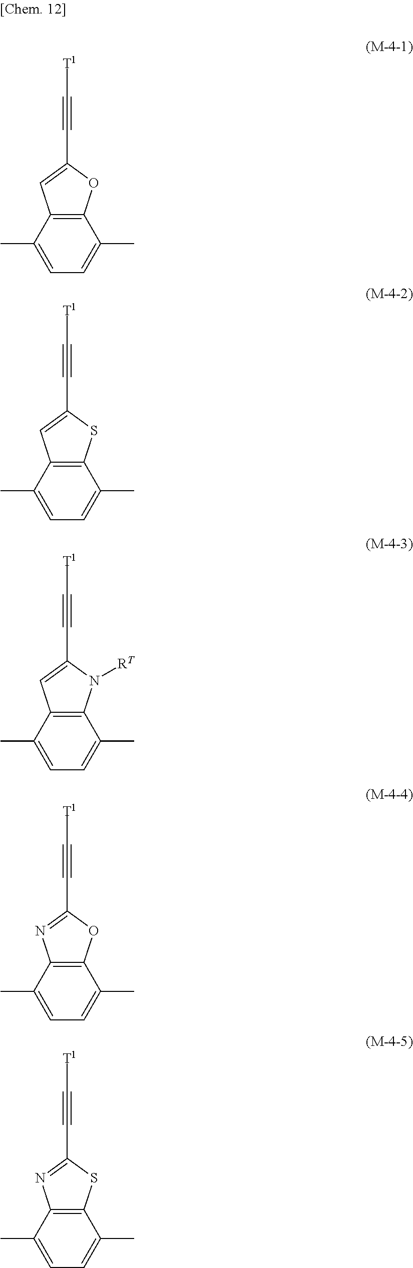

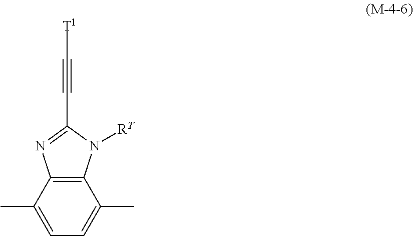

(In the formulas, T¹ represents the same meaning as defined above, and R^{T} represents a hydrogen atom or an alkyl group having 1 to 20 carbon atoms.), more preferably represents the groups selected from Formula (M-4-4) or (M-4-5), and particularly preferably represents the group selected from Formula (M-4-5).

The groups represented by Formulas (M-7) to (M-14) preferably represent the groups selected from Formulas (M-7-1) to (M-14-1):

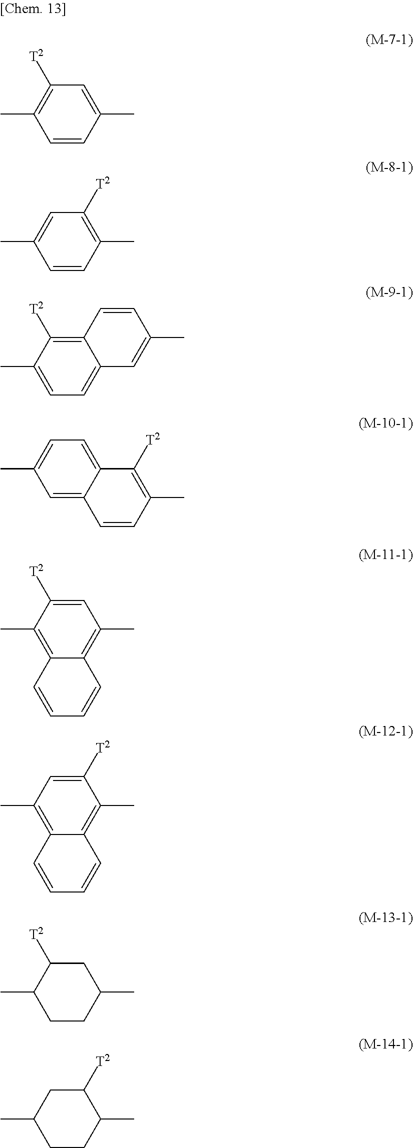

(In the formulas, T² represents the same meaning as defined above.), more preferably represent the groups selected from Formulas (M-7-1) to (M-12-1), and particularly preferably represent the groups selected from Formula (M-7-1) or (M-8-1)

In Formulas (M-1) to (M-6), from the viewpoints of wavelength dispersibility and ease of synthesis, T¹ preferably represents the groups selected from Formulas (T1-1), (T1-2), (T1-3), and (T1-6), more preferably represents the groups selected from Formulas (T1-3) and (T1-5), and particularly preferably represents the group selected from Formula (T1-3). More specifically, the group represented by Formula (T1-1) preferably represents the groups selected from Formulas (T1-1-1) to (T1-1-7):

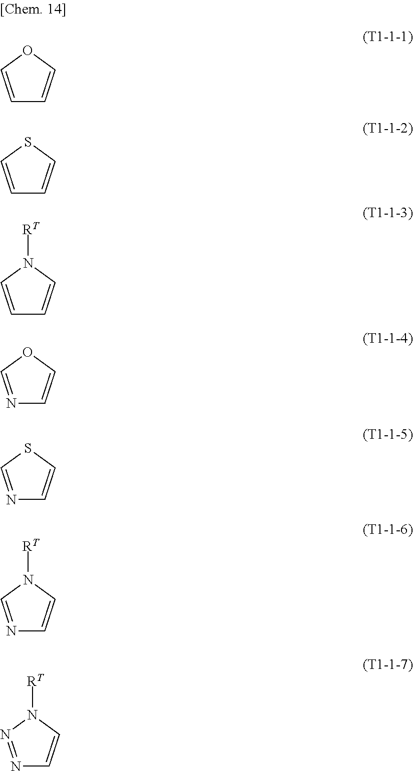

(In the formulas, a bond site may be present at an arbitrary position, and R^{T} represents a hydrogen atom or an alkyl group having 1 to 20 carbon atoms. These groups may be unsubstituted or substituted with one or more of the substituents L^{G}'s described above.), and more preferably represents the groups selected from Formulas (T1-1-2), (T1-1-4), (T1-1-5), (T1-1-6), and (T1-1-7).

The group represented by Formula (T1-2) preferably represents the groups selected from Formulas (T1-2-1) to (T1-2-8):

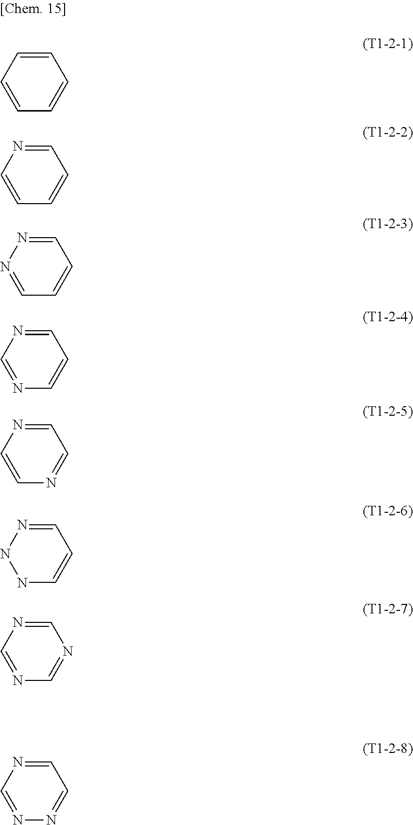

(In the formulas, a bond site may be present at an arbitrary position, and these groups may be unsubstituted or substituted with one or more of the substituents L^{G}'S described above.), and more preferably represents the group selected from Formula (T1-2-1).

The group represented by Formula (T1-3) preferably represents the groups selected from Formulas (T1-3-1) to (T1-3-8):

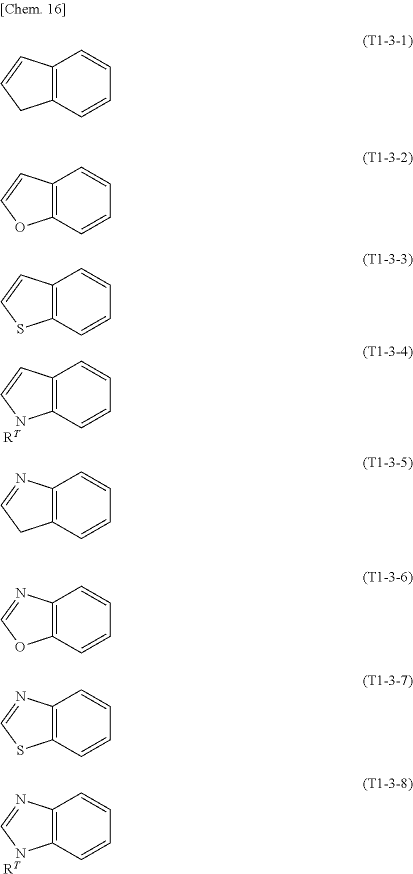

(In the formulas, a bond site may be present at an arbitrary position, and R^{T} represents a hydrogen atom or an alkyl group having 1 to 20 carbon atoms. These groups may be unsubstituted or substituted with one or more of the substituents L^{G}'S described above.), and more preferably represents the groups selected from Formulas (T1-3-2), (T1-3-3), (T1-3-6), and (T1-3-7).

The group represented by Formula (T1-4) preferably represents the groups selected from Formulas (T1-4-1) to (T1-4-6).

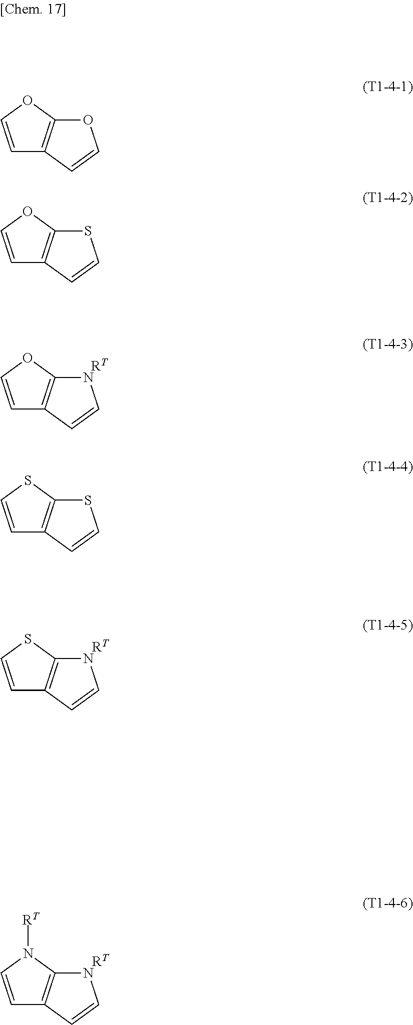

(In the formulas, a bond site may be present at an arbitrary position, and R^{T} represents a hydrogen atom or an alkyl group having 1 to 20 carbon atoms. These groups may be unsubstituted or substituted with one or more of the substituents L^{G}'S described above.)

The group represented by Formula (T1-5) preferably represents the groups selected from Formulas (T1-5-1) to (T1-5-9).

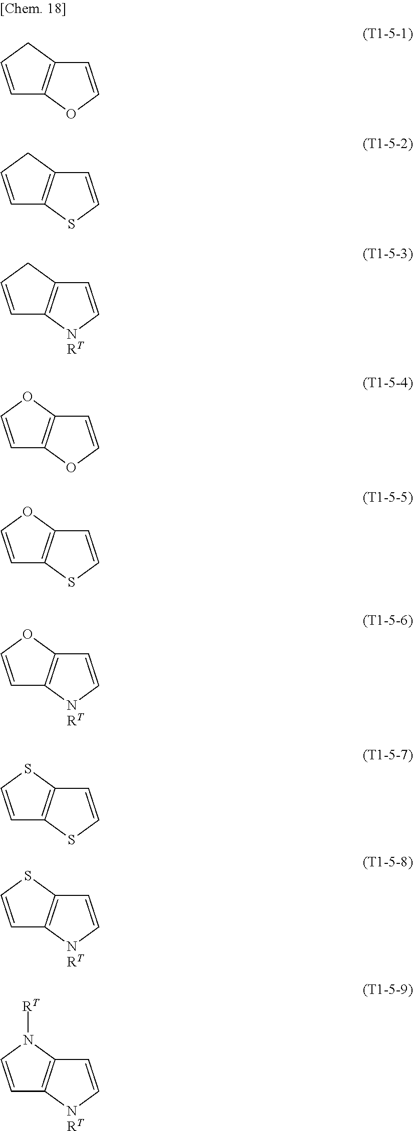

(In the formulas, a bond site may be present at an arbitrary position, and R^{T} represents a hydrogen atom or an alkyl group having 1 to 20 carbon atoms. These groups may be unsubstituted or substituted with one or more of the substituents L^{G}'S described above.)

The group represented by Formula (T1-6) preferably represents the groups selected from Formulas (T1-6-1) to (T1-6-7).

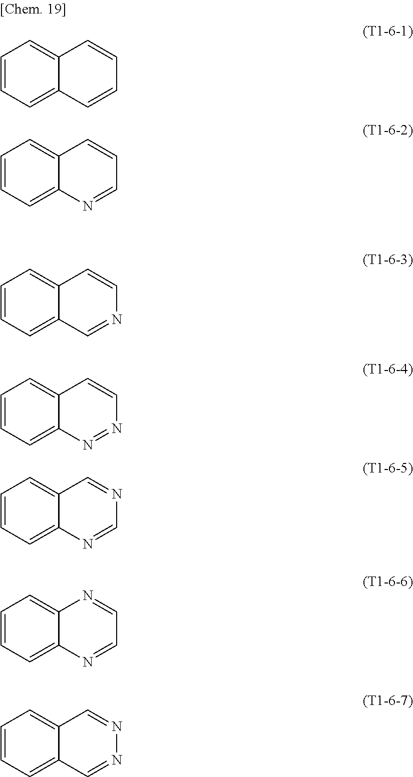

(In the formulas, a bond site may be present at an arbitrary position, and these groups may be unsubstituted or substituted with one or more of the substituents L^{G}'S described above.)

In General Formula (I), L^{G} represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—. L^{G} may represent a group represented by P^{LG}-(Sp^{LG}-X^{LG})_{kLG}— in which P^{LG} represents a polymerizable group and a preferred polymerizable group therefor is the same as defined for P⁰ above, Sp^{LG} is a spacer group or a single bond, a preferred spacer group therefor is the same as those defined for Sp⁰ above, and in the case where a plurality of Sp^{LG}'s are present, these may be the same as or different from each other, X^{LG} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{LG}'s are present, these may be the same as or different from each other, with the proviso that P^{LG} (Sp^{LG}-X^{LG})_{kLG}— does not contain an —O—O— bond, kLG represents an integer of 0 to 10, and in the case where a plurality of L^{G}'s are present in the compound, these are the same as or different from each other. From the viewpoints of liquid crystallinity and ease of synthesis, L^{G} preferably represents a fluorine atom, a chlorine atom, a bromine atom, an iodine atom, a pentafluorosulfuranyl group, a nitro group, a cyano group, an isocyano group, a thioisocyano group, or a linear or branched alkyl group having 1 to 12 carbon atoms in which an arbitrary hydrogen atom may be substituted with a fluorine atom and one —CH₂— or two or more non-adjacent —CH₂—'s may be independently substituted with a group selected from —O—, —S—, —COO—, or —OCO—, L^{G} more preferably represents a fluorine atom, a chlorine atom, a nitro group, a cyano group, a thioisocyano group, or a linear or branched alkyl group having 1 to 8 carbon atoms in which an arbitrary hydrogen atom may be substituted with a fluorine atom and one —CH₂— or two or more non-adjacent —CH₂—'s may be independently substituted with a group selected from —O— or —S—, L^{G} still more preferably represents a fluorine atom, a chlorine atom, a nitro group, a cyano group, a thioisocyano group, a linear alkyl group having 1 to 8 carbon atoms, or a linear alkoxy group having 1 to 8 carbon atoms, and L^{G} particularly preferably represents a fluorine atom, a chlorine atom, a nitro group, a cyano group, a linear alkyl group having 1 to 8 carbon atoms, or a linear alkoxy group having 1 to 8 carbon atoms.

In Formula (T2-1) or Formula (T2-2), from the viewpoints of liquid crystallinity and ease of synthesis, Y preferably represents a hydrogen atom, a fluorine atom, a chlorine atom, a nitro group, a cyano group, or a linear or branched alkyl group having 1 to 20 carbon atoms in which an arbitrary hydrogen atom in the group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or a group represented by P^{Y}-(Sp^{Y}-X^{Y})_{kY}—. Y more preferably represents a hydrogen atom or a linear or branched alkyl group having 1 to 12 carbon atoms in which an arbitrary hydrogen atom in the group may be substituted with a fluorine atom and one —CH₂— or two or more non-adjacent —CH₂—'s may be independently substituted with —O—, —COO—, or —OCO—. Y still more preferably represents a hydrogen atom or a linear or branched alkyl group having 1 to 12 carbon atoms in which an arbitrary hydrogen atom in the group may be substituted with a fluorine atom. Y particularly preferably represents a hydrogen atom or a linear alkyl group having 1 to 12 carbon atoms.

In Formula (T2-1) or (T2-2), from the viewpoints of liquid crystallinity and ease of synthesis, W¹ represents an aromatic and/or non-aromatic carbocyclic ring or heterocyclic ring, which has 1 to 80 carbon atoms and may be substituted, and an arbitrary carbon atom of the carbocyclic or heterocyclic ring may be substituted with a hetero atom. From the viewpoints of easy availability of raw materials and ease of synthesis, the aromatic group contained in W¹ preferably represents a group selected from Formulas (W-1) to (W-18) which may be unsubstituted or substituted with one or more substituents L^{W}'s.

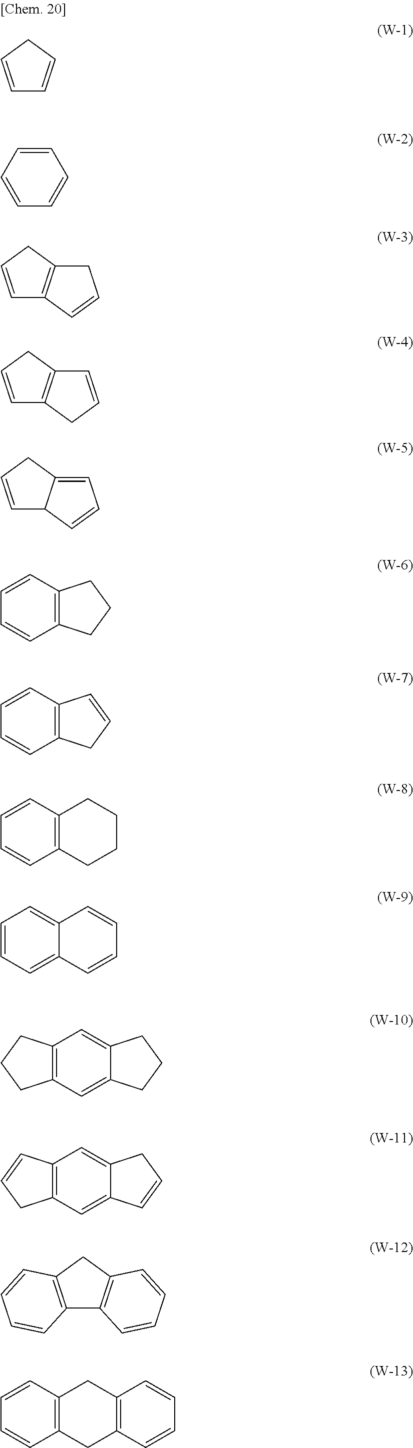

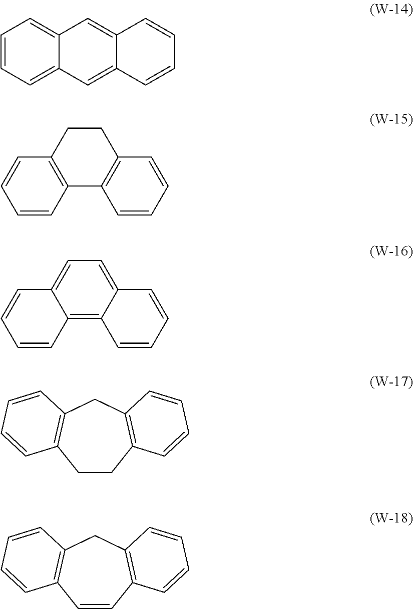

(In the formulas, the ring structure may have a bond site at an arbitrary position, a group formed by linking two or more aromatic groups selected from these groups by a single bond may be formed, an arbitrary —CH═ may be each independently substituted with —N═, each —CH₂— may be independently substituted with —O—, —S—, —NR^{T}— (where R^{T} is a hydrogen atom or an alkyl group having 1 to 20 carbon atoms), —CS—, or —CO—, provided that an —O—O— bond is not included. These groups may be unsubstituted or substituted with one or more of the substituents L^{W}'s above.)

The group represented by Formula (W-1) preferably represents a group selected from Formulas (W-1-1) to (W-1-7) which may be unsubstituted or substituted with one or more of the substituents L^{W}'s above.

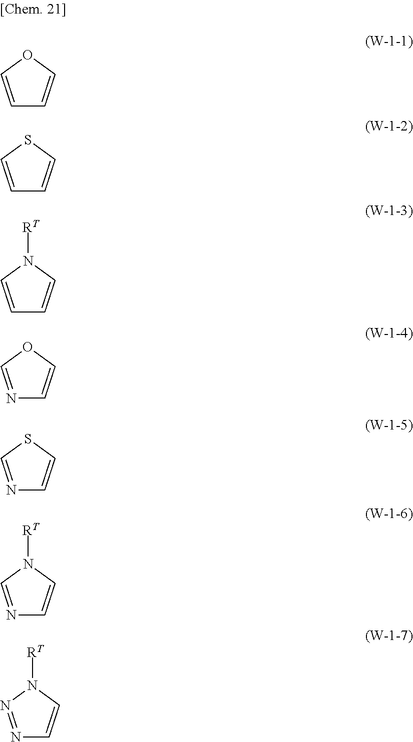

(In the formulas, these groups may have a bond site at an arbitrary position and R^{T} represents a hydrogen atom or an alkyl group having 1 to 8 carbon atoms.)

The group represented by Formula (W-2) preferably represents a group selected from Formulas (W-2-1) to (W-2-8) which may be unsubstituted or substituted with one or more of the substituents L^{W}'s above.

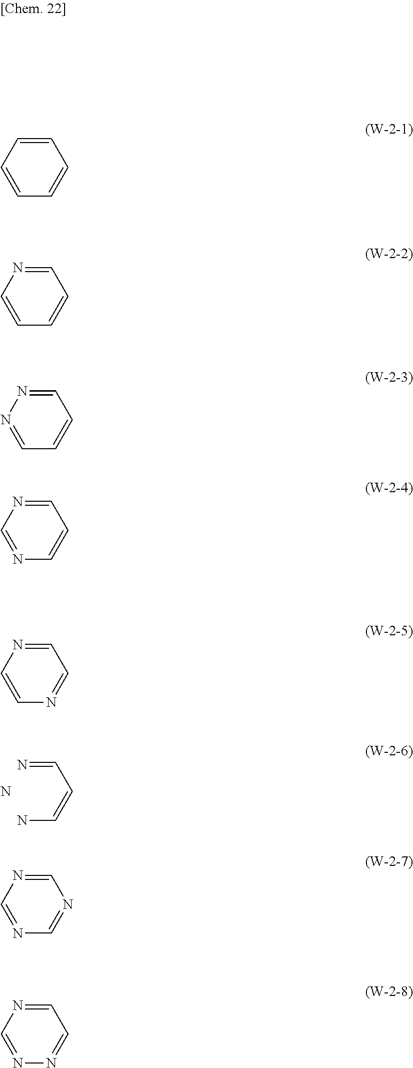

(In the formulas, these groups may have a bond site at an arbitrary position.)

The group represented by Formula (W-3) preferably represents a group selected from Formulas (W-3-1) to (W-3-6) which may be unsubstituted or substituted with one or more of the substituents L^{W}'s above.

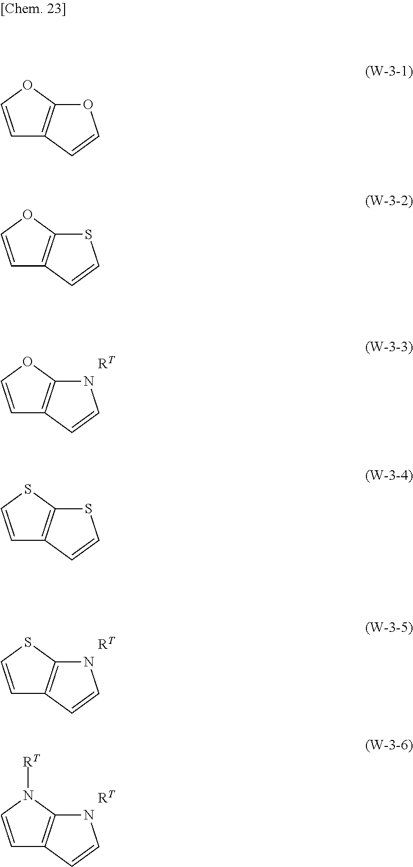

(In the formula, these groups may have a bond site at an arbitrary position and R^{T} represents a hydrogen atom or an alkyl group having 1 to 8 carbon atoms.)

The group represented by Formula (W-4) preferably represents a group selected from Formulas (W-4-1) to (W-4-9) which may be unsubstituted or substituted with one or more of the substituents L^{W}'s above.

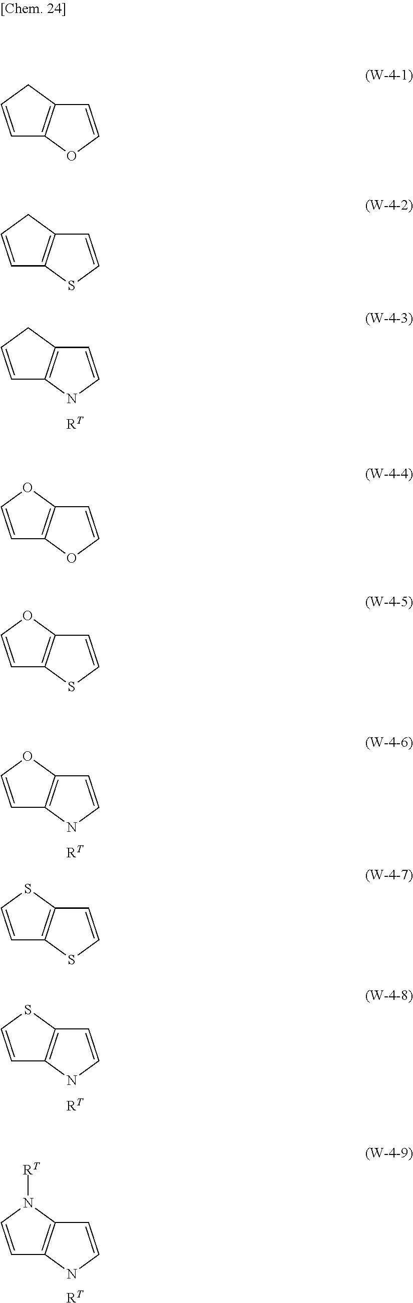

(In the formula, these groups may have a bond site at an arbitrary position and R^{T} represents a hydrogen atom or an alkyl group having 1 to 8 carbon atoms.)

The group represented by Formula (W-5) preferably represents a group selected from Formulas (W-5-1) to (W-5-13) which may be unsubstituted or substituted with one or more of the substituents L^{W}'s above.

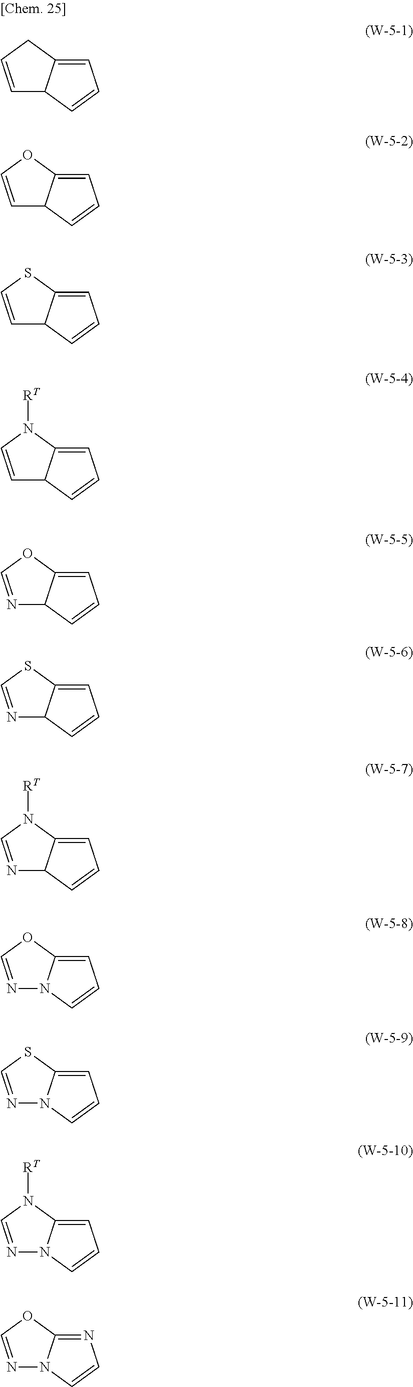

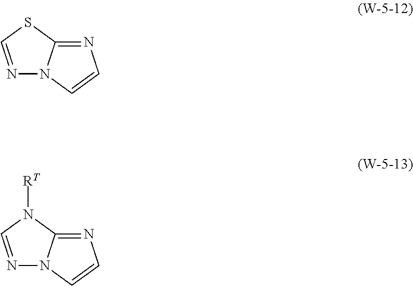

(In the formulas, these groups may have a bond site at an arbitrary position and R^{T} represents a hydrogen atom or an alkyl group having 1 to 8 carbon atoms.)

The group represented by Formula (W-6) preferably represents a group selected from Formulas (W-6-1) to (W-6-12) which may be unsubstituted or substituted with one or more of the substituents L^{W}'s above.

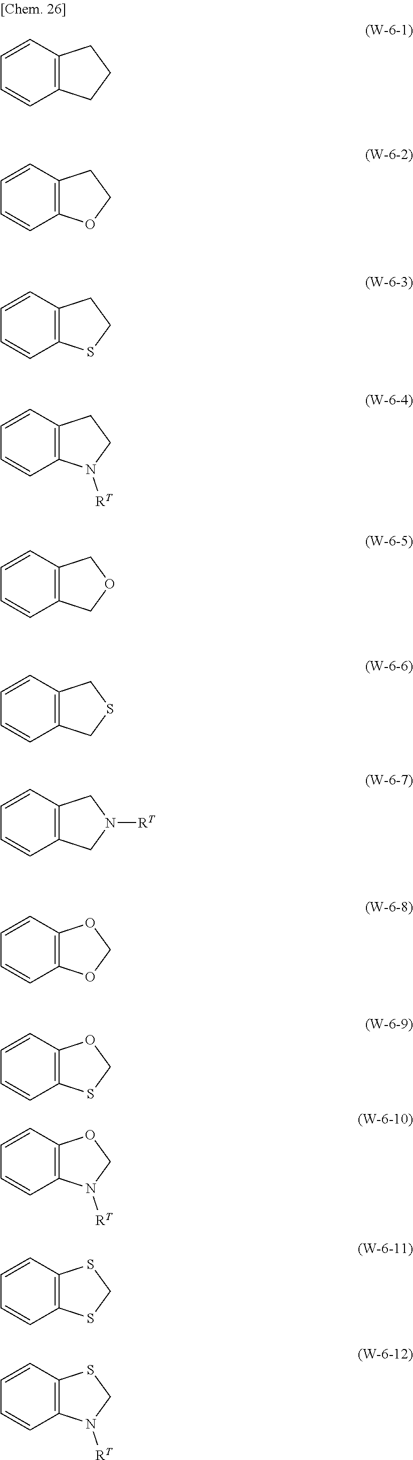

(In the formulas, these groups may have a bond site at an arbitrary position and R^{T} represents a hydrogen atom or an alkyl group having 1 to 8 carbon atoms.)

The group represented by Formula (W-7) preferably represents a group selected from Formulas (W-7-1) to (W-7-8) which may be unsubstituted or substituted with one or more of the substituents L^{W}'s above.

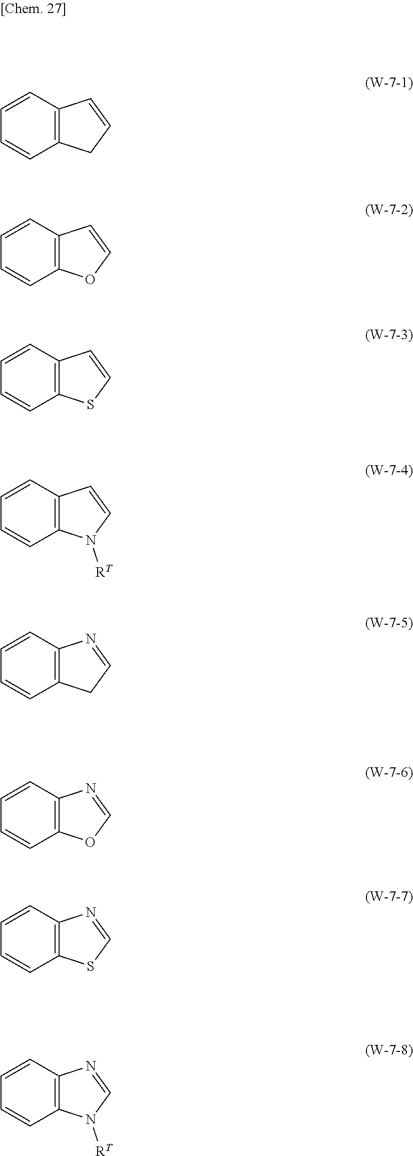

(In the formulas, these groups may have a bond site at an arbitrary position and R^{T} represents a hydrogen atom or an alkyl group having 1 to 8 carbon atoms.)

The group represented by Formula (W-8) preferably represents a group selected from Formulas (W-8-1) to (W-8-19) which may be unsubstituted or substituted with one or more of the substituents L^{W}'s above.

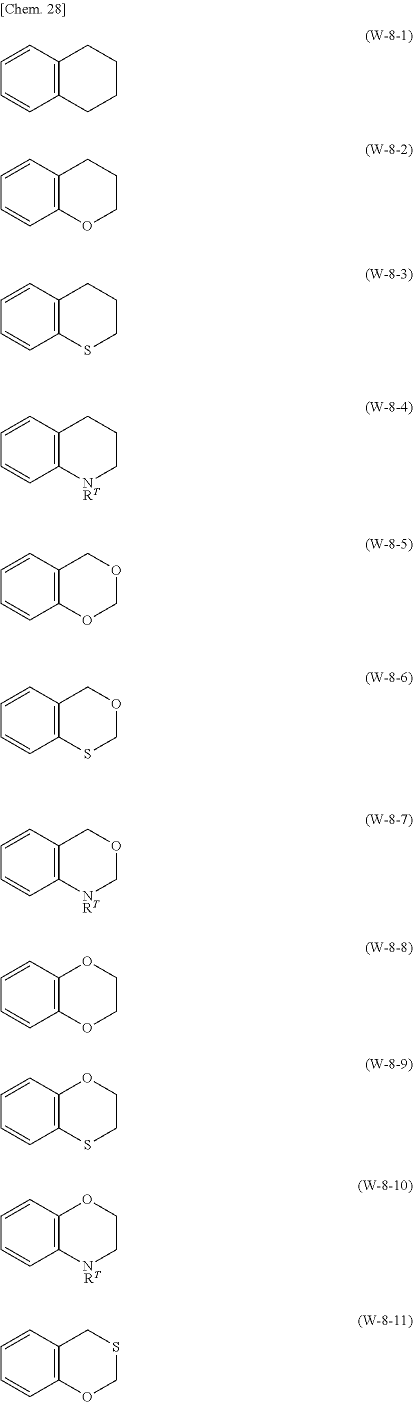

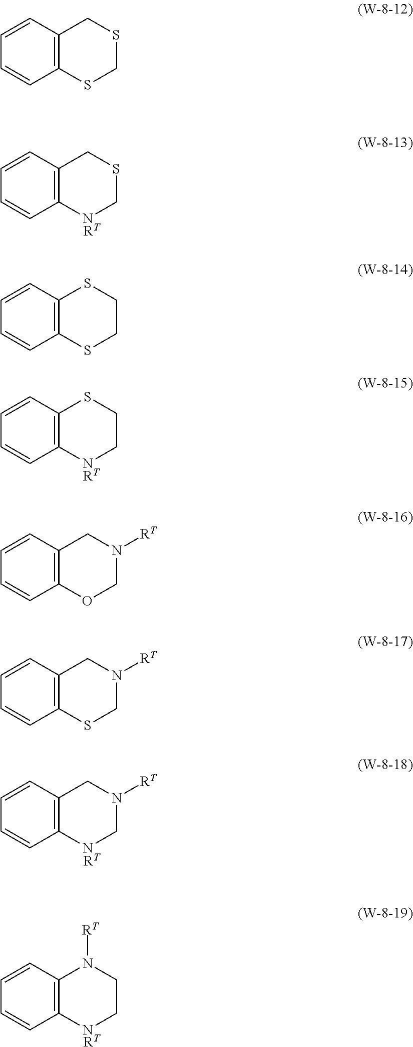

(In the formulas, these groups may have a bond site at an arbitrary position and R^{T} represents a hydrogen atom or an alkyl group having 1 to 8 carbon atoms.)

The group represented by Formula (W-9) preferably represents a group selected from Formulas (W-9-1) to (W-9-7) which may be unsubstituted or substituted with one or more of the substituents L^{W}'s above.

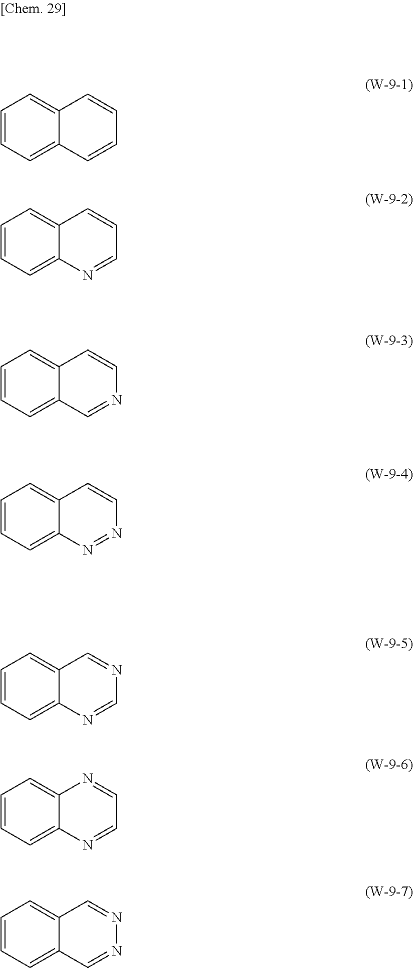

(In the formulas, these groups may have a bond site at an arbitrary position.)

The group represented by Formula (W-10) preferably represents a group selected from Formulas (W-10-1) to (W-10-16) which may be unsubstituted or substituted with one or more of the substituents L^{W}'s above.

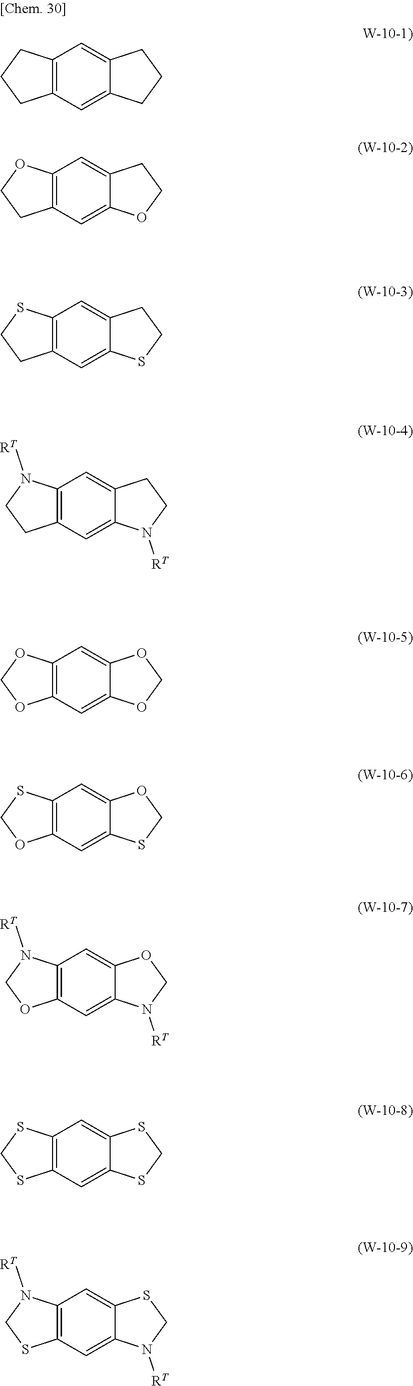

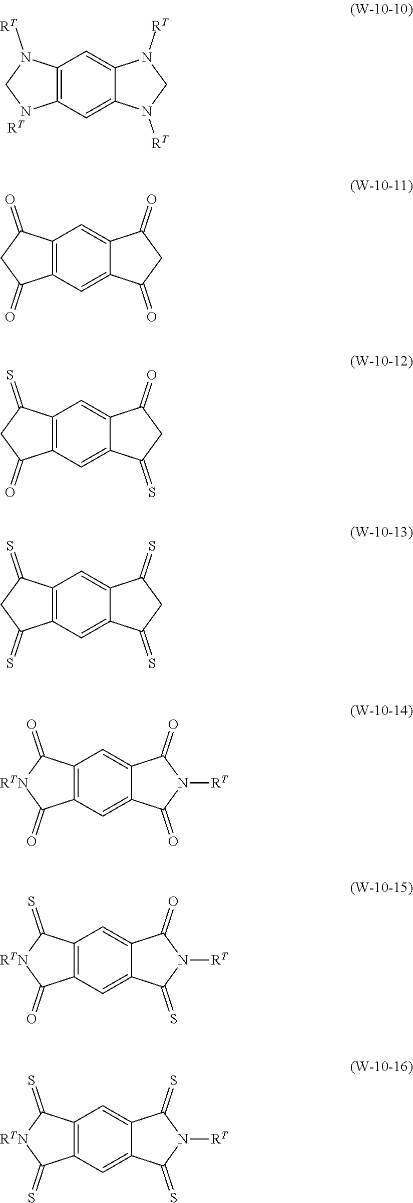

(In the formulas, these groups may have a bond site at an arbitrary position and R^{T} represents a hydrogen atom or an alkyl group having 1 to 8 carbon atoms.)

The group represented by Formula (W-11) preferably represents a group selected from Formulas (W-11-1) to (W-11-10) which may be unsubstituted or substituted with one or more of the substituents L^{W}'s above.

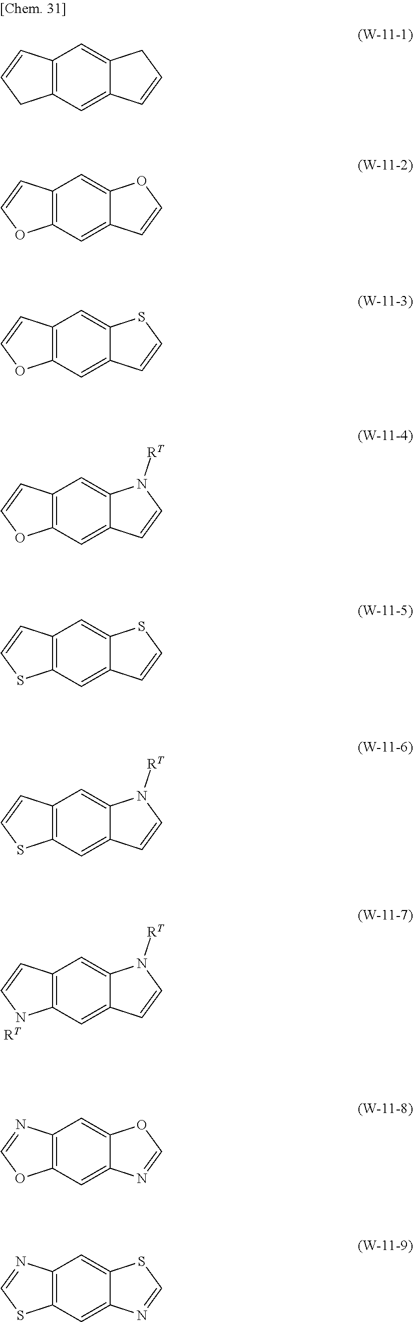

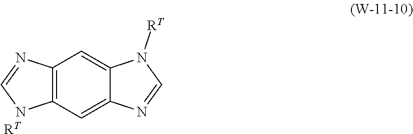

(In the formulas, these groups may have a bond site at an arbitrary position and R^{T} represents a hydrogen atom or an alkyl group having 1 to 8 carbon atoms.)

The group represented by Formula (W-12) preferably represents a group selected from Formulas (W-12-1) to (W-12-4) which may be unsubstituted or substituted with one or more of the substituents L^{W}'s above.

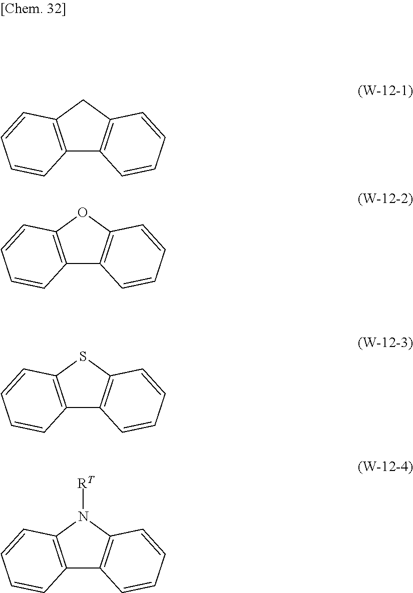

(In the formulas, these groups may have a bond site at an arbitrary position and R^{T} represents a hydrogen atom or an alkyl group having 1 to 8 carbon atoms.)

The group represented by Formula (W-13) preferably represents a group selected from Formulas (W-13-1) to (W-13-10) which may be unsubstituted or substituted with one or more of the substituents L^{W}'s above.

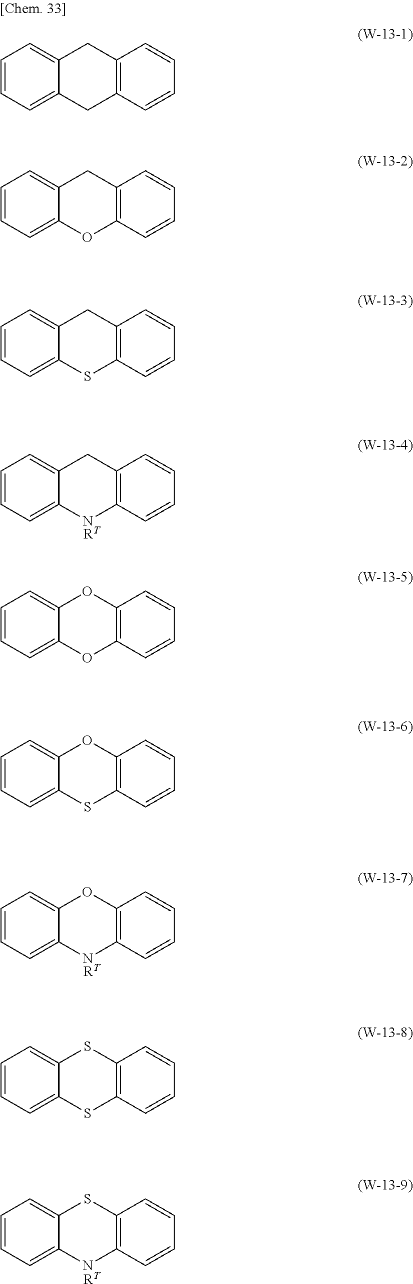

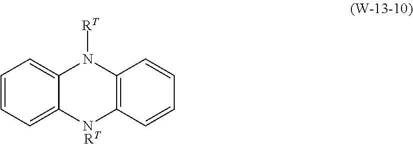

(In the formulas, these groups may have a bond site at an arbitrary position and R^{T} represents a hydrogen atom or an alkyl group having 1 to 8 carbon atoms.)

The group represented by Formula (W-17) preferably represents a group selected from Formulas (W-17-1) to (W-17-16) which may be unsubstituted or substituted with one or more of the substituents L^{W}'s above.

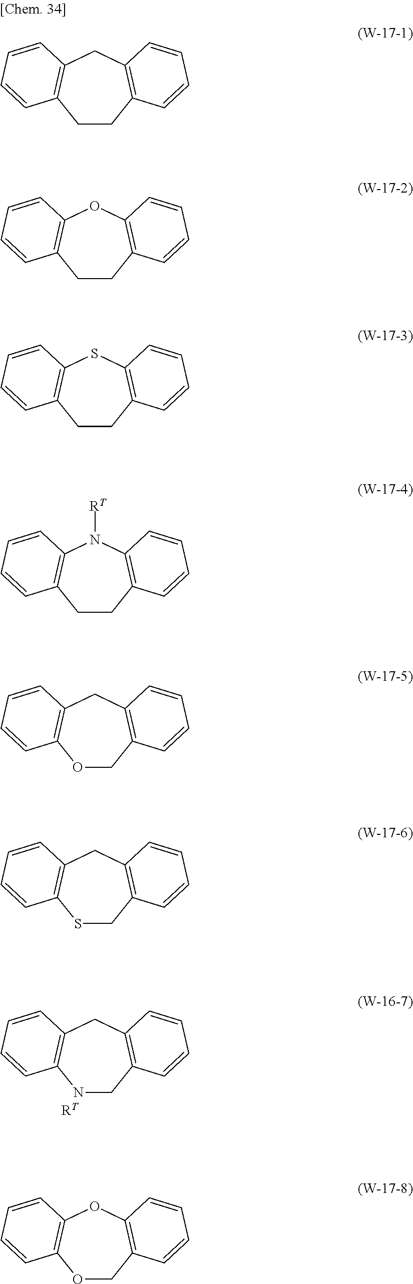

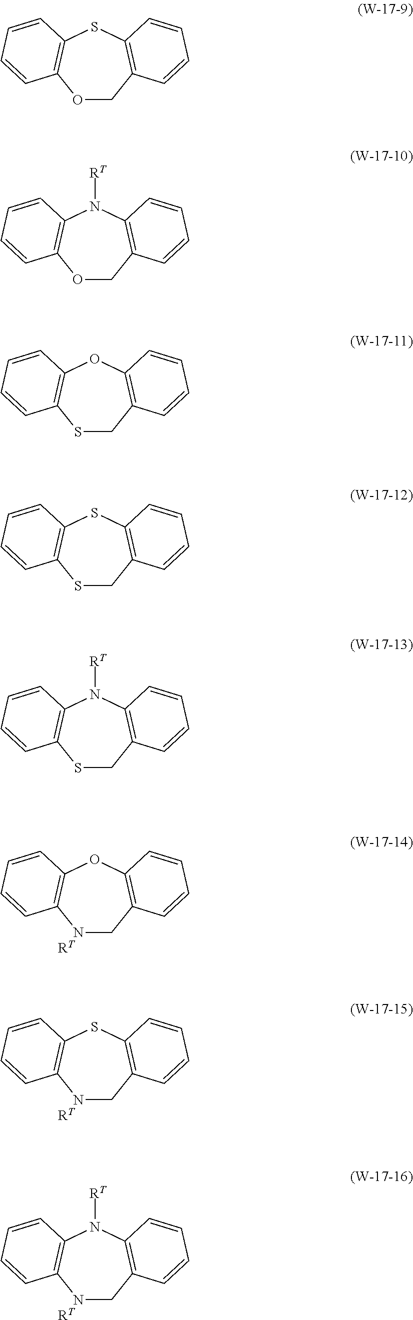

(In the formulas, these groups may have a bond site at an arbitrary position and R^{T} represents a hydrogen atom or an alkyl group having 1 to 8 carbon atoms.)

The group represented by Formula (W-18) preferably represents a group selected from Formulas (W-18-1) to (W-18-4) which may be unsubstituted or substituted with one or more of the substituents L^{W}'s above.

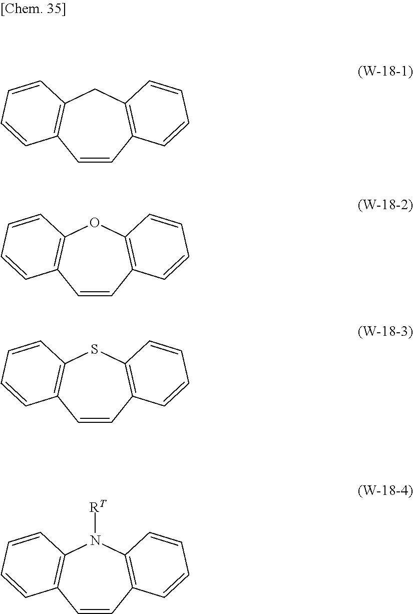

(In the formulas, these groups may have a bond site at an arbitrary position and R^{T} represents a hydrogen atom or an alkyl group having 1 to 8 carbon atoms.)

The group containing a carbocyclic ring or a heterocyclic ring contained in W¹ more preferably represents a group selected from any one of Formulas (W-1-1), (W-1-2), (W-1-3), (W-1-4), (W-1-5), (W-1-6), (W-2-1), (W-6-9), (W-6-11), (W-6-12), (W-7-2), (W-7-3), (W-7-4), (W-7-6), (W-7-7), (W-7-8), (W-9-1), (W-12-1), (W-12-2), (W-12-3), (W-12-4), (W-13-7), (W-13-9), (W-13-10), (W-14), (W-18-1), and (W-18-4) which may be unsubstituted or substituted with one or more of the substituents L^{W}'s above, more preferably represents a group selected from any one of Formulas (W-2-1), (W-7-3), (W-7-7), and (W-14) which may be unsubstituted or substituted with one or more of the substituents L^{W}'s above, still more preferably represents a group selected from any one of Formulas (W-7-3), (W-7-7), and (W-14) which may be unsubstituted or substituted with one or more of the substituents L^{W}'s above, still more preferably represents a group represented by Formula (W-7-7) which may be unsubstituted or substituted with one or more of the substituents L^{W}'s above, and a group represented by Formula (W-7-7-1) which may be unsubstituted or substituted with one or more of the substituents L^{W}'s above:

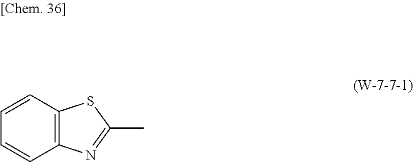

is particularly preferable.

In Formula (T-1) or (T-2), from the viewpoints of availability of raw materials and ease of synthesis, W² more preferably represents a hydrogen atom or a linear or branched alkyl group having 1 to 20 carbon atoms in which an arbitrary hydrogen atom in the group may be substituted with a fluorine atom and one —CH₂— or two or more non-adjacent —CH₂—'s may be independently substituted with —O—, —CO—, —COO—, —OCO—, —O—CO—O—, —CH═CH—COO—, —CH═CH—OCO—, —COO—CH═CH—, —OCO—CH═CH—, —CH═CH—, —CF═CF, or —C≡C—, or a group represented by P^{W}-(Sp^{W}-X^{W})_{kW}—, W² still more preferably represents a hydrogen atom or a linear or branched alkyl group having 1 to 20 carbon atoms in which an arbitrary hydrogen atom in the group may be substituted with a fluorine atom and one —CH₂— or two or more non-adjacent —CH₂—'s may be independently substituted with —O—, —CO—, —COO—, or —OCO—, or a group represented by P^{W}-(Sp^{W}-X^{W})_{kW}—, and W² still more preferably represents a hydrogen atom, a linear alkyl group having 1 to 12 carbon atoms in which one —CH₂— or two or more non-adjacent —CH₂—'s may be independently substituted with —O—, or a group represented by P^{W}-(Sp^{W}-X^{W})_{kW}—.

In the case where W² represents a group having 2 to 30 carbon atoms which has at least one aromatic group and may be unsubstituted or substituted with one or more of the substituents L^{W}'s above, W² preferably represents a group selected from Formulas (W-1) to (W-18) which may be unsubstituted or substituted with one or more of the substituents L^{W}'s above. In this case, the more preferable structure is the same as above.

In the case where W² represents a group represented by P^{W}-(Sp^{W}-X^{W})_{kW}—, preferable structures of groups represented by P^{W}, Sp^{W}, X^{W}, and kW are the same as preferable structures of groups represented by P⁰, Sp⁰, X⁰, and k0.

W¹ and W² may form a ring structure together, and in this case, a cyclic group represented by —NW¹W² preferably represents a group selected from Formulas (W-19) to (W-40) which may be unsubstituted or substituted with one or more of the substituents L^{W}'s above.

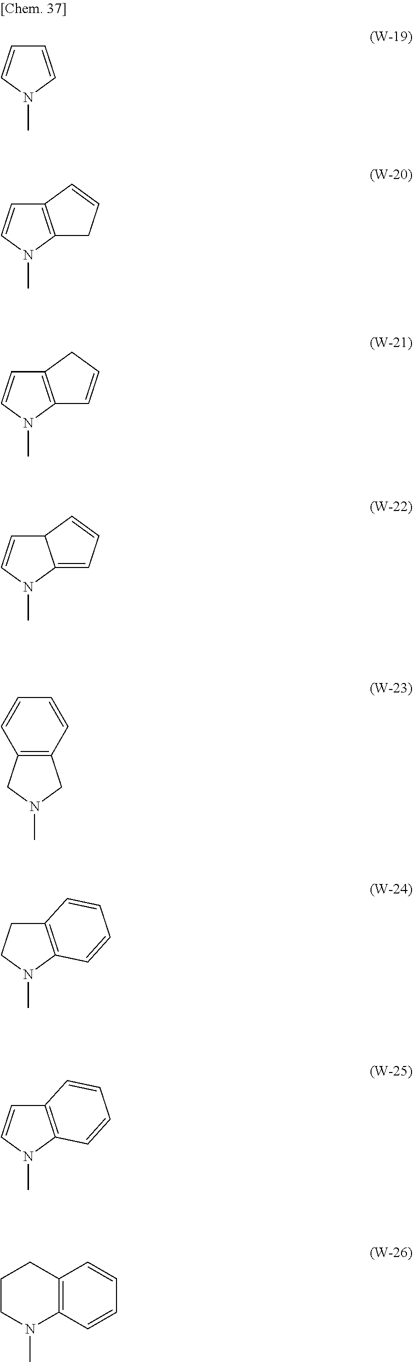

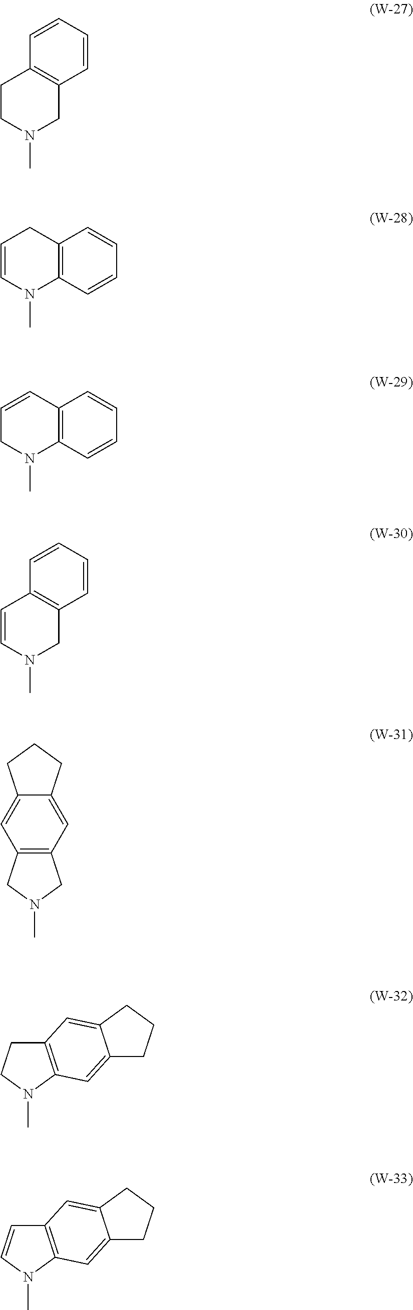

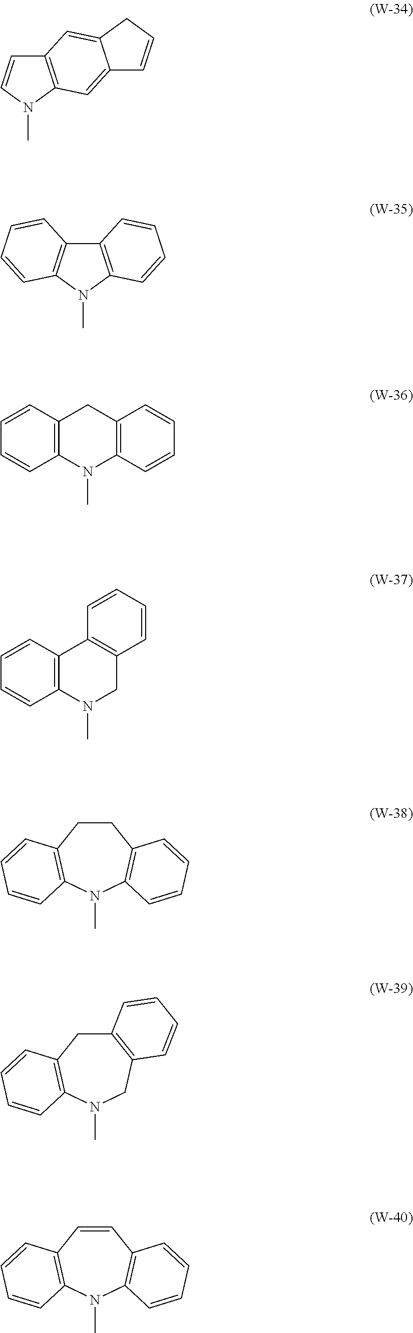

(In the formulas, an arbitrary —CH═ may be independently substituted with —N═, each —CH₂— may be independently substituted with —O—, —S—, —NR^{T}— (where R^{T} represents a hydrogen atom or an alkyl group having 1 to 20 carbon atoms), —CS—, or —CO—, provided that an —O—O— bond is not included. These groups may be unsubstituted or substituted with one or more of the substituents L^{W}'s above.)

The group represented by Formula (W-19) preferably represents groups selected from Formulas (W-19-1) to (W-19-3) which may be unsubstituted or substituted with one or more of the substituents L^{W}'s above.

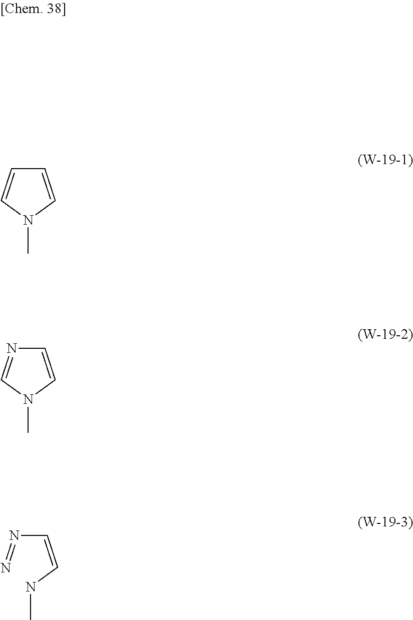

The group represented by Formula (W-20) preferably represents groups selected from Formulas (W-20-1) to (W-20-4) which may be unsubstituted or substituted with one or more of the substituents L^{W}'s above.

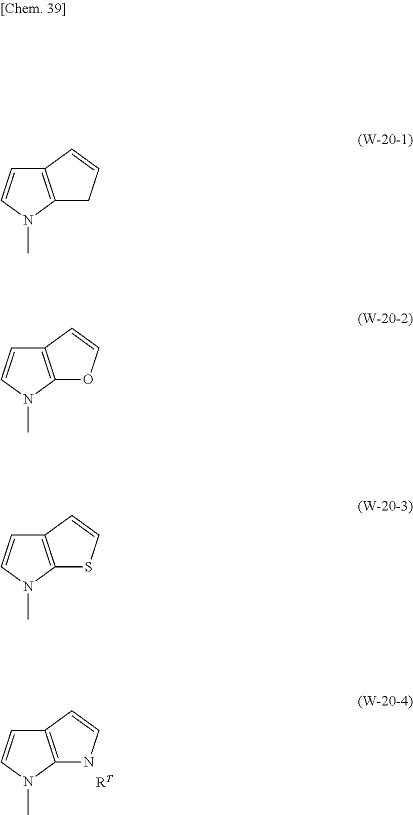

(In the formulas, R^{T} represents a hydrogen atom or an alkyl group having 1 to 8 carbon atoms.)

The group represented by Formula (W-21) preferably represents groups selected from Formulas (W-21-1) to (W-21-4) which may be unsubstituted or substituted with one or more of the substituents L^{W}'s above.

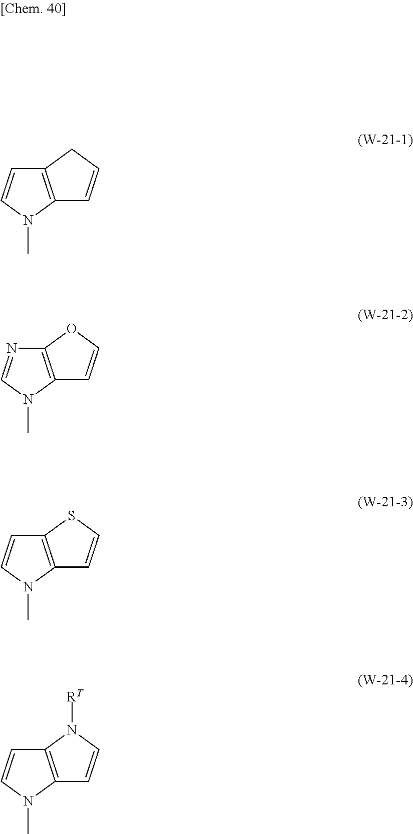

(In the formulas, R^{T} represents a hydrogen atom or an alkyl group having 1 to 8 carbon atoms.)

The group represented by Formula (W-22) preferably represents groups selected from Formulas (W-22-1) to (W-22-4) which may be unsubstituted or substituted with one or more of the substituents L^{W}'s above.

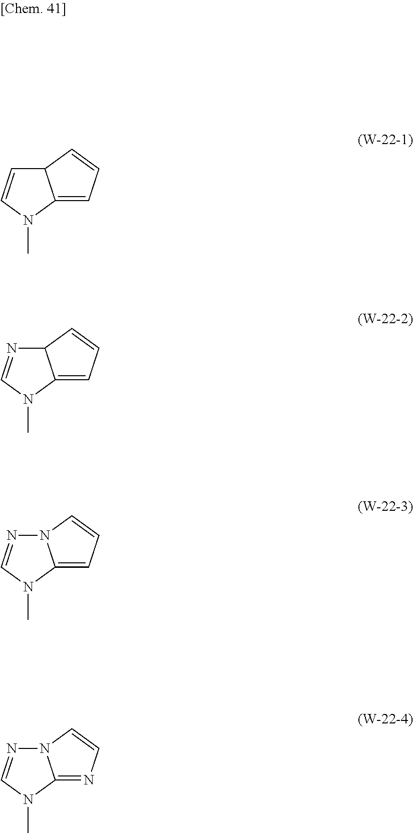

The group represented by Formula (W-23) preferably represents groups selected from Formulas (W-23-1) to (W-23-3) which may be unsubstituted or substituted with one or more of the substituents L^{W}'s above.

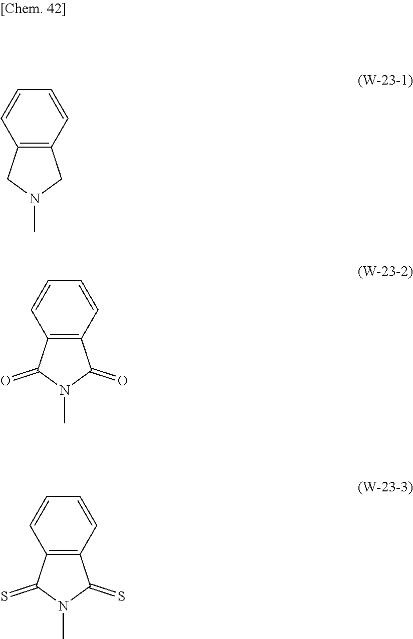

The group represented by Formula (W-24) preferably represents groups selected from Formulas (W-24-1) to (W-24-4) which may be unsubstituted or substituted with one or more of the substituents L^{W}'s above.

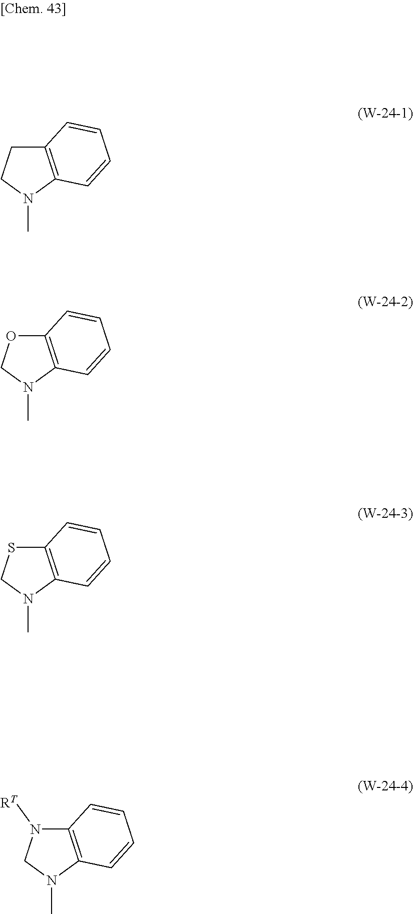

(In the formulas, R^{T} represents a hydrogen atom or an alkyl group having 1 to 8 carbon atoms.)

The group represented by Formula (W-25) preferably represents groups selected from Formulas (W-25-1) to (W-25-3) which may be unsubstituted or substituted with one or more of the substituents L^{W}'s above.

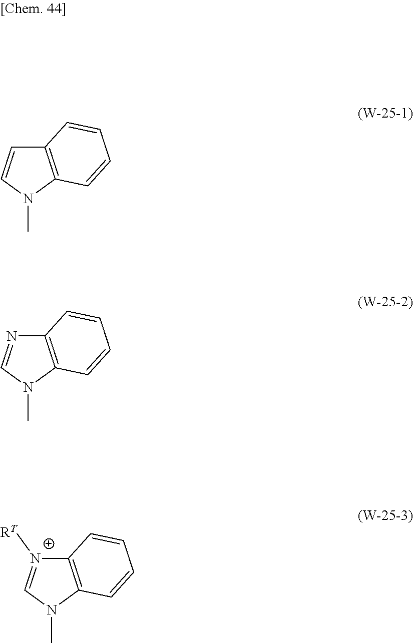

(In the formulas, R^{T} represents a hydrogen atom or an alkyl group having 1 to 8 carbon atoms.)

The group represented by Formula (W-26) preferably represents groups selected from Formulas (W-26-1) to (W-26-7) which may be unsubstituted or substituted with one or more of the substituents L^{W}'s above.

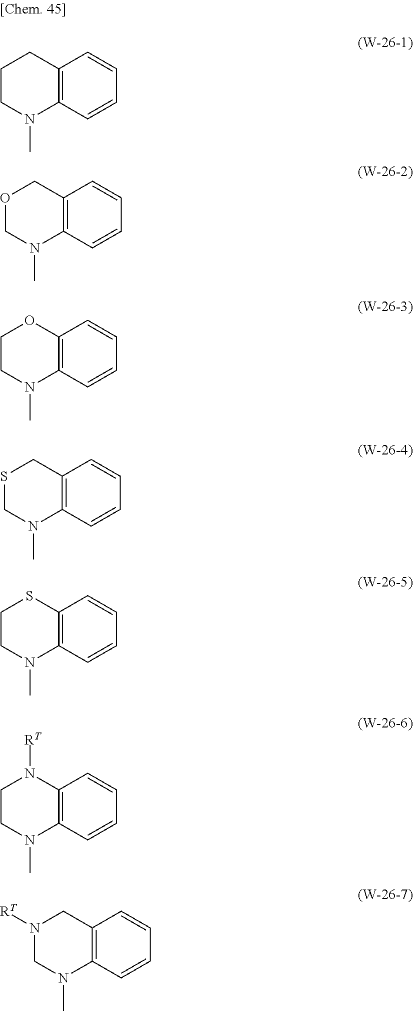

(In the formulas, R^{T} represents a hydrogen atom or an alkyl group having 1 to 8 carbon atoms.)

The group represented by Formula (W-27) preferably represents groups selected from Formulas (W-27-1) to (W-27-4) which may be unsubstituted or substituted with one or more of the substituents L^{W}'s above.

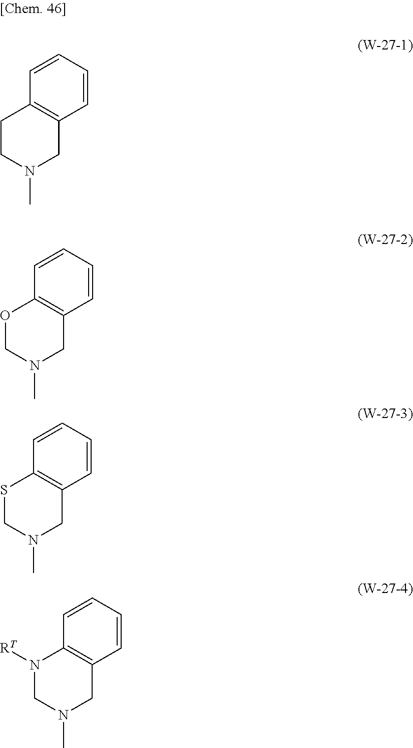

(In the formulas, R^{T} represents a hydrogen atom or an alkyl group having 1 to 8 carbon atoms.)

The group represented by Formula (W-28) preferably represents groups selected from Formulas (W-28-1) to (W-28-6) which may be unsubstituted or substituted with one or more of the substituents L^{W}'s above.

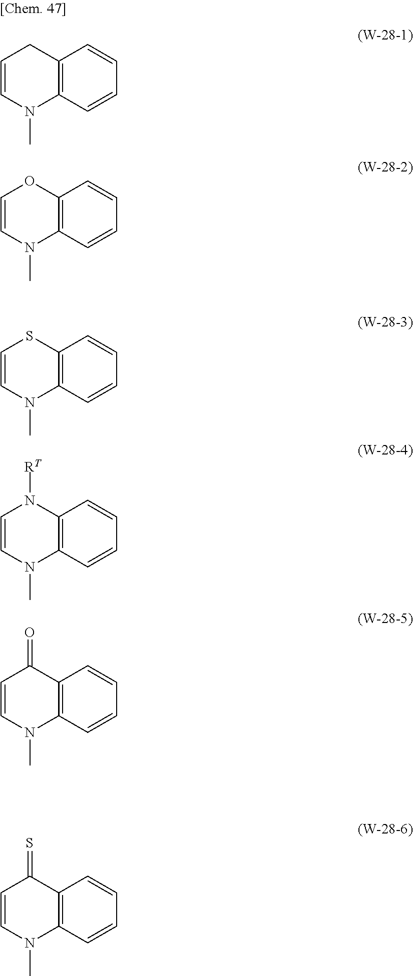

(In the formulas, R^{T} represents a hydrogen atom or an alkyl group having 1 to 8 carbon atoms.)

The group represented by Formula (W-29) preferably represents groups selected from Formulas (W-29-1) to (W-29-3) which may be unsubstituted or substituted with one or more of the substituents L^{W}'s above.

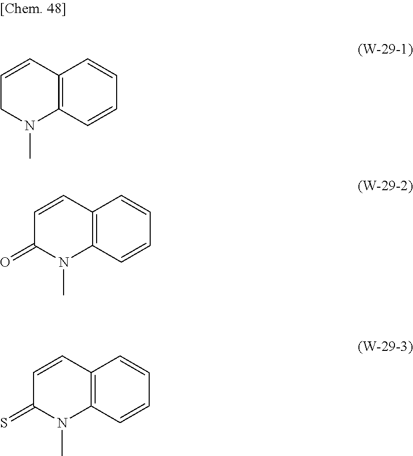

The group represented by Formula (W-30) preferably represents groups selected from Formulas (W-30-1) to (W-30-3) which may be unsubstituted or substituted with one or more of the substituents L^{W}'s above.

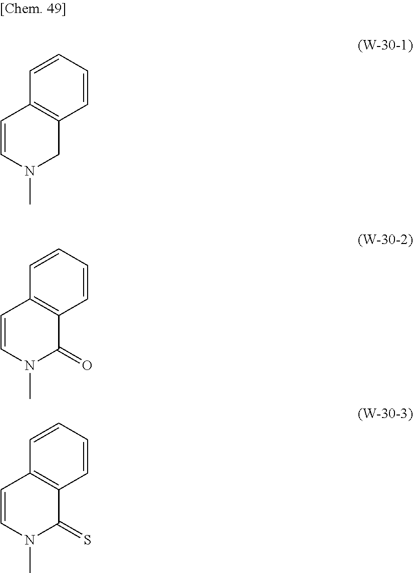

The group represented by Formula (W-31) preferably represents groups selected from Formulas (W-31-1) to (W-31-4) which may be unsubstituted or substituted with one or more of the substituents L^{W}'s above.

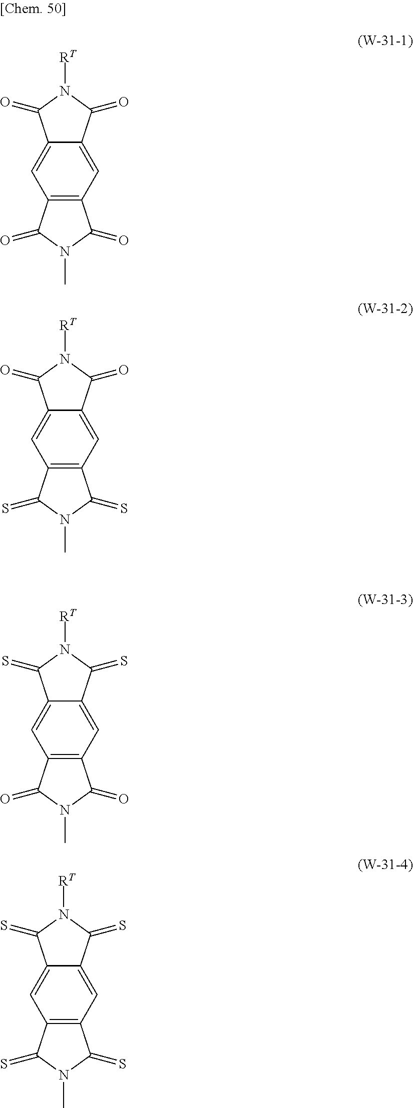

(In the formulas, R^{T} represents a hydrogen atom or an alkyl group having 1 to 8 carbon atoms.)

The group represented by Formula (W-32) preferably represents groups selected from Formulas (W-32-1) to (W-32-5) which may be unsubstituted or substituted with one or more of the substituents L^{W}'s above.

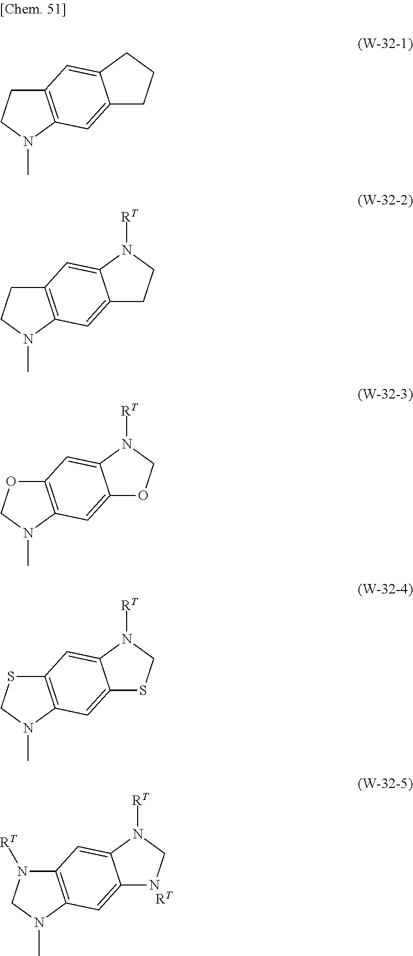

(In the formulas, R^{T} represents a hydrogen atom or an alkyl group having 1 to 8 carbon atoms.)

The group represented by Formula (W-33) preferably represents groups selected from Formulas (W-33-1) to (W-33-3) which may be unsubstituted or substituted with one or more of the substituents L^{W}'s above.

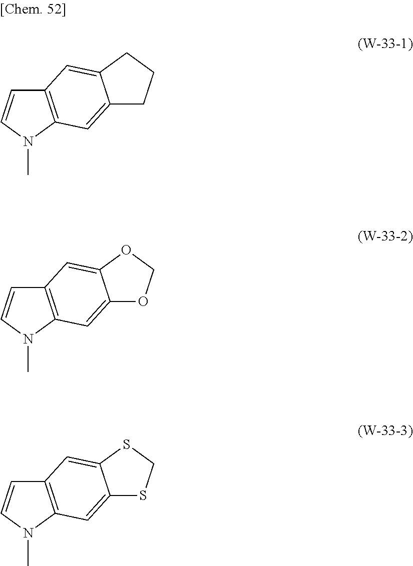

The group represented by Formula (W-34) preferably represents groups selected from Formulas (W-34-1) to (W-34-5) which may be unsubstituted or substituted with one or more of the substituents L^{W}'s above.

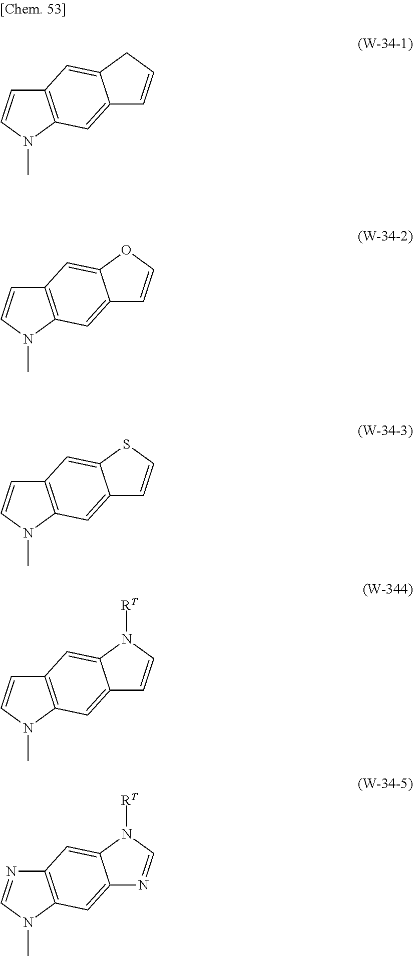

(In the formulas, R^{T} represents a hydrogen atom or an alkyl group having 1 to 8 carbon atoms.)

The group represented by Formula (W-35) preferably represents Formula (W-35-1) which may be unsubstituted or substituted with one or more of the substituents L^{W}'s above.

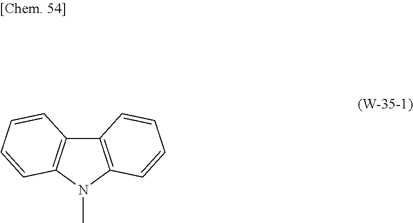

The group represented by Formula (W-36) preferably represents groups selected from Formulas (W-36-1) to (W-36-6) which may be unsubstituted or substituted with one or more of the substituents L^{W}'s above.

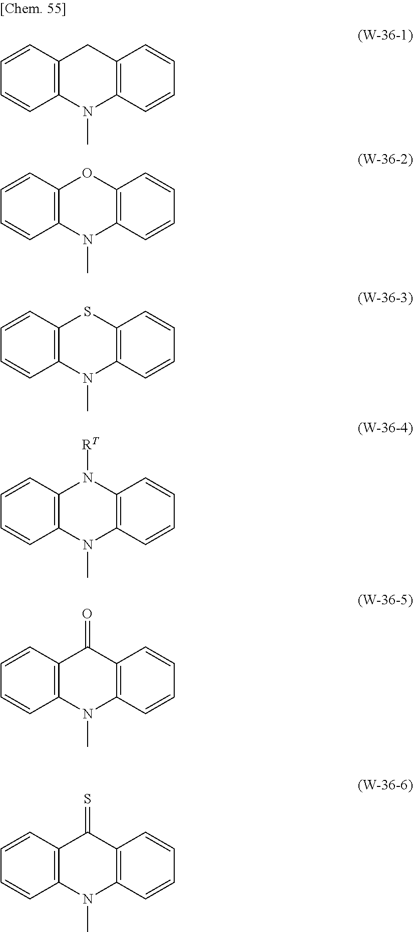

(In the formulas, R^{T} represents a hydrogen atom or an alkyl group having 1 to 8 carbon atoms.)

The group represented by Formula (W-37) preferably represents groups selected from Formulas (W-37-1) to (W-37-3) which may be unsubstituted or substituted with one or more of the substituents L^{W}'s above.

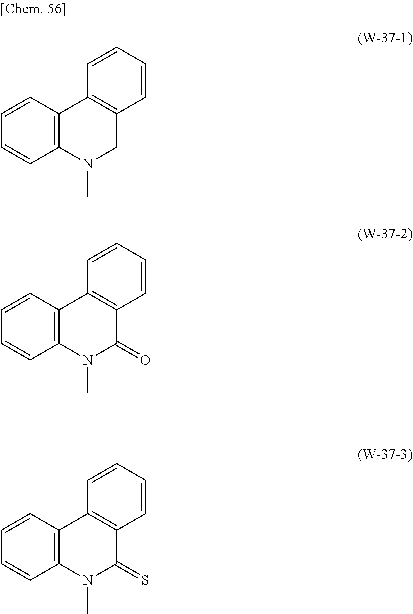 [SMILES: CN1Cc2ccccc2-c2ccccc21 ; Cn1c(=O)c2ccccc2c2ccccc21 ; Cn1c(=S)c2ccccc2c2ccccc21]

The group represented by Formula (W-38) preferably represents groups selected from Formulas (W-38-1) to (W-38-4) which may be unsubstituted or substituted with one or more of the substituents L^{W}'s above.

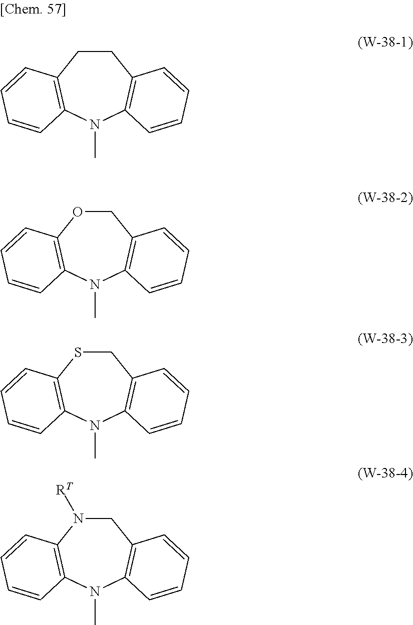

(In the formulas, R^{T} represents a hydrogen atom or an alkyl group having 1 to 8 carbon atoms.)

The group represented by Formula (W-39) preferably represents groups selected from Formulas (W-39-1) to (W-39-4) which may be unsubstituted or substituted with one or more of the substituents L^{W}'s above.

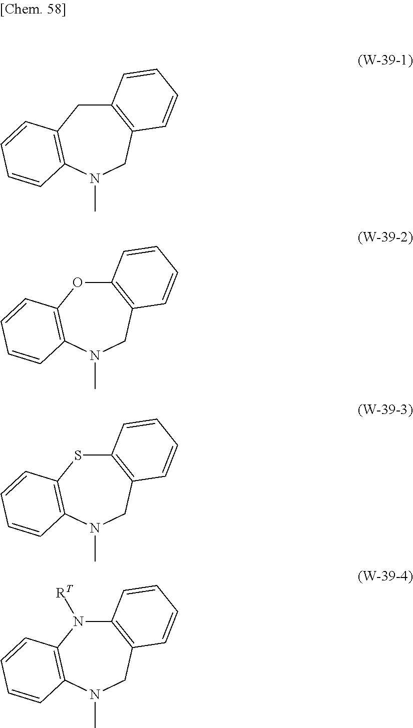

(In the formulas, R^{T} represents a hydrogen atom or an alkyl group having 1 to 8 carbon atoms.)

The group represented by Formula (W-40) preferably represents Formula (W-40-1):

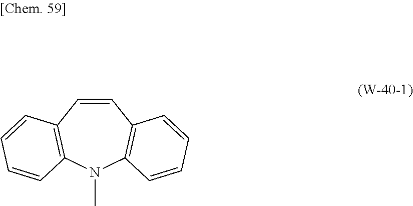 [SMILES: CN1c2ccccc2C=Cc2ccccc21]

which may be unsubstituted or substituted with one or more of the substituents L^{W}'s above.

From the viewpoints of easy availability of raw materials and ease of synthesis, the cyclic group represented by —NW¹W² more preferably represents groups selected from Formulas (W-19-1), (W-21-2), (W-21-3), (W-21-4), (W-23-2), (W-23-3), (W-25-1), (W-25-2), (W-25-3), (W-30-2), (W-30-3), (W-35-1), (W-36-2), (W-36-3), (W-36-4), and (W-40-1) which may be unsubstituted or substituted with one or more of the substituents L^{W}'s above.

W¹ and W² may form a ring structure together, and in this case, a cyclic group represented by ═CW¹W² preferably represents groups selected from Formulas (W-41) to (W-62) which may be unsubstituted or substituted with one or more of the substituents L^{W}'s above.

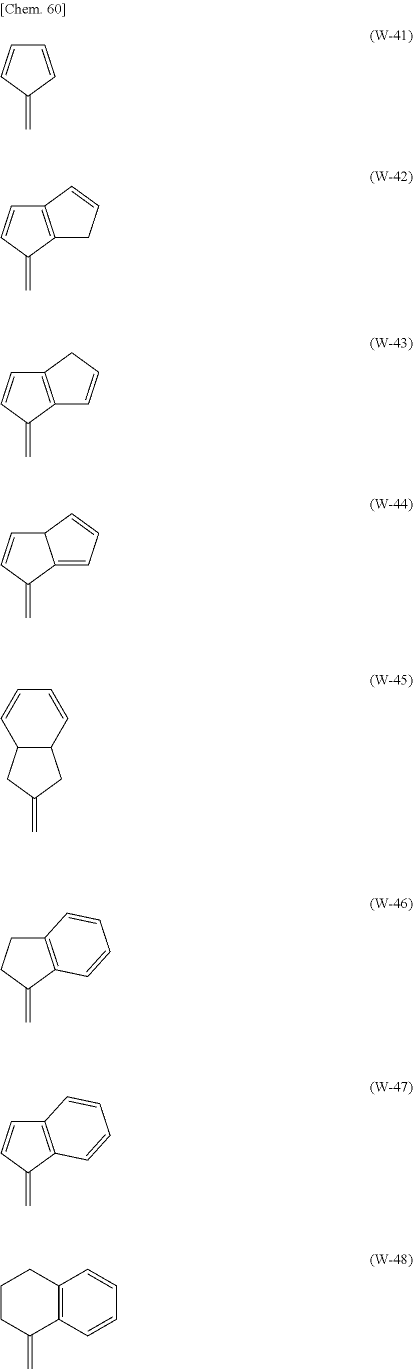

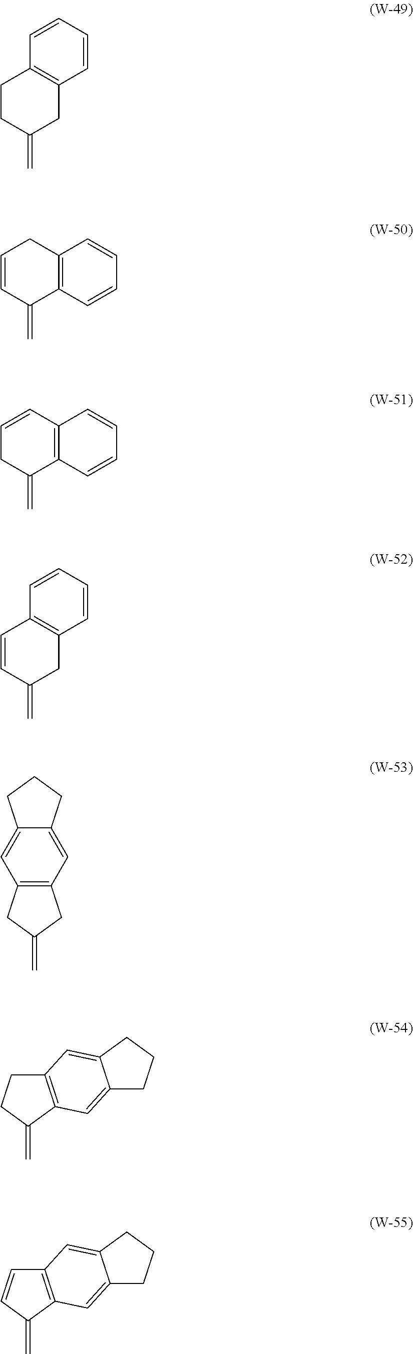

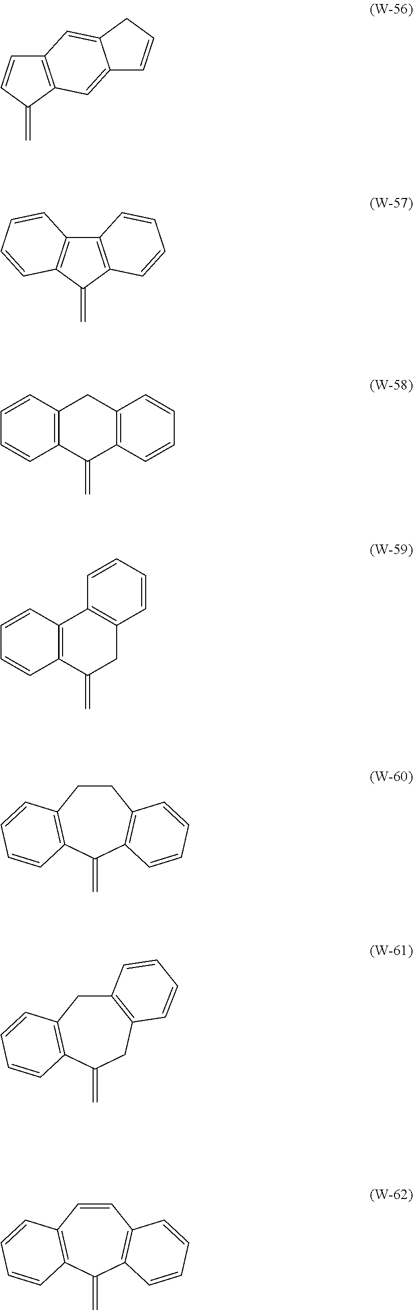

(In the formulas, an arbitrary —CH═ may be independently substituted with —N═, each —CH₂— may be independently substituted with —O—, —S—, —NR^{T}— (where R^{T} represents a hydrogen atom or an alkyl group having 1 to 20 carbon atoms), —CS—, or —CO—, provided that an —O—O— bond is not included. These groups may be unsubstituted or substituted with one or more of the substituents L^{W}'s above.)

The group represented by Formula (W-41) preferably represents groups selected from Formulas (W-41-1) to (W-41-3) which may be unsubstituted or substituted with one or more of the substituents L^{W}'s above.

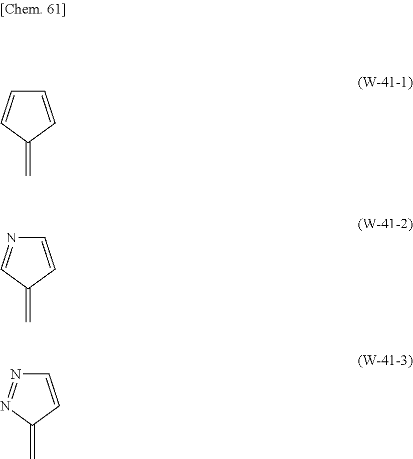

The group represented by Formula (W-42) preferably represents groups selected from Formulas (W-42-1) to (W-42-4) which may be unsubstituted or substituted with one or more of the substituents L^{W}'s above.

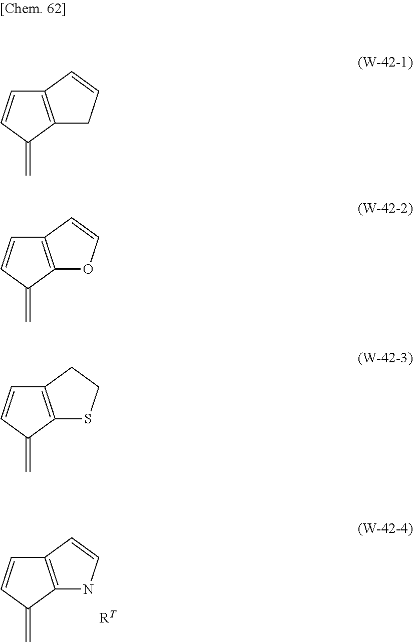

(In the formulas, R^{T} represents a hydrogen atom or an alkyl group having 1 to 8 carbon atoms.)

The group represented by Formula (W-43) preferably represents groups selected from Formulas (W-43-1) to (W-43-4) which may be unsubstituted or substituted with one or more of the substituents L^{W}'s above.

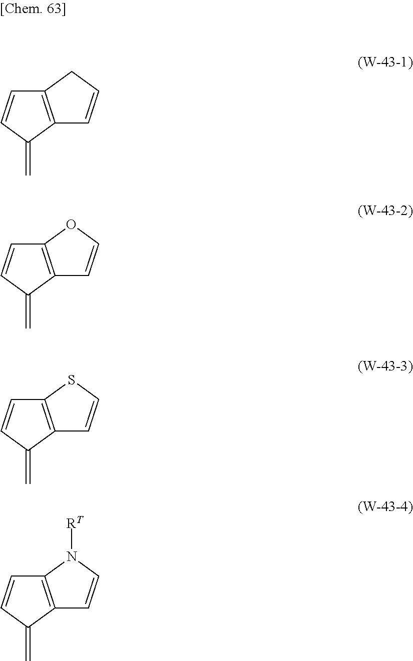

(In the formulas, R^{T} represents a hydrogen atom or an alkyl group having 1 to 8 carbon atoms.)

The group represented by Formula (W-44) preferably represents groups selected from Formulas (W-44-1) to (W-44-4) which may be unsubstituted or substituted with one or more of the substituents L^{W}'s above.

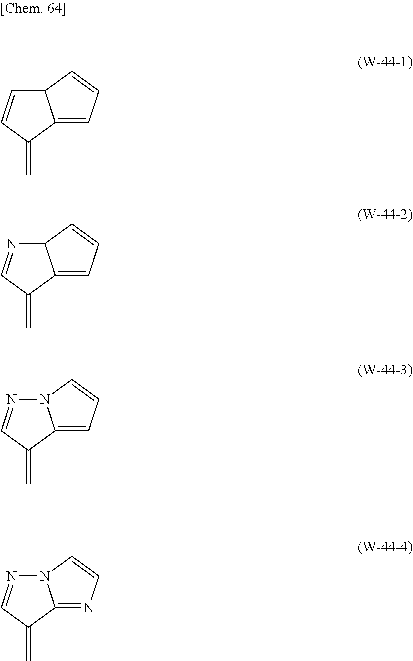

The group represented by Formula (W-45) preferably represents groups selected from Formulas (W-45-1) to (W-45-4) which may be unsubstituted or substituted with one or more of the substituents L^{W}'s above.

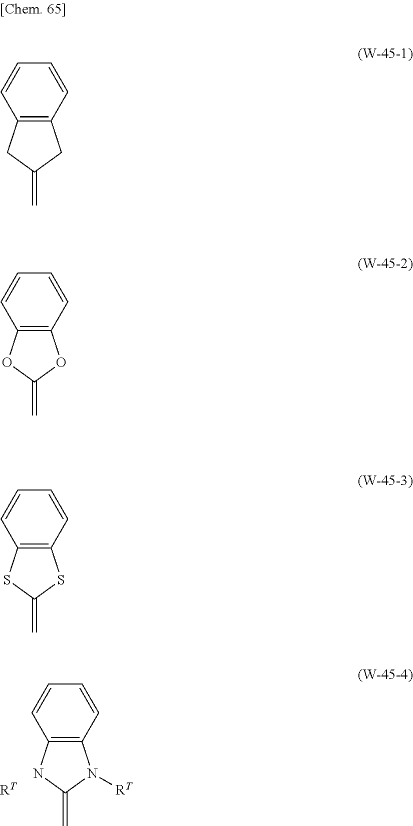

(In the formulas, R^{T} represents a hydrogen atom or an alkyl group having 1 to 8 carbon atoms.)

The group represented by Formula (W-46) preferably represents groups selected from Formulas (W-46-1) to (W-46-4) which may be unsubstituted or substituted with one or more of the substituents L^{W}'s above.

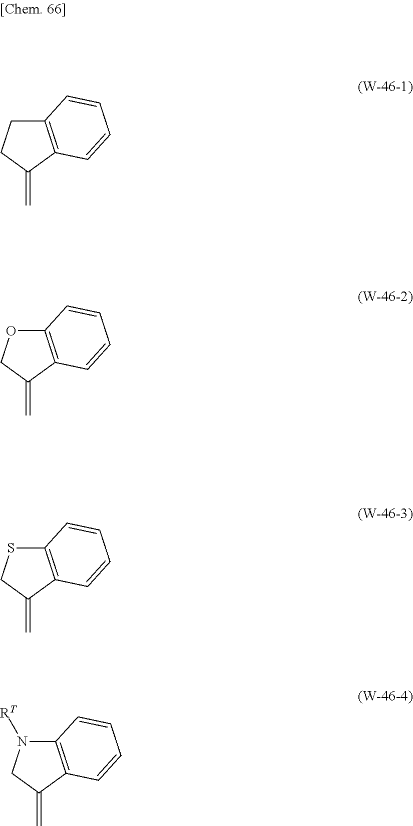

(In the formulas, R^{T} represents a hydrogen atom or an alkyl group having 1 to 8 carbon atoms.)

The group represented by Formula (W-47) preferably represents groups selected from Formulas (W-47-1) to (W-47-3) which may be unsubstituted or substituted with one or more of the substituents L^{W}'s above.

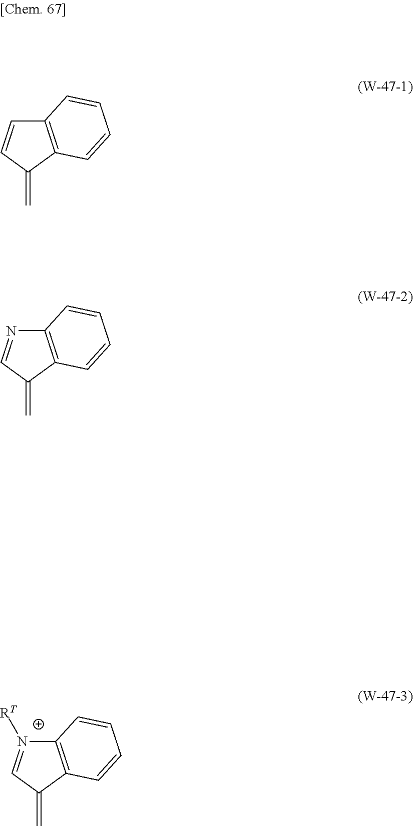

(In the formulas, R^{T} represents a hydrogen atom or an alkyl group having 1 to 8 carbon atoms.)

The group represented by Formula (W-48) preferably represents groups selected from Formulas (W-48-1) to (W-48-7) which may be unsubstituted or substituted with one or more of the substituents L^{W}'s above.

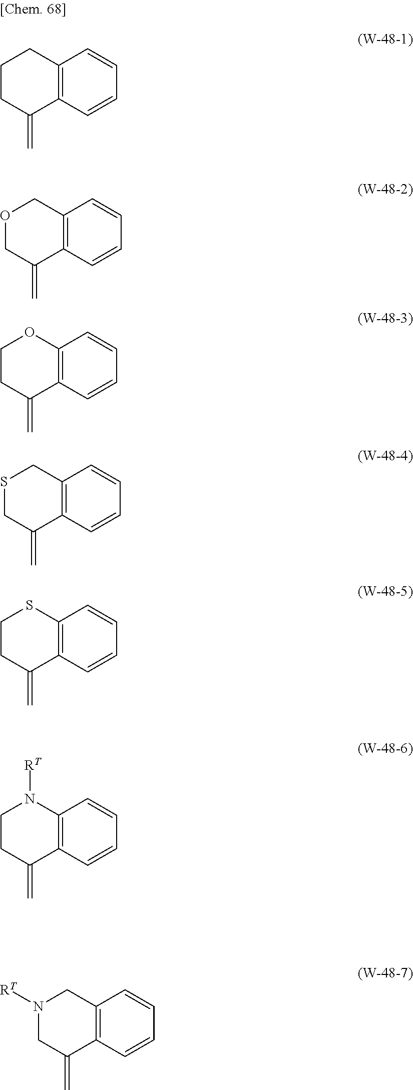

(In the formulas, R^{T} represents a hydrogen atom or an alkyl group having 1 to 8 carbon atoms.)

The group represented by Formula (W-49) preferably represents groups selected from Formulas (W-49-1) to (W-49-4) which may be unsubstituted or substituted with one or more of the substituents L^{W}'s above.

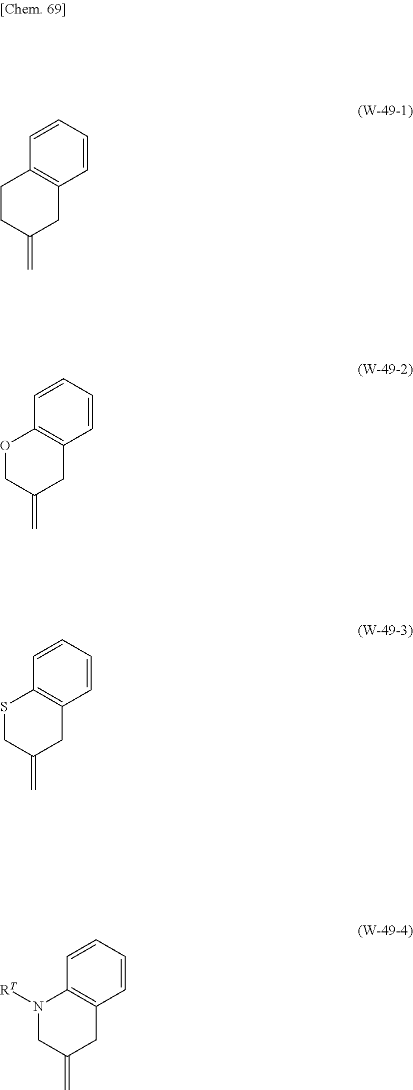

(In the formulas, R^{T} represents a hydrogen atom or an alkyl group having 1 to 8 carbon atoms.)

The group represented by Formula (W-50) preferably represents groups selected from Formulas (W-50-1) to (W-50-6) which may be unsubstituted or substituted with one or more of the substituents L^{W}'s above.

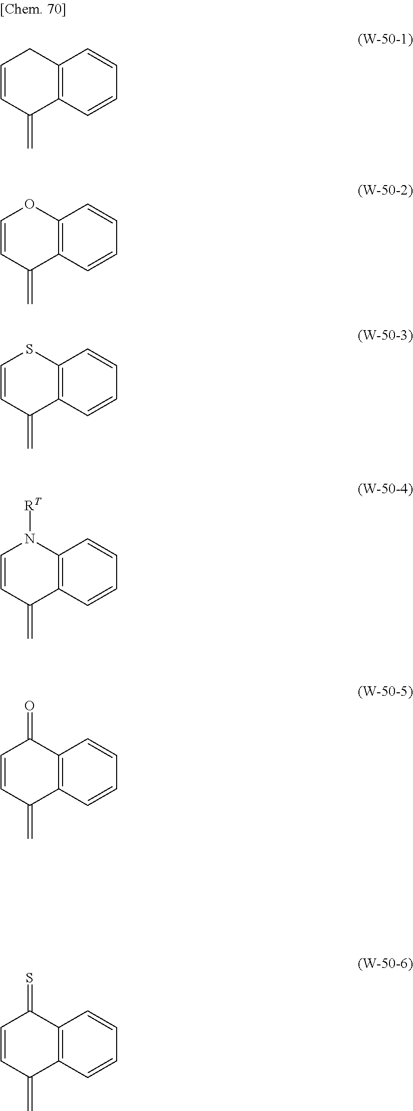

(In the formulas, R^{T} represents a hydrogen atom or an alkyl group having 1 to 8 carbon atoms.)

The group represented by Formula (W-51) preferably represents groups selected from Formulas (W-51-1) to (W-51-3) which may be unsubstituted or substituted with one or more of the substituents L^{W}'s above.

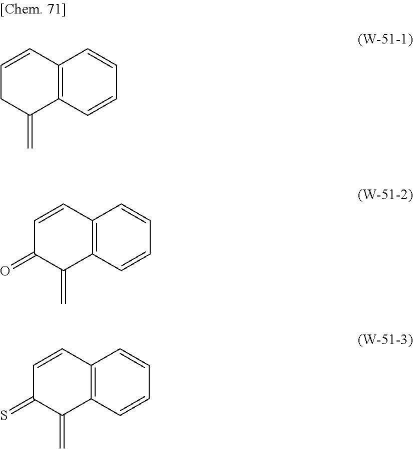

The group represented by Formula (W-52) preferably represents groups selected from Formulas (W-52-1) to (W-52-3) which may be unsubstituted or substituted with one or more of the substituents L^{W}'s above.

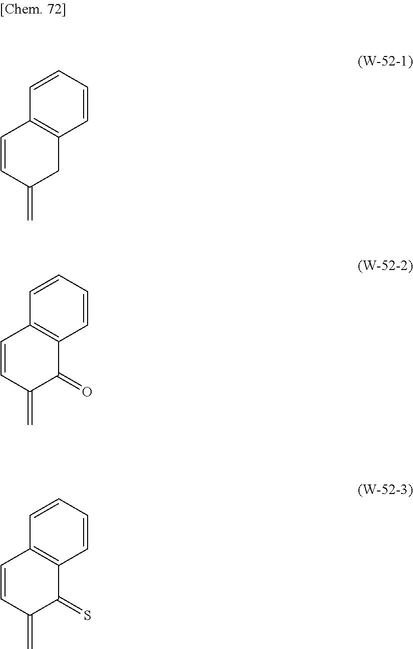

The group represented by Formula (W-53) preferably represents groups selected from Formulas (W-53-1) to (W-53-8) which may be unsubstituted or substituted with one or more of the substituents L^{W}'s above.

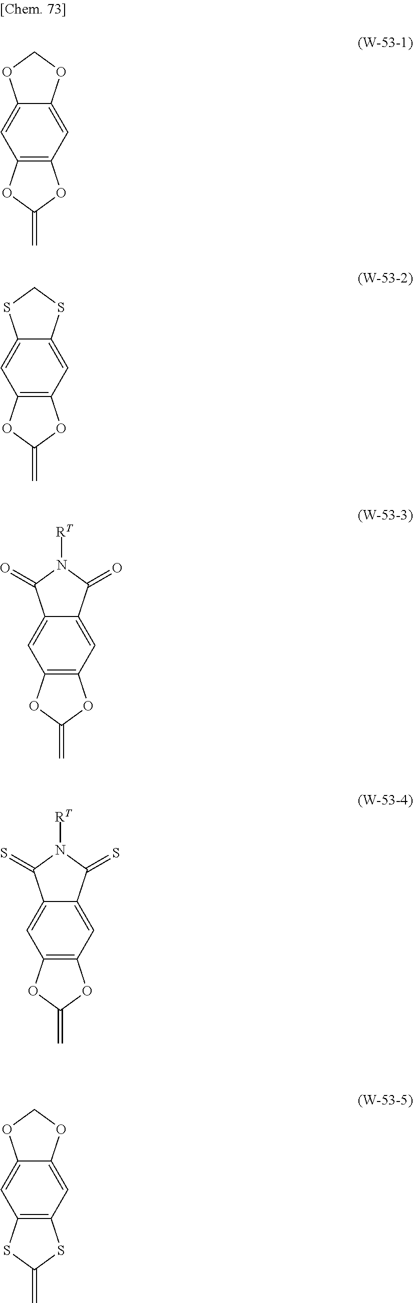

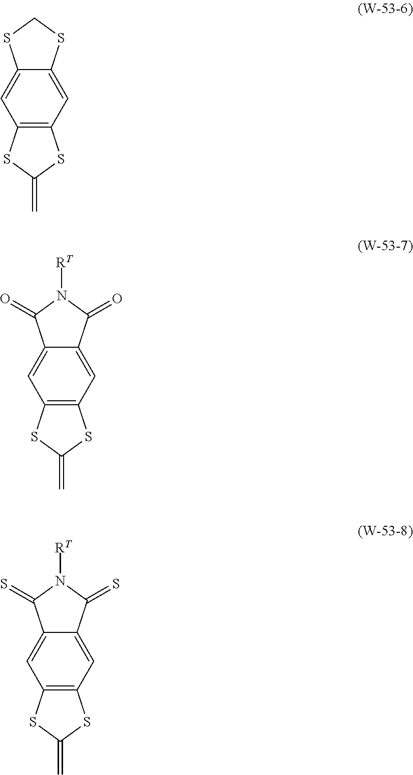

(In the formulas, R^{T} represents a hydrogen atom or an alkyl group having 1 to 8 carbon atoms.)

The group represented by Formula (W-54) preferably represents groups selected from Formulas (W-54-1) to (W-54-5) which may be unsubstituted or substituted with one or more of the substituents L^{W}'s above.

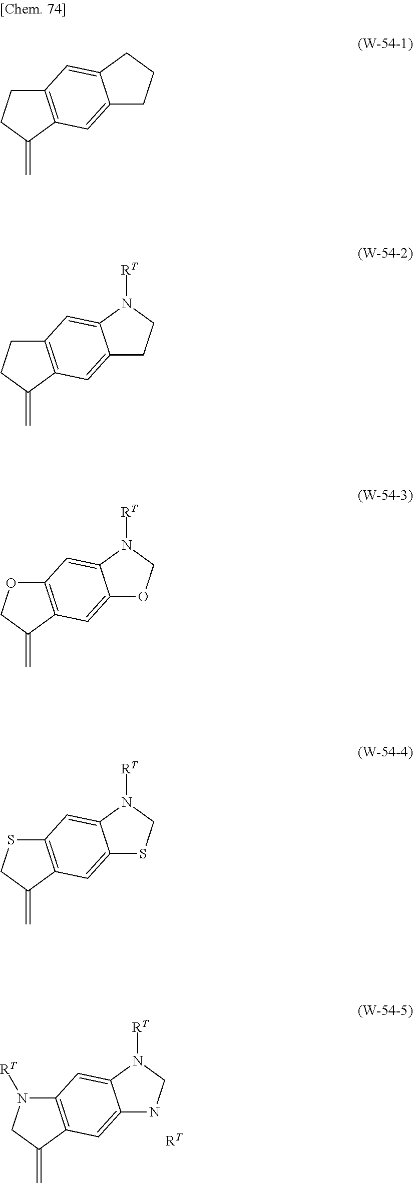

(In the formulas, R^{T} represents a hydrogen atom or an alkyl group having 1 to 8 carbon atoms.)

The group represented by Formula (W-55) preferably represents groups selected from Formulas (W-55-1) to (W-55-3) which may be unsubstituted or substituted with one or more of the substituents L^{W}'s above.

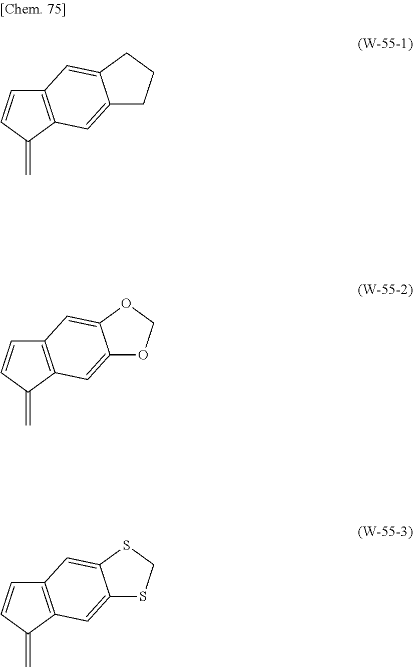

The group represented by Formula (W-56) preferably represents groups selected from Formulas (W-56-1) to (W-56-5) which may be unsubstituted or substituted with one or more of the substituents L^{W}'s above.

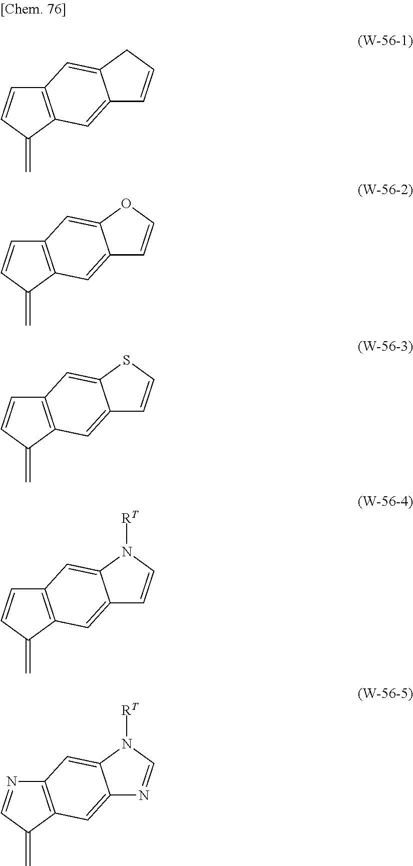

(In the formulas, R^{T} represents a hydrogen atom or an alkyl group having 1 to 8 carbon atoms.)

The group represented by Formula (W-57) preferably represents Formula (W-57-1) which may be unsubstituted or substituted with one or more of the substituents L^{W}'s above.

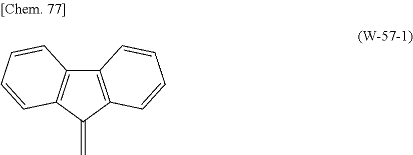

The group represented by Formula (W-58) preferably represents groups selected from Formulas (W-58-1) to (W-58-6) which may be unsubstituted or substituted with one or more of the substituents L^{W}'s above.

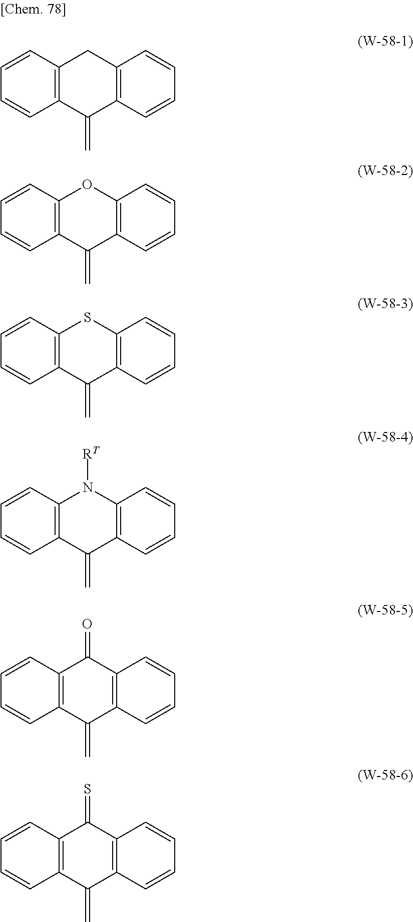

(In the formulas, R^{T} represents a hydrogen atom or an alkyl group having 1 to 8 carbon atoms.)

The group represented by Formula (W-59) preferably represents groups selected from Formulas (W-59-1) to (W-59-3) which may be unsubstituted or substituted with one or more of the substituents L^{W}'s above.

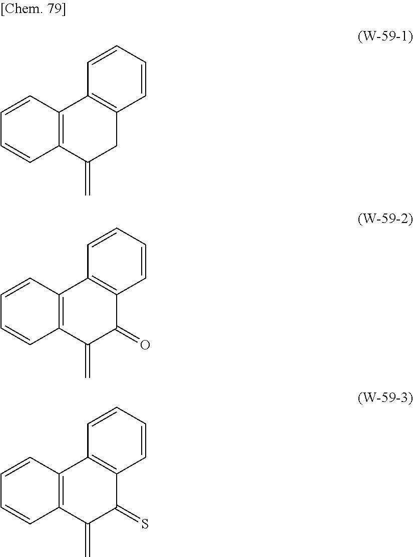

The group represented by Formula (W-60) preferably represents groups selected from Formulas (W-60-1) to (W-60-4) which may be unsubstituted or substituted with one or more of the substituents L^{W}'s above.

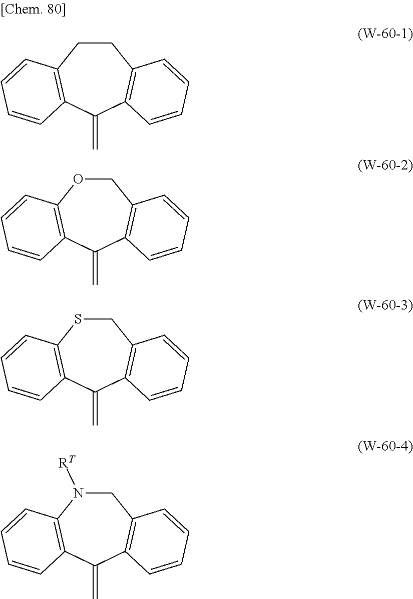

(In the formulas, R^{T} represents a hydrogen atom or an alkyl group having 1 to 8 carbon atoms.)

The group represented by Formula (W-61) preferably represents groups selected from Formulas (W-61-1) to (W-61-4) which may be unsubstituted or substituted with one or more of the substituents L^{W}'s above.

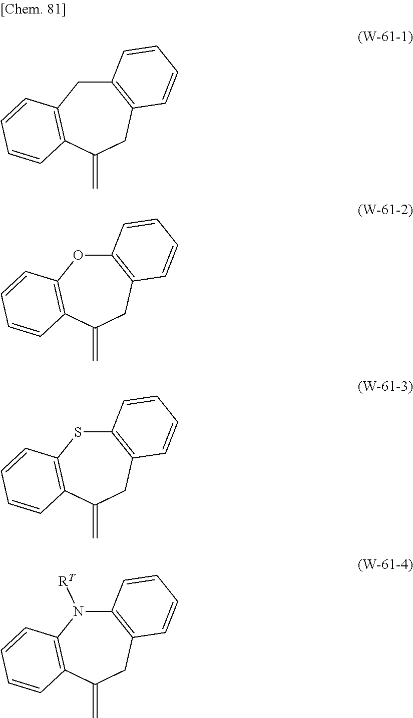

(In the formulas, R^{T} represents a hydrogen atom or an alkyl group having 1 to 8 carbon atoms.)

As the group represented by Formula (W-62), Formula (W-62-1) which may be unsubstituted or substituted with one or more of the substituents L^{W}'s above:

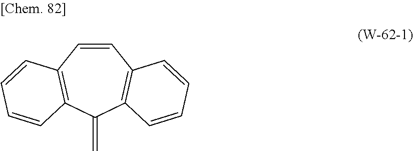 [SMILES: C=C1c2ccccc2C=Cc2ccccc21]

is preferable.

From the viewpoints of easy availability of raw materials and ease of synthesis, the cyclic group represented by ═CW¹W² more preferable represents groups selected from Formulas (W-42-2), (W-42-3), (W-43-2), (W-43-3), (W-45-3), (W-45-4), (W-57-1), (W-58-2), (W-58-3), (W-58-4), and (W-62-1) which may be unsubstituted or substituted with one or more of the substituents L^{W}'s above, still more preferable represents groups selected from Formulas (W-57-1) and (W-62-1) which may be unsubstituted or substituted with one or more of the substituents L^{W}'s above, and still more preferable represents a group represented by Formula (W-57-1) which may be unsubstituted or substituted with one or more of the substituents L^{W}'s above.

The total number of π electrons contained in W¹ and W² is preferably 4 to 24 from the viewpoints of wavelength dispersion characteristics, storage stability, liquid crystallinity, and ease of synthesis.

From the viewpoints of liquid crystallinity and ease of synthesis, L^{W} preferably represents a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which an arbitrary hydrogen atom may be substituted with a fluorine atom and one —CH₂— or two or more non-adjacent —CH₂—'s may be independently substituted with a group selected from —O—, —S—, —CO—, —COO—, —OCO—, —O—CO—O—, —CH═CH—, —CF═CF—, or —C≡C—, more preferably represents a fluorine atom, a chlorine atom, or a linear or branched alkyl group having 1 to 12 carbon atoms in which an arbitrary hydrogen atom may be substituted with a fluorine atom and one —CH₂— or two or more non-adjacent —CH₂—'s may be independently substituted with a group selected from —O—, —COO—, or —OCO—, still more preferably represents a fluorine atom, a chlorine atom, or a linear or branched alkyl group or alkoxy group having 1 to 12 carbon atoms in which an arbitrary hydrogen atom may be substituted with a fluorine atom, and particularly preferably represents a fluorine atom, a chlorine atom, or a linear alkyl group or a linear alkoxy group which has 1 to 8 carbon atoms.

In General Formula (I), G¹ more preferably represents groups selected from Formulas (G-1) to (G-22).

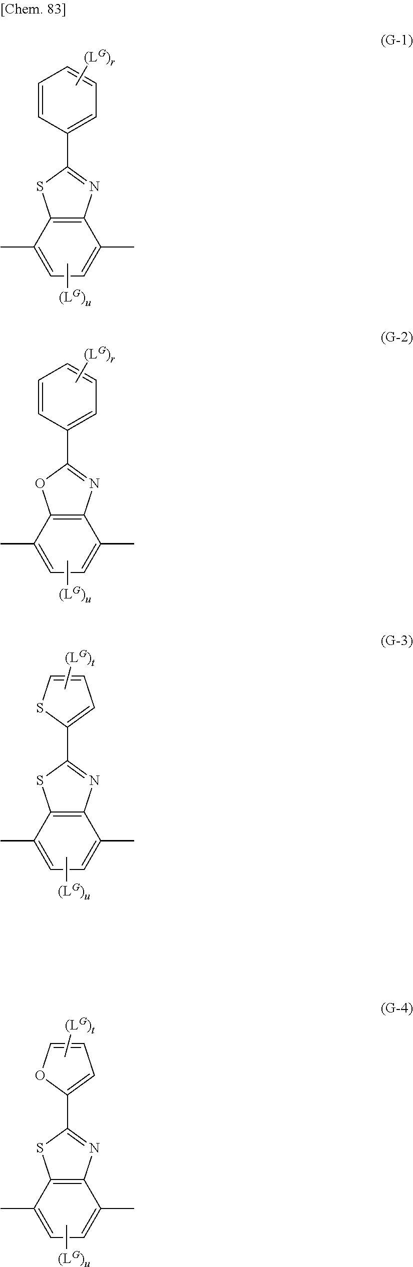

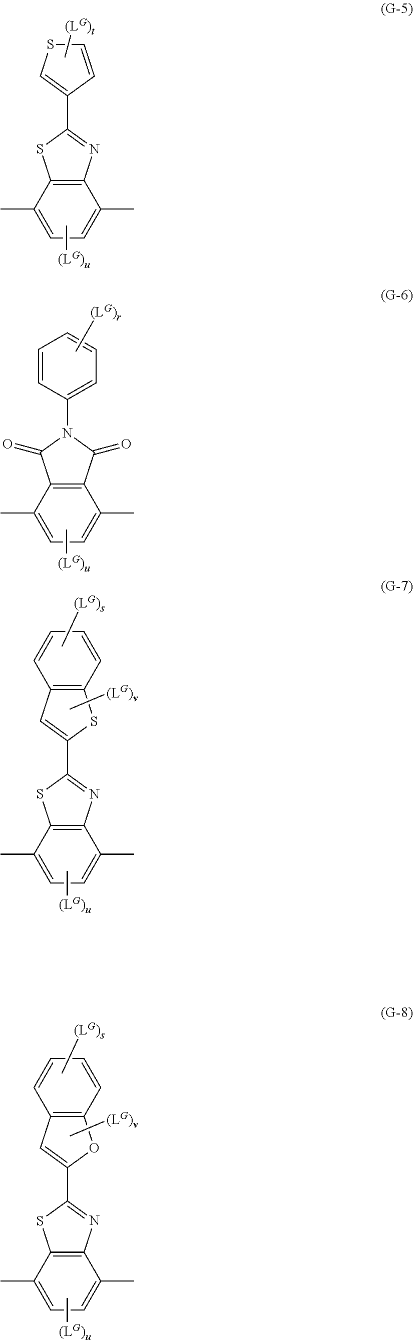

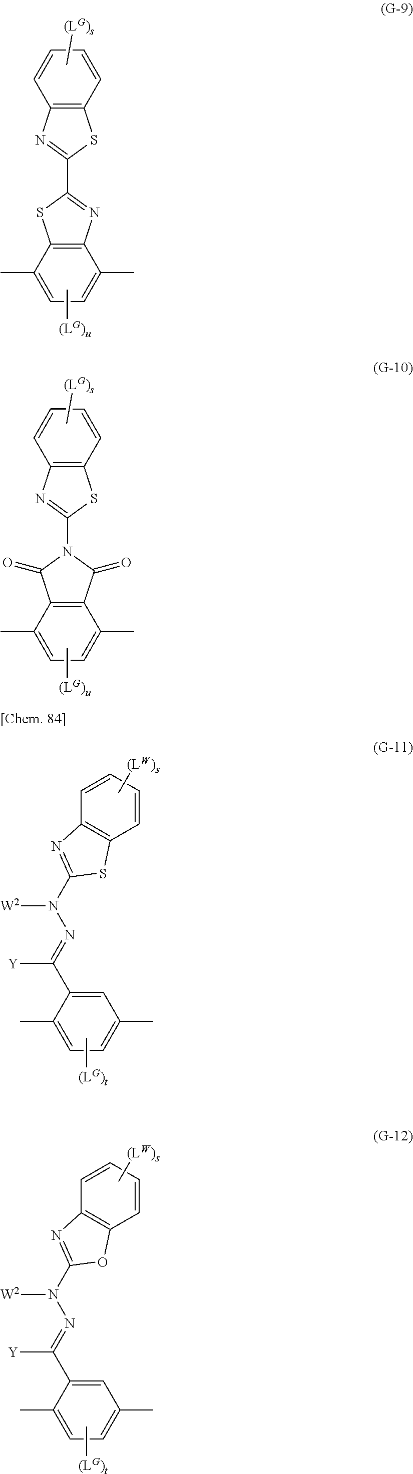

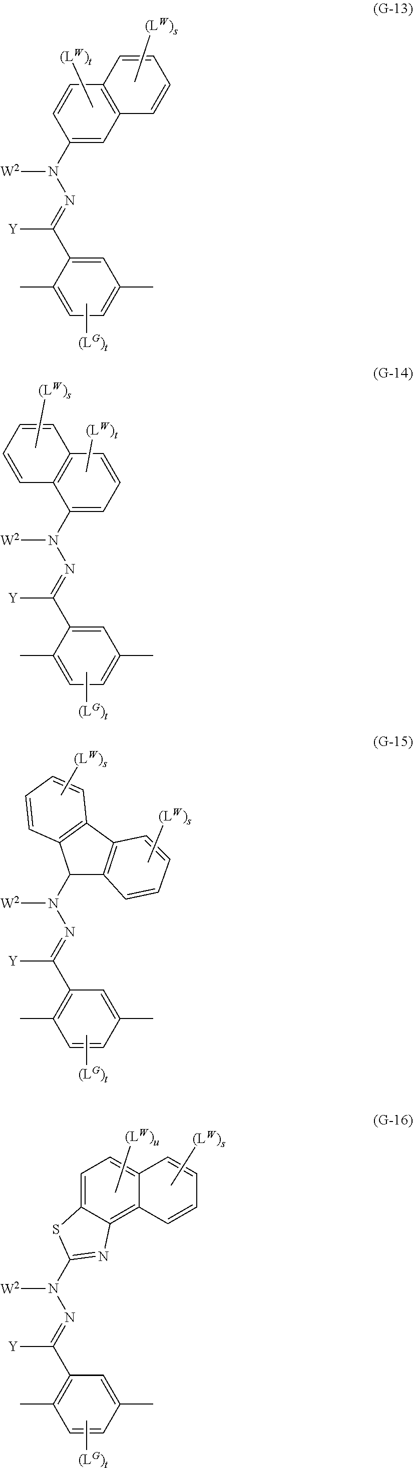

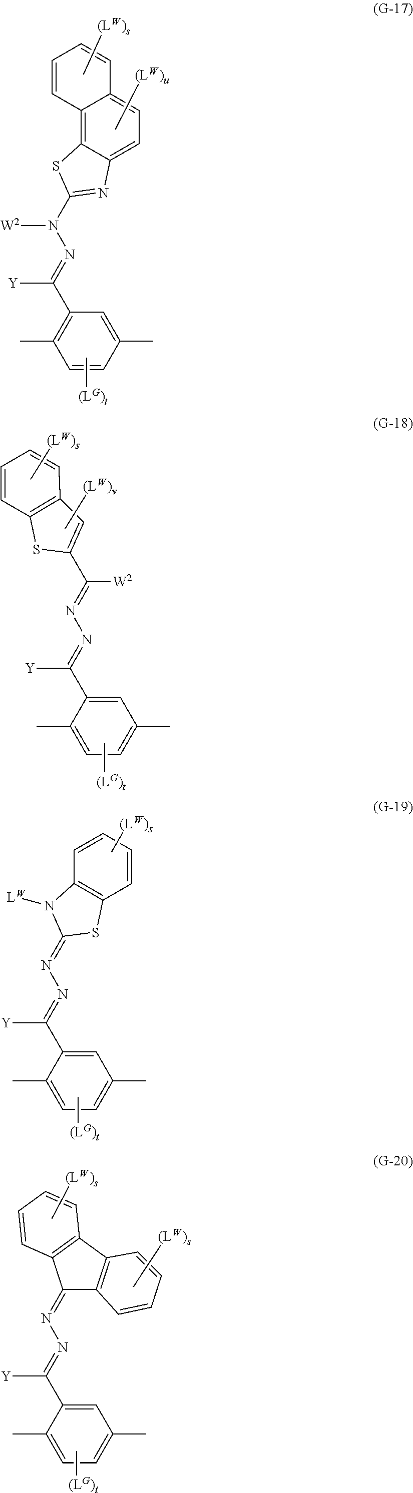

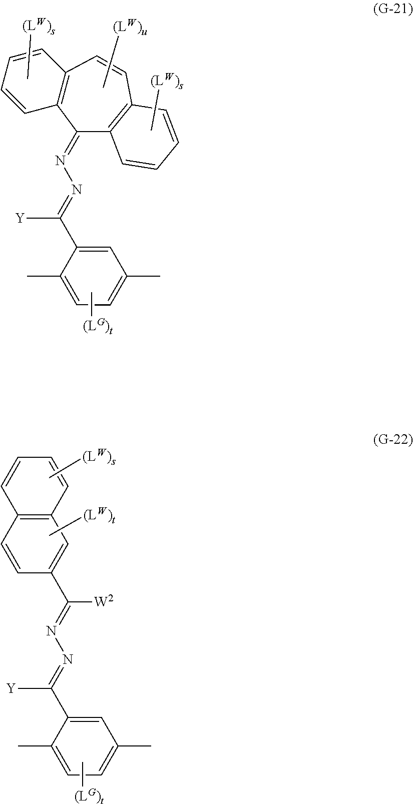

(In the formulas, L^{G}, L^{W}, Y, and W² represent the same meaning as described above, r represents an integer of 0 to 5, s represents an integer of 0 to 4, t represents an integer of 0 to 3, u represents an integer of 0 to 2, and v represents 0 or 1. These groups may be inverted in left and right.)

In Formulas (G-1) to (G-10), groups selected from Formulas (G-1), (G-3), (G-5), (G-6), (G-7), (G-8), and (G-10) are more preferable, the case where u is 0 is still more preferable, and groups selected from Formulas (G-1-1) to (G-10-1) are particularly preferable.

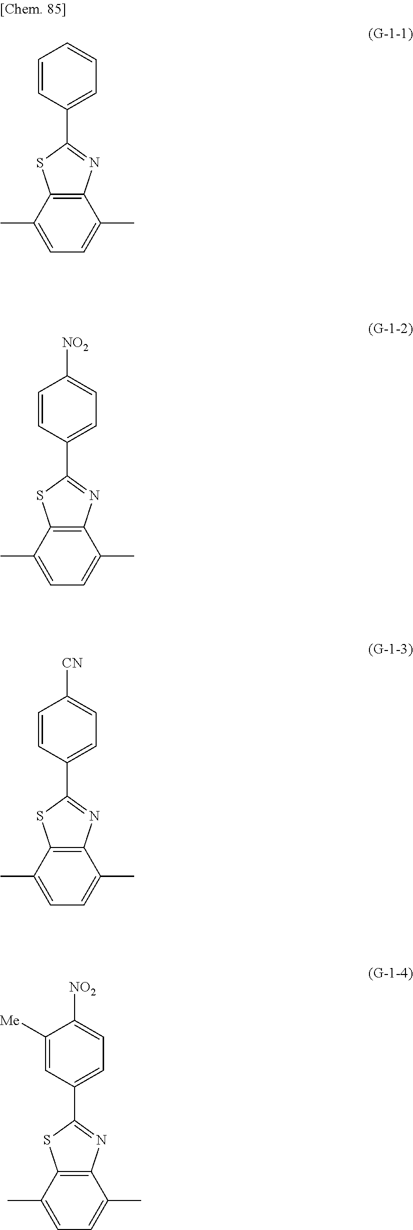

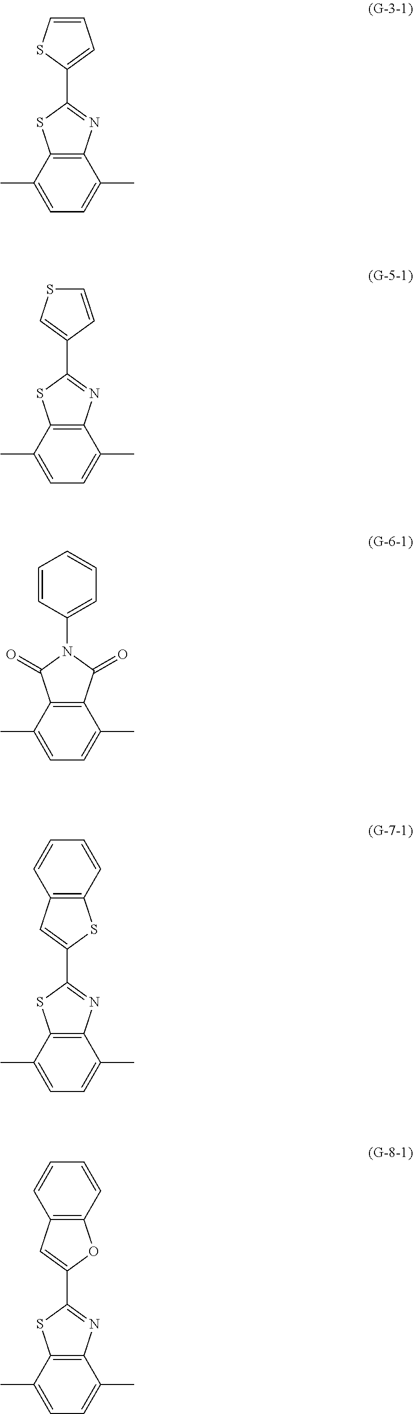

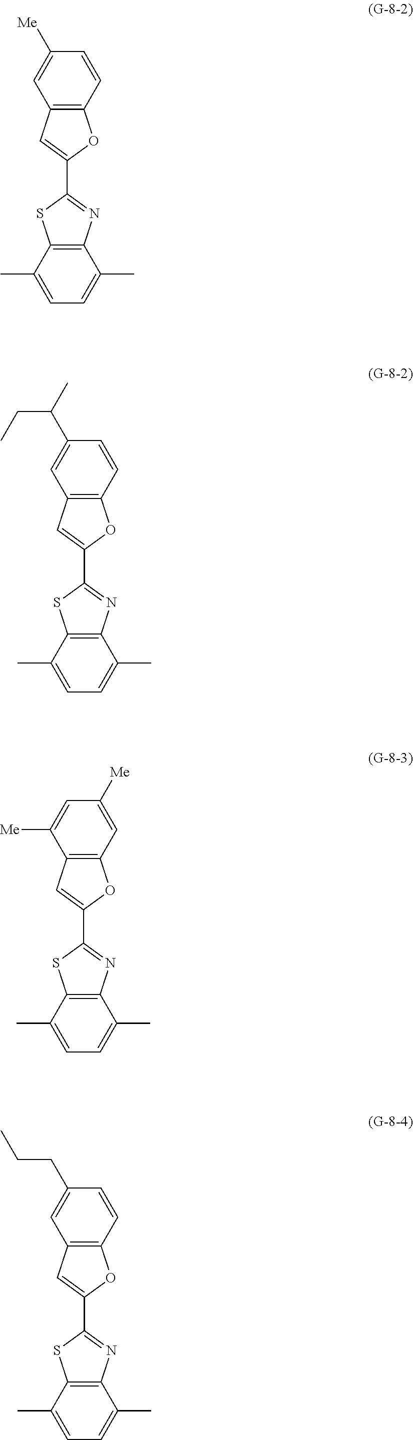

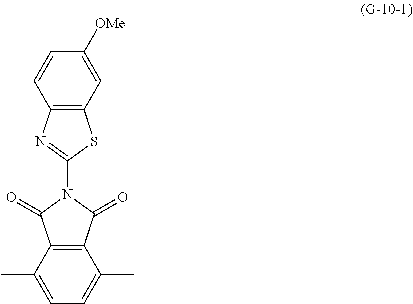

(In the formulas, these groups may be inverted in left and right.)

In Formulas (G-11) to (G-22), it is more preferable that Y represents a hydrogen atom, it is still more preferable that s, t, u, and v represent 0, and the groups selected from Formulas (G-11-1) to (G-20-1) are particularly preferable.

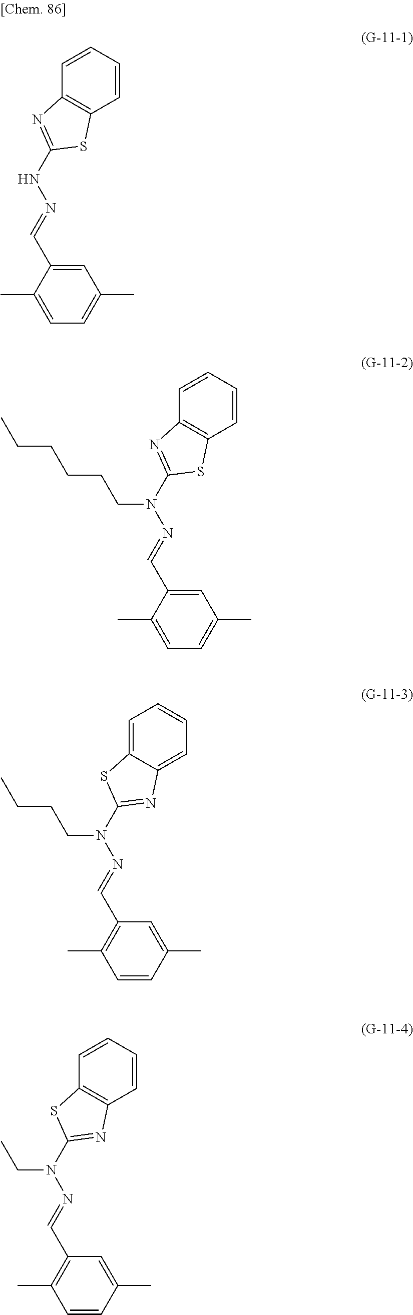

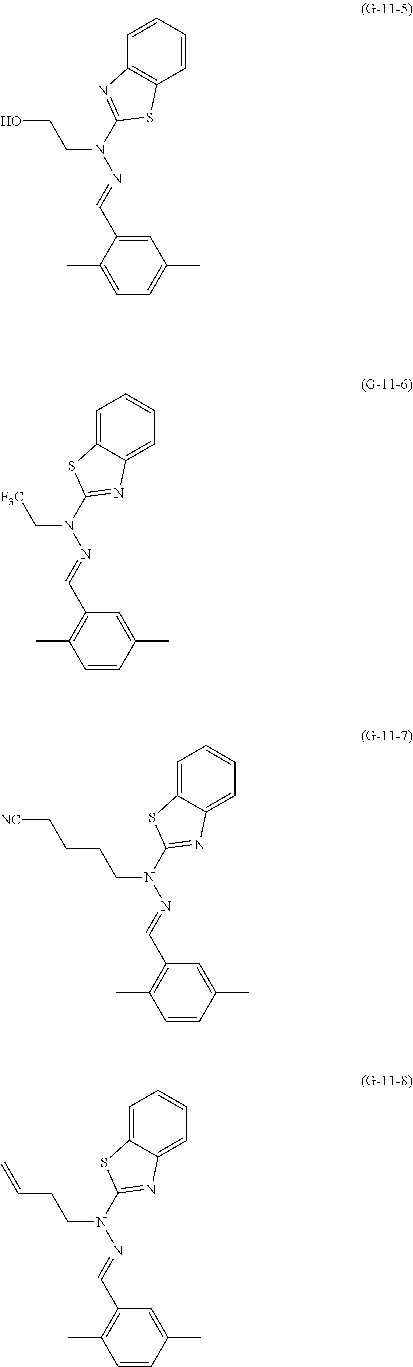

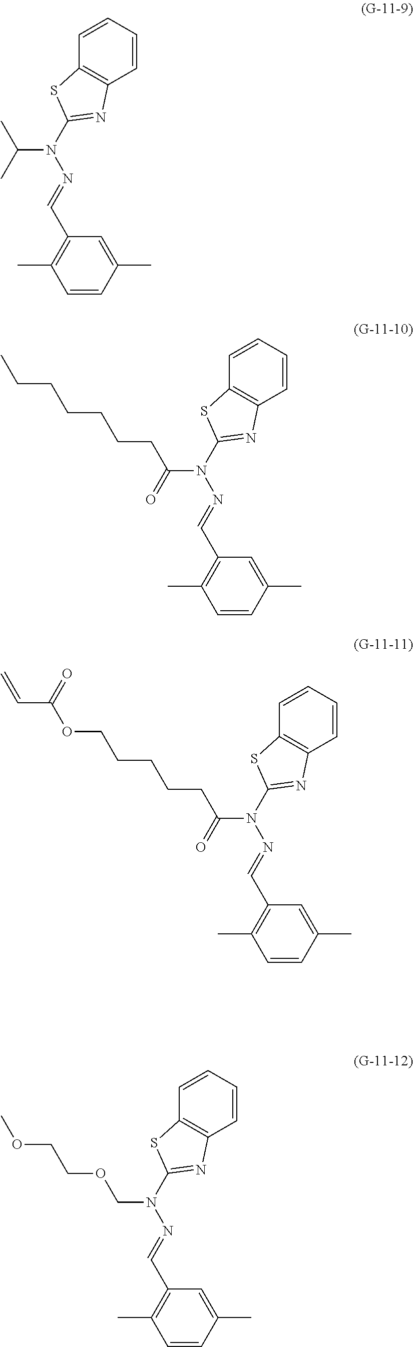

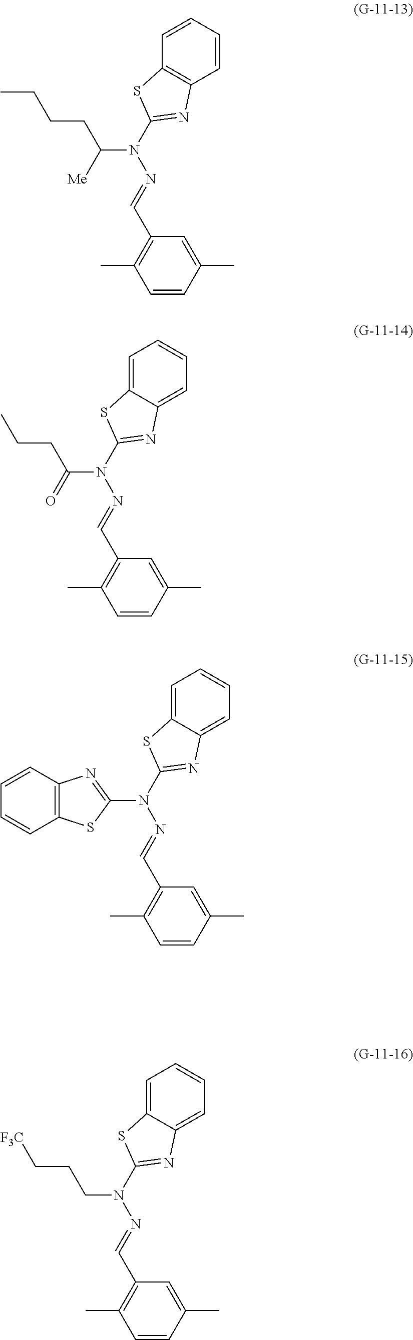

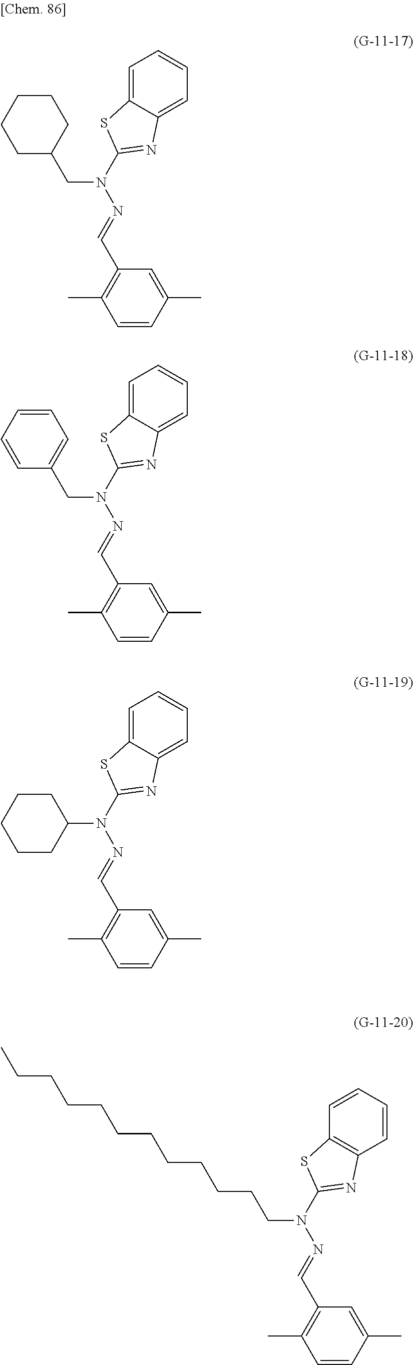

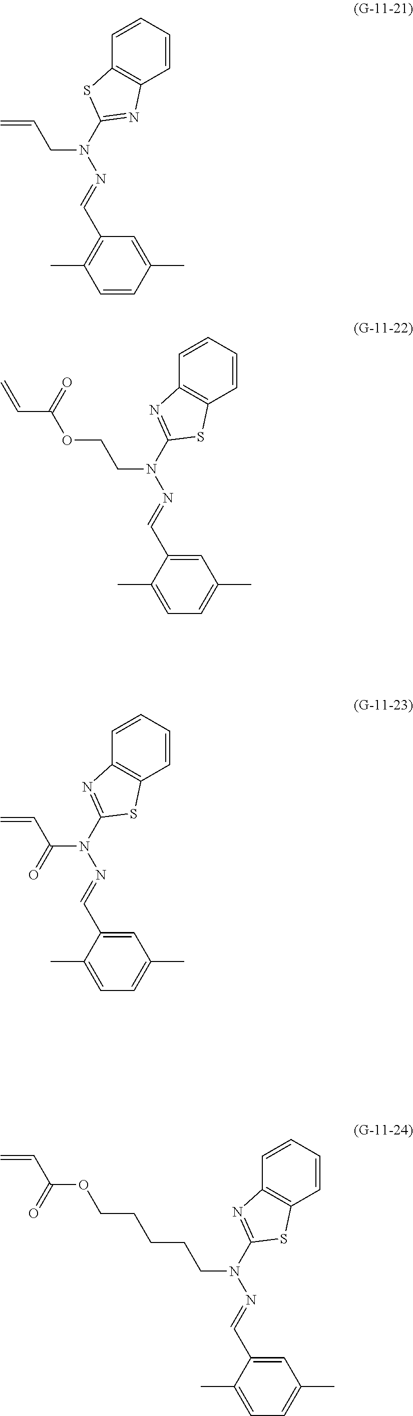

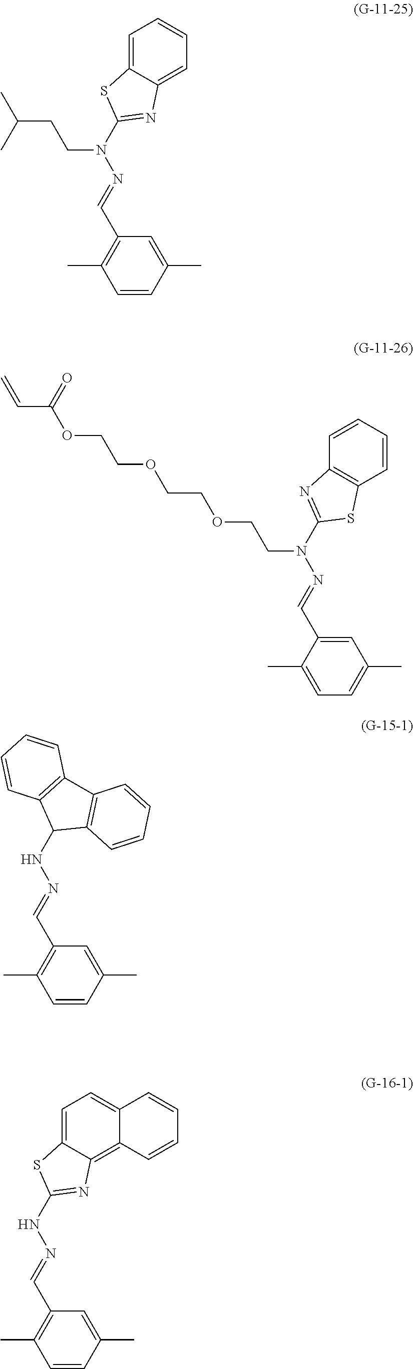

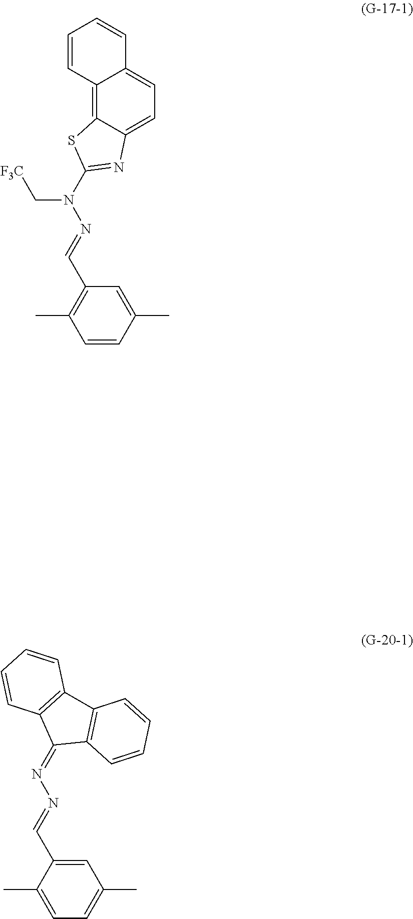 [SMILES: Cc1ccc(C)c(/C=N/N(CC(F)(F)F)c2nc3ccc4ccccc4c3s2)c1 ; Cc1ccc(C)c(/C=N/N=C2c3ccccc3-c3ccccc32)c1]

(In the formulas, these groups may be inverted in left and right.)

In the compound represented by General Formula (I), from the viewpoints of reverse dispersibility and liquid crystallinity, the compound is preferably a compound represented by General Formula (IA).

[Chem. 88]

R¹-A¹¹-Z¹¹-A¹²-Z¹²-G¹-Z²¹-A²¹-Z²²-A²²-R² (IA)

(In the formulas, R¹, R², and G¹ represent the same meanings as in General Formula (I), A¹¹, A¹², A²¹, and A²² represent the same meanings as A¹ and A² in General Formula (I), Z¹¹ and Z¹² represent the same as Z¹ in General Formula (I), and Z²¹ and Z²² represent the same meaning as Z² in General Formula (I), provided that at least one of Z¹¹, Z¹², Z²¹ and Z²² represents a group selected from —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —NH—O—, —O—NH—, —SCH₂—, —CH₂S—, —CF₂O—, —OCF₂—, —CF₂S—, —SCF₂—, —CH═CH—, —N═N—, —CH═N—, —N═CH—, —CF═CF—, —C≡C—, or a single bond.)

Preferred forms of each group are the same as those in General Formula (I).

In the compound represented by Formula (IA), from the viewpoints of reverse dispersibility and liquid crystallinity, it is more preferable that A¹¹, A¹², A²¹, and A²² each independently represent a 1,4-phenylene group, a 1,4-cyclohexylene group, or a naphthalene-2,6-diyl group which may be unsubstituted or substituted with one or more of the substituents L's. It is still more preferable that A¹¹, A¹², A²¹, and A²² each independently represent groups selected from Formulas (A-1) to (A-11).

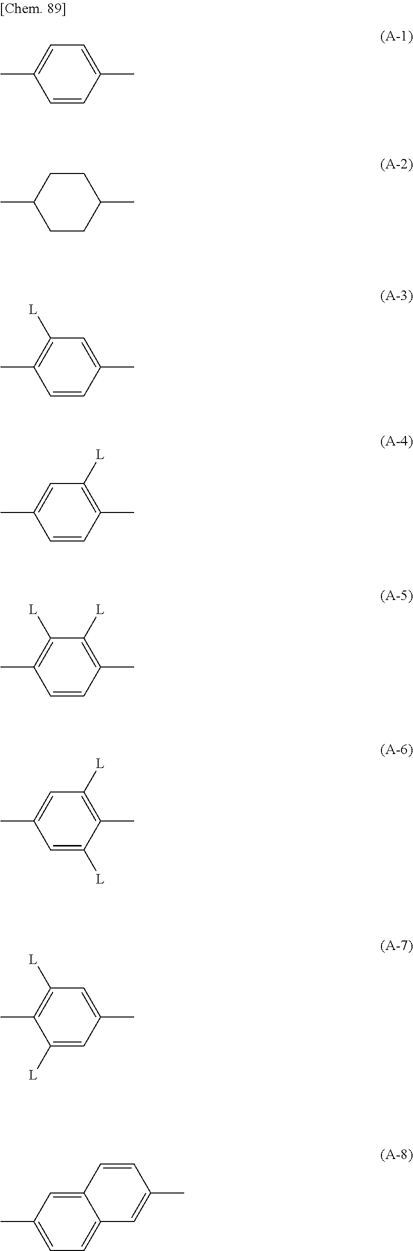

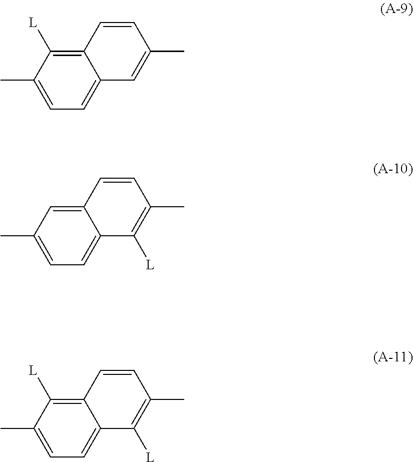

It is still more preferable that A¹¹, A¹², A²¹, and A²² each independently represent groups selected from Formulas (A-1) to (A-8), and it is particularly preferable that A¹¹, A¹², A²¹, and A²² each independently represent groups selected from Formulas (A-1) to (A-4). From the viewpoint of reverse dispersibility, it is preferable that A¹² and A²¹ each independently represent a 1,4-cyclohexylene group which may be unsubstituted or substituted with one or more of the substituents L's. It is more preferable that A¹² and A²¹ each independently represent a group represented by Formula (A-2). From the viewpoints of refractive index anisotropy, ease of synthesis, and solubility in a solvent, it is preferable that A¹¹ and A²² each independently represent a 1,4-phenylene group or a naphthalene-2,6-diyl group which may be unsubstituted or substituted with one or more of the substituents L's. It is more preferable that A¹¹ and A²² each independently represent groups selected from Formulas (A-1), and (A-3) to (A-11). It is still more preferable that A¹¹ and A²² each independently represent groups selected from Formulas (A-1), and (A-3) to (A-8). It is still more preferable that A¹¹ and A²² each independently represent groups selected from Formulas (A-1), (A-3), and (A-4). It is particularly preferable that A¹¹ and A²² each independently represent a group represented by Formula (A-1).

In the compound represented by Formula (IA), from the viewpoints of liquid crystallinity, easy availability of raw materials, and ease of synthesis, Z¹¹, Z¹², 21 and Z²² each preferably represent —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C—, or a single bond, more preferably represent —OCH₂—, —CH₂O—, —COO—, —OCO—, —CF₂O—, —OCF₂—, —CH₂CH₂—, —COO—CH₂CH₂—, —OCO—CH₂CH₂—, —CH₂CH₂—COO—, —CH₂CH₂—OCO—, —CH═CH—, —C≡C—, or a single bond, still more preferably represent —OCH₂—, —CH₂O—, —COO—, —OCO—, —CF₂O—, —OCF₂—, or a single bond, and still more preferably represent —OCH₂—, —CH₂O—, —COO—, —OCO—, or a single bond. From the viewpoints of reverse dispersibility and liquid crystallinity, it is particularly preferable that Z¹¹ and Z²² each independently represent —COO—, —OCO—, or a single bond, and it is particularly preferable that Z¹² and Z²¹ each independently represent —OCH₂—, —CH₂O—, —COO—, or —OCO—.

From the viewpoint of liquid crystallinity, a 1,4-cyclohexylene group, a tetrahydropyran-2,5-diyl group, a 1,3-dioxane-2,5-diyl group, and a decahydronaphthalene-2,6-diyl group contained in the compound represented by General Formula (I) may be in either a cis form or a trans form, or may be a mixture thereof, but from the viewpoint of liquid crystallinity, it is preferable that the trans form is the main component, and it is particularly preferable that only the trans form is used.

The mixture of the present invention is preferably used in a nematic liquid crystal composition, a smectic liquid crystal composition, a chiral smectic liquid crystal composition, and a cholesteric liquid crystal composition. A compound other than that of the invention of the present application may be added to the liquid crystal composition using the mixture of the invention of the present application.

Examples of other polymerizable compounds to be mixed with the mixture of the invention of the present application so as to be used include a rod-like polymerizable liquid crystal compound which has a rigid site which is a mesogenic group in which a plurality of structures such as a 1,4-phenylene group and a 1,4-cyclohexylene group are linked and has a polymerizable functional group such as a vinyl group, an acryloyl group, and a (meth)acryloyl group, as described in Handbook of Liquid Crystals (D. Demus, J. W. Goodby, G. W. Gray, H. W. Spiess, V. Vill Editor, Published by Wiley-VCH Company, 1998), Quarterly Chemical Review No. 22, Chemistry of Liquid Crystals (edited by The Chemical Society of Japan, 1994), or JP-A-7-294735, JP-A-8-3111, JP-A-8-29618, JP-A-11-80090, JP-A-11-116538, and JP-A-11-148079, and the like, or a rod-like polymerizable liquid crystal compound having a maleimide group as described in JP-A-2004-2373 and JP-A-2004-99446.

As specific examples of the other polymerizable compounds to be used by mixing with the mixture of the invention of the present application, preferred are compounds represented by General Formula (X-11):

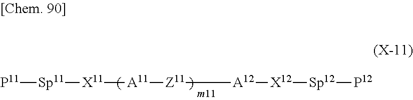

and/or General Formula (X-12):

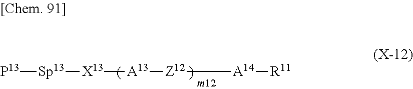

(In the formulas, P¹¹, P¹², and P¹³ each independently represent a polymerizable group, Sp¹¹, Sp¹², and Sp¹³ each independently represent a single bond or an alkylene group having 1 to 20 carbon atoms, but one —CH₂— or two or more non-adjacent —CH₂—'s may be independently substituted with —O—, —COO—, —OCO—, or —OCOO—, X¹¹, X¹², and X¹³ each independently represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C≡C—, or a single bond, Z¹¹ and Z¹² each independently represent-O—, —S—, —OCH₂—, —CH₂O—, —COO—, —OCO—, —CO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH₂CH₂—, —CH₂CF₂—, —CF₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C≡C—, or a single bond, and in the case where a plurality of Z¹¹'s are present, these may be the same as or different from each other, and in the case where a plurality of Z¹²'s are present, these may be the same as or different from each other, A¹¹, A¹², A¹³, and A¹⁴ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, or a 1,3-dioxane-2,5-diyl group, in which A¹¹, A¹², A¹³, and A¹⁴ each may be independently unsubstituted or substituted with a substituent L¹¹, in the case where a plurality of A¹¹ are present, these are the same as or different from each other, and in the case where a plurality of A¹³ are present, these are the same as or different from each other, L¹¹ represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or L¹¹ may represent a group represented by P^{L11}-(Sp^{L11}-X^{L11})_{kL11}— in which P^{L11} represents a polymerizable group and a preferable polymerizable group is the same as that in the case of P⁰, Sp^{L11} represents a spacer group or a single bond and a preferable spacer group is the same as that in the case of Sp⁰, in the case where a plurality of Sp^{L11}'s are present, these may be the same as or different from each other, X^{L11} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{L11}'s are present, these may be the same as or different from each other, with the proviso that P^{L11}-(Sp^{L11}-X^{L11})_{kL11}— does not contain an —O—O— bond, kL11 represents an integer of 0 to 10, but in the case where a plurality of L¹¹'s are present in the compound, these may be the same as or different from each other, R¹¹ represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and m11 and m12 each independently represent an integer of 0 to 3.)

The case where P¹¹, P¹², and P¹³ are an acryl group or a methacrylic group is particularly preferable. Specific examples of the compound represented by General Formula (X-11) include compounds represented by Formulas (X-11-A) to (X-11-F).

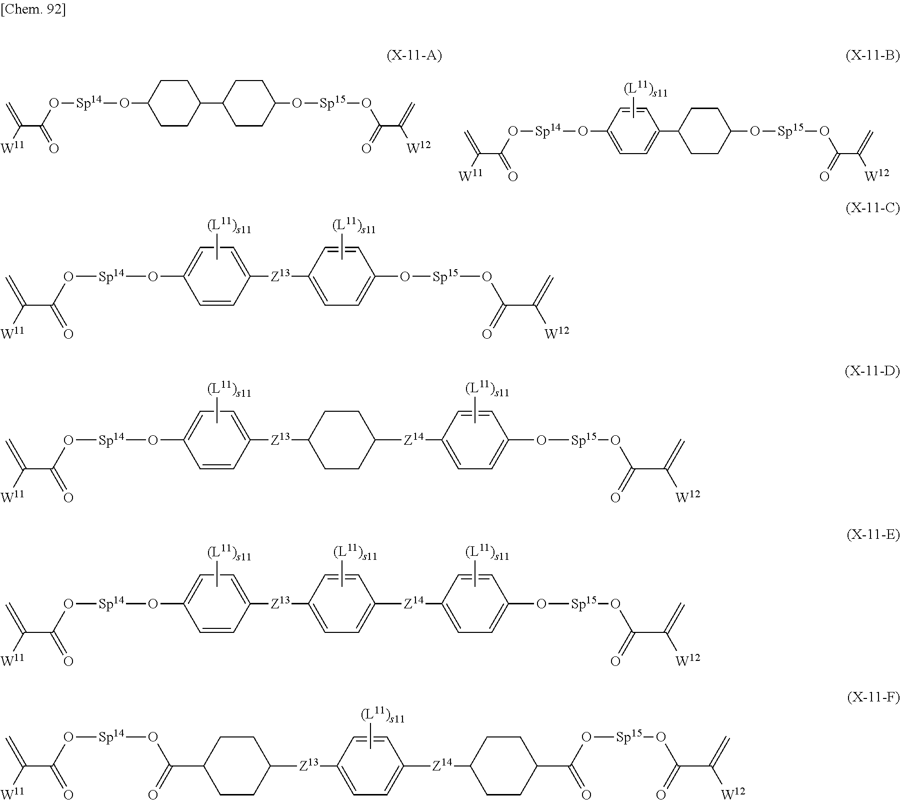

(In the formulas, W¹¹ and W¹² each independently represent a hydrogen atom, a fluorine atom, a methyl group, or a trifluoromethyl group, Sp¹⁴ and Sp¹⁵ each independently represent an alkylene group having 2 to 18 carbon atoms, Z¹³ and Z¹⁴ each independently represent —OCH₂—, —CH₂O—, —COO—, —OCO—, —COO—CH₂CH₂—, —OCO—CH₂CH₂—, —CH₂CH₂—COO—, —CH₂CH₂—OCO—, —C≡C—, or a single bond, L¹¹ represents the same meaning as described above, and s11 represents an integer of 0 to 4.)

In Formulas (X-11-A) to (X-11-F), it is more preferable that W¹¹ and W¹² each independently represent a hydrogen atom or a methyl group, it is more preferable that Z¹³ and Z¹⁴ each independently represent —COO—, —OCO—, —COO—CH₂CH₂—, or —CH₂CH₂—OCO—, it is still more preferable that Z¹³ and Z¹⁴ each independently represent —COO— or —OCO—, and it is more preferable that L¹¹ each represents a fluorine atom, a chlorine atom, a methyl group, or a methoxy group.

More specific examples of the compound represented by Formula (X-11) include compounds represented by Formulas (X-11-B-1) to (X-11-F-2).

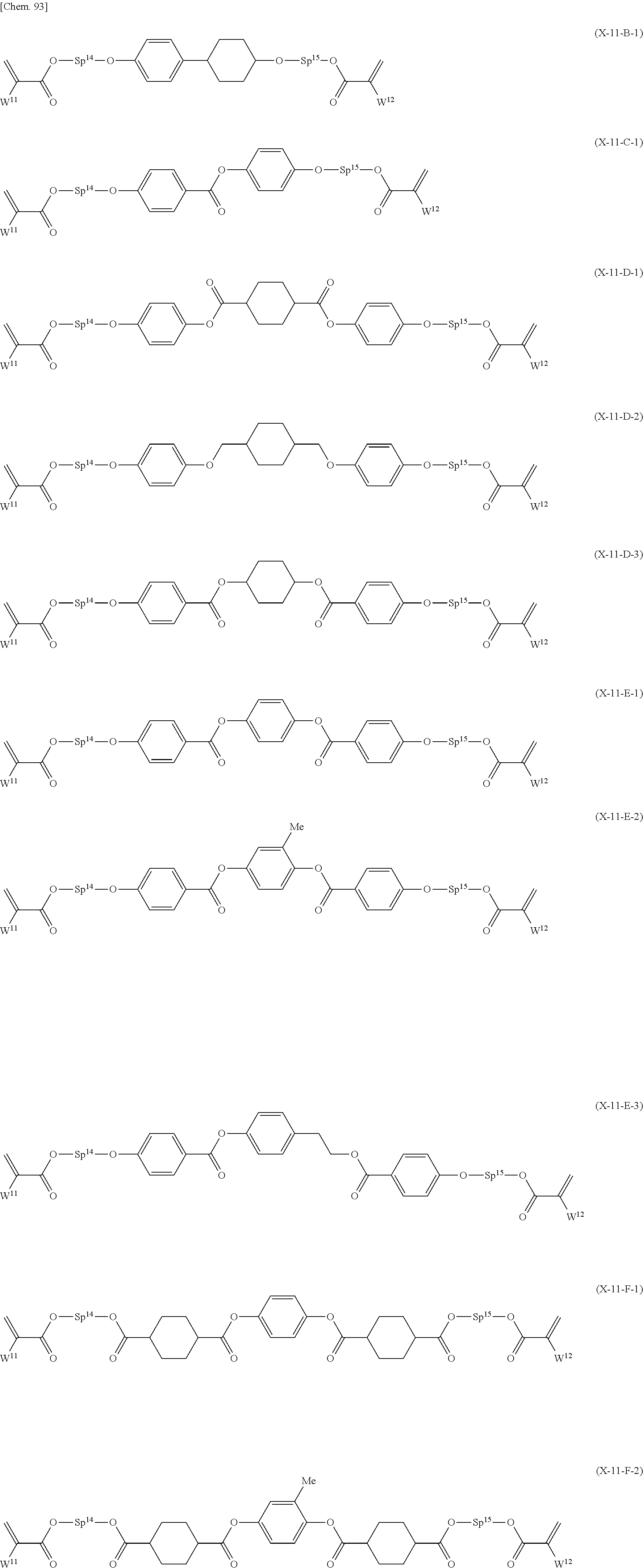

(In the formulas, W¹¹, W¹², Sp¹⁴, and Sp¹⁵ each independently represent the same meaning as described above.)

Specific examples of the compound represented by General Formula (X-12) include compounds represented by General Formulas (X-12-A) to (X-12-E)

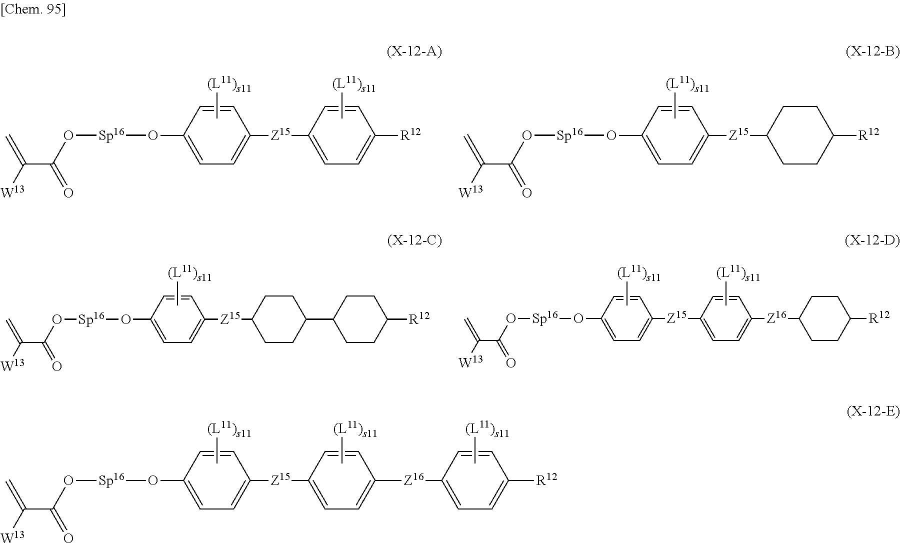

(In the formulas, W¹³ each independently represent a hydrogen atom, a fluorine atom, a methyl group, or a trifluoromethyl group, Sp¹⁶ each independently represent an alkylene group having 2 to 18 carbon atoms, Z¹⁵ and Z¹⁶ each independently represent —OCH₂—, —CH₂O—, —COO—, —OCO—, —COO—CH₂CH₂—, —OCO—CH₂CH₂—, —CH₂CH₂—COO—, —CH₂CH₂—OCO—, —C≡C—, or a single bond, L¹¹ represents the same meaning as described above, s11 represents an integer of 0 to 4, and R¹² represents a hydrogen atom, a fluorine atom, a cyano group, an alkyl group having 1 to 10 carbon atoms, or an alkoxy group having 1 to 10 carbon atoms.)

In Formulas (X-12-A) to (X-12-E), it is more preferable that W¹³ each independently represent a hydrogen atom or a methyl group, it is more preferable that Z¹⁵ and Z¹⁶ each independently represent —COO—, —OCO—, —C≡C—, or a single bond, it is still more preferable that Z¹⁵ and Z¹⁶ each independently represent —COO—, —OCO—, or a single bond, and it is more preferable that L¹¹ each represent a fluorine atom, a chlorine atom, a methyl group, or a methoxy group.

More specific examples of the compound represented by Formula (X-12) include compounds represented by Formulas (X-12-A-1) to (X-12-E-6)

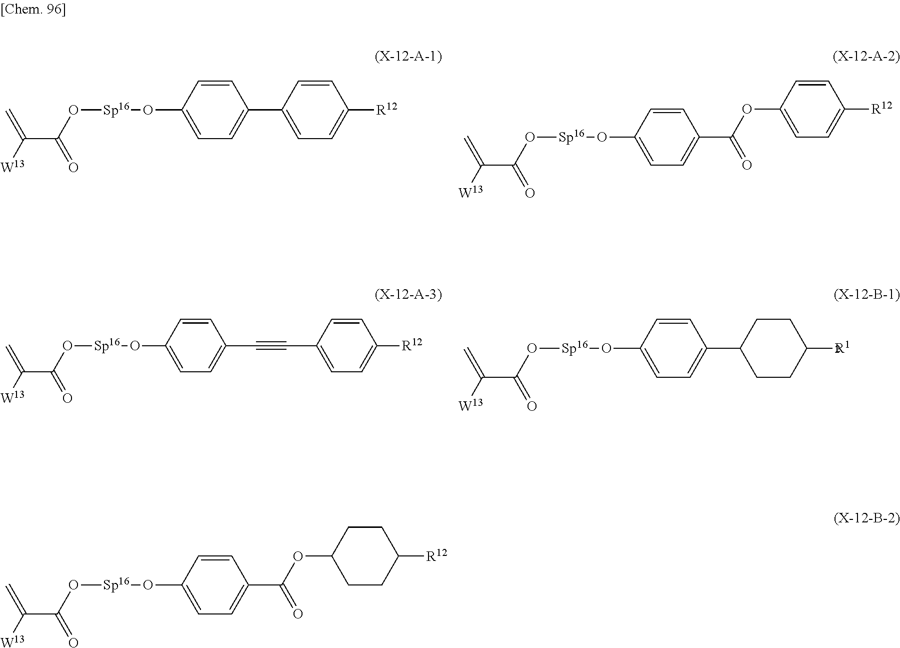

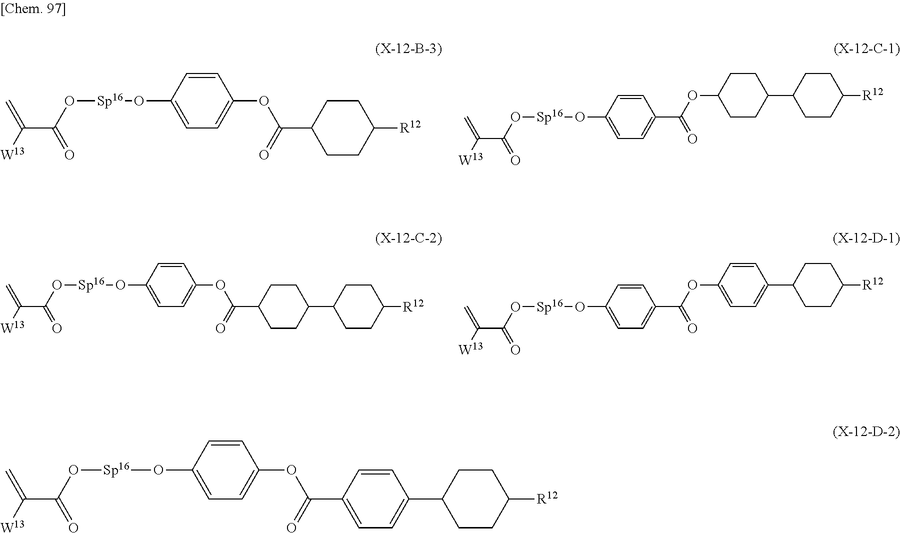

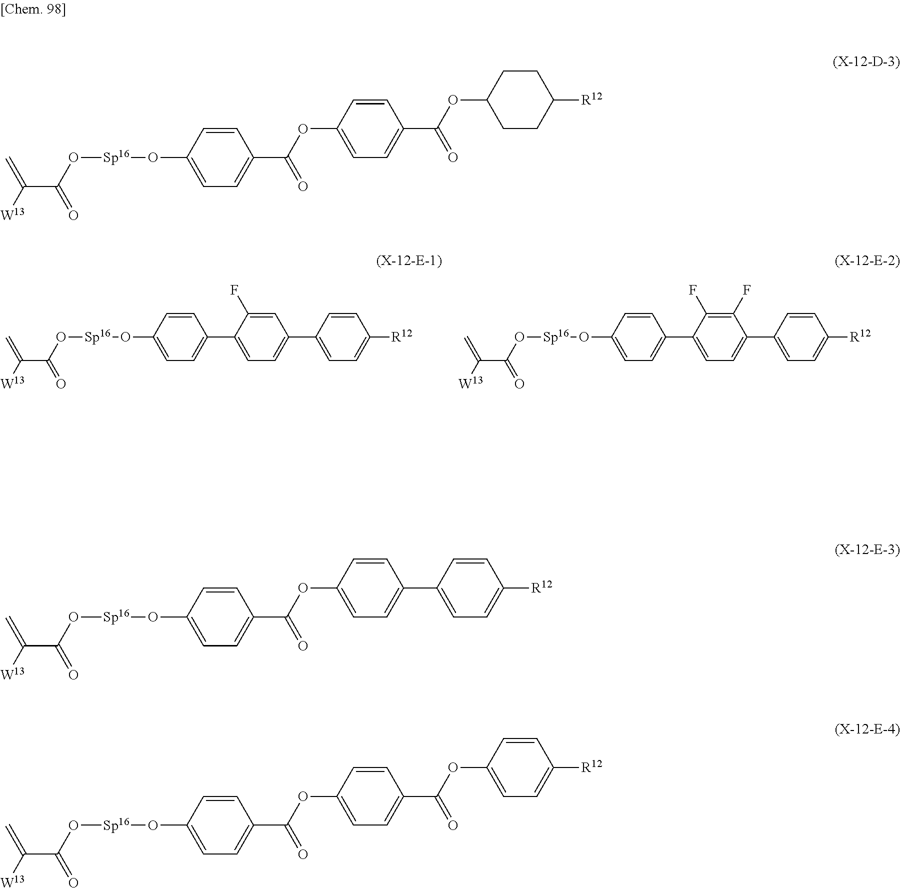

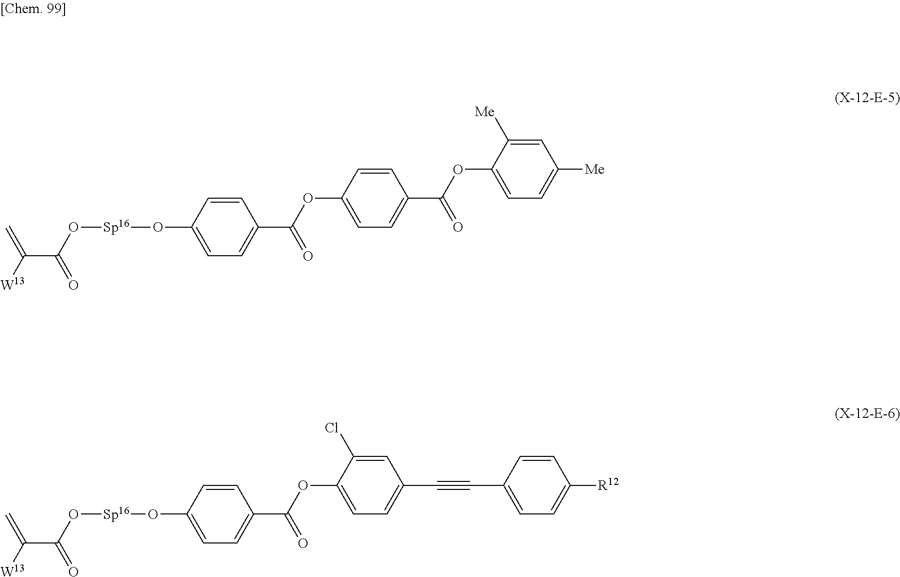

(In the formulas, W¹³, Sp¹⁶, and R¹² each independently represent the same meaning as described above.)

To the liquid crystal composition of the present invention, a compound containing a mesogenic group not having a polymerizable group may be added, and examples thereof include a compound used for a general liquid crystal device, for example, a TFT liquid crystal or the like. As the compound containing a mesogenic group not having a polymerizable group, a compound represented by General Formula (X-21) is preferable.

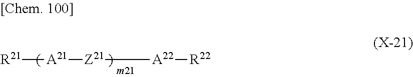

(In the formula, R²¹ and R²² each independently represent a hydrogen atom, a fluorine atom, a chlorine atom, a cyano group, or a linear alkyl group or a branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF, or C≡C—, A²¹ and A²² each independently represent a 1,4-phenylene group, 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L²¹'s, in the case where a plurality of A²¹'s are present, these may be the same as or different from each other, L²¹ represents a fluorine atom, a chlorine atom, a cyano group, or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF, or —C≡C—, Z²¹ represents a group represented by —OCH₂—, —CH₂O—, —CH₂CH₂—, —COO—, —OCO—, —CO—S—, —S—CO—, —CO—NH—, —NH—CO—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —N═N—, —CH═N—, —N═CH—, —CH═N—N═CH—, —CF═CF—, —C≡C, or a single bond, and in the case where a plurality of Z²¹'s are present, these may be the same as or different from each other, and m21 represents an integer of 0 to 6.)

As specific examples of the compound represented by General Formula (X-21), compounds selected from Formulas (X-21-1) to (X-21-8) are more preferable.

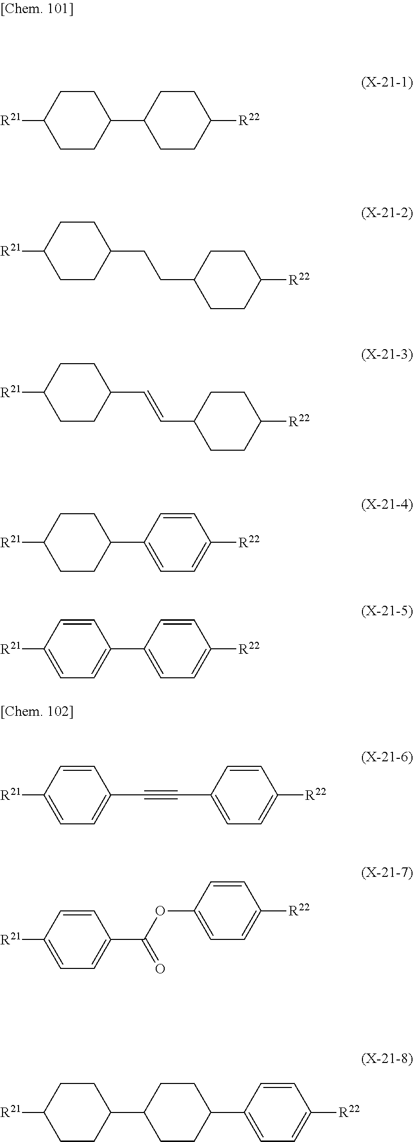

(In the formulas, R²¹ and R²² each independently represent the same meaning as described above, but it is preferable that R²¹ and R²² each independently represent a fluorine atom, a cyano group, or a linear alkyl group having 1 to 8 carbon atoms in which one —CH₂— may be substituted with —O— or —CH═CH—.)

The total content of the compound represented by General Formula (X-12) is preferably 5.0% by mass or higher, preferably 10.0% by mass or higher, and preferably 15.0% by mass or higher, or preferably 90.0% by mass or lower and preferably 85.0% by mass or lower with respect to the total content of the polymerizable composition.

In the polymerizable liquid crystal composition of the present invention, a chiral compound may be blended with a chiral compound for the purpose of obtaining a chiral nematic phase or a chiral smectic phase. Among chiral compounds, compounds having a polymerizable functional group in the molecule are particularly preferable. The chiral compound of the present invention may be liquid crystalline, and may exhibit non-liquid crystallinity.

The chiral compound used in the present invention preferably has at least one polymerizable functional group. Examples of such compounds include a polymerizable chiral compound which contains chiral sugars such as isosorbide, isomannide, and glucoside, has a rigid site such as a 1,4-phenylene group and 1,4-cyclohexylene group, and has a polymerizable functional group such as a vinyl group, an acryloyl group, a (meth)acryloyl group, or a maleimide group, as described in JP-A-11-193287, JP-A-2001-158788, JP-T-2006-52669, JP-A-2007-269639, JP-A-2007-269640, JP-A-2009-84178, and the like, apolymerizable chiral compound consisting of a terpenoid derivative as described in JP-A-8-239666, a polymerizable chiral compound consisting of a spacer having a mesogenic group and a chiral moiety as described in NATURE VOL. 35, pp. 467 to 469 (published on Nov. 30, 1995), NATURE VOL. 392, pp. 476 to 479 (published on Apr. 2, 1998), or polymerizable chiral compound containing a binaphthyl group as described in JP-T-2004-504285 and JP-A-2007-248945. Among these, a chiral compound having large helical twisting power (HTP) is preferable for the polymerizable liquid crystal composition of the present invention.

It is required that a blending amount of the chiral compound is appropriately adjusted according to helical inducting power of the compound, and in the polymerizable liquid crystal composition, the compound is preferably contained by 0% to 25% by mass, more preferably contained by 0% to 20% by mass, and particularly preferably contained by 0% to 15% by mass.

Specific examples of the chiral compound are preferably selected from Formulas (X-31) to (X-34).

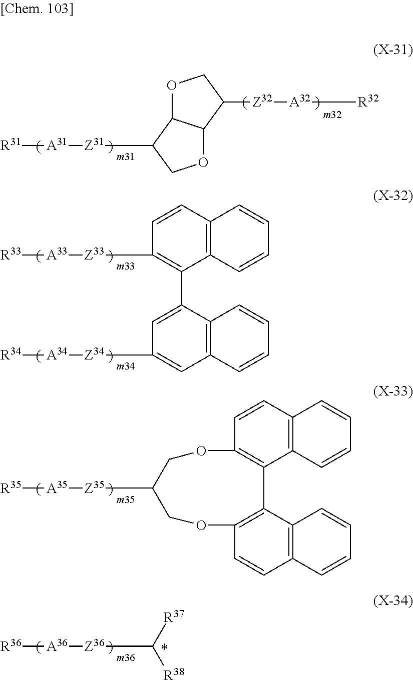

In the formulas, R³¹, R³², R³³, R³⁴, R³⁵, R³⁶, R³⁷ and R³⁸ each independently represent a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—), or R³¹, R³², R³³, R³⁴, R³, R³⁶, R³⁷, and R³⁸ each independently represent a group represented by Formula (X-30-R).

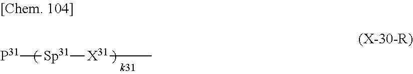

(In the formula, P³¹ represents a polymerizable group and a preferable polymerizable group represents the same as in the case of P⁰, Sp³¹ represents a spacer group or a single bond and a preferable spacer group is the same as that in the case of Sp⁰, in the case where a plurality of Sp³¹'s are present, these may be the same as or different from each other, X³¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X³¹'s are present, these may be the same as or different from each other, with the proviso that P³¹-(Sp³¹-X³¹)ₖ₃₁— does not contain an —O—O— bond, and k31 represents an integer of 0 to 10.)

R³⁷ and R³⁸ represent a different group from each other, which is other than a hydrogen atom, A³¹, A³², A³³, A³⁴, A³⁵, and A³⁶ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, these groups may be unsubstituted or substituted with one or more of substituents L³¹'s, and in the case where a plurality of A³¹, A³², A³³, A³⁴, A³⁵, and A³⁶ are present, these may be the same as or different from each other, L³¹ represents a fluorine atom, a chlorine atom, a bromine atom, an iodine atom, a pentafluorosulfuranyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which an arbitrary hydrogen atom in the alkyl group may be substituted with a fluorine atom and one —CH₂— or two or more non-adjacent —CH₂—'s may be independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or L³¹ may represent a group represented by P^{L31}-(Sp^{L31}-X^{L31})_{kL31}—, in which P^{L31} represents a polymerizable group and a preferable polymerizable group is the same as the case of P⁰, Sp^{L31} represents a spacer group or a single bond and a preferred spacer group therefor is the same as the case of Sp⁰, and in the case where a plurality of Sp^{L31}'s are present, these may be the same as or different from each other, X^{L31} represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and in the case where a plurality of X^{L3}'s are present, these are the same as or different from each other, with the proviso that P^{L3}-(Sp^{L31}-X^{L3})_{kL31}— does not contain an —O—O-bond, kL31 represents an integer of 0 to 10 and in the case where a plurality of L³¹'s are present in the compound, these may be the same as or different from each other, Z 31, Z³², Z³³, Z³⁴, Z³⁵ and Z³⁶ each independently represent a group represented by —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, and in the case where a plurality of Z 31, Z³², Z³³, Z³⁴, Z³⁵ and Z³⁶ are present, these may be the same as or different from each other, and m31, m32, m33, m34, m35, and m36 each independently represent an integer of 0 to 6.

As more specific examples of the chiral compound, compounds represented by Formulas (X-31-1) to (X-34-6) are more preferable.

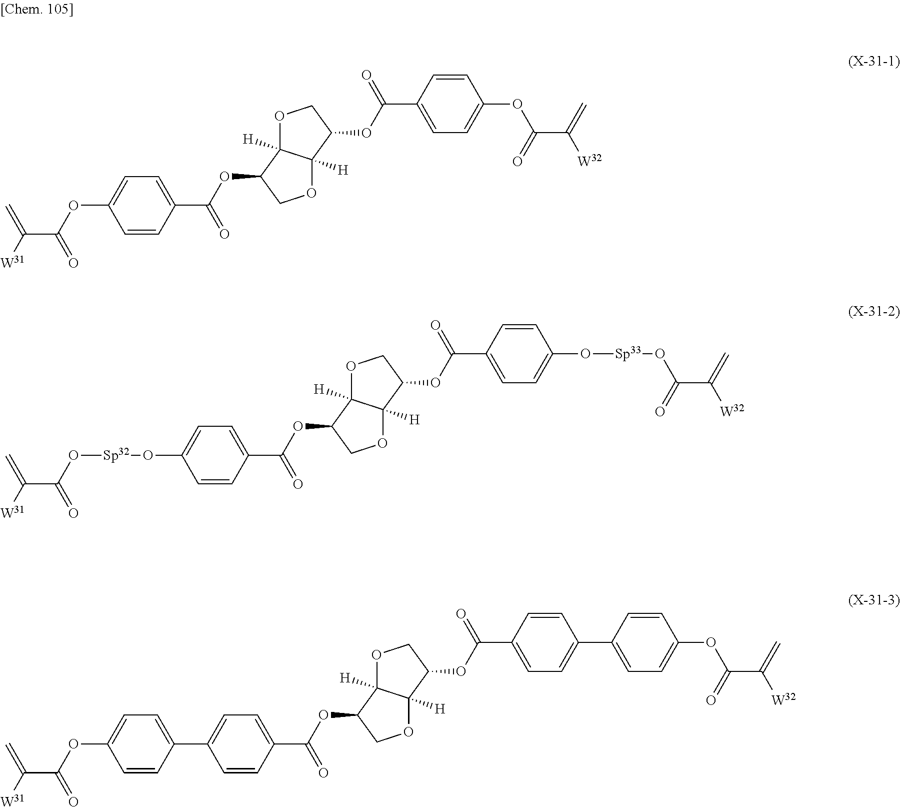

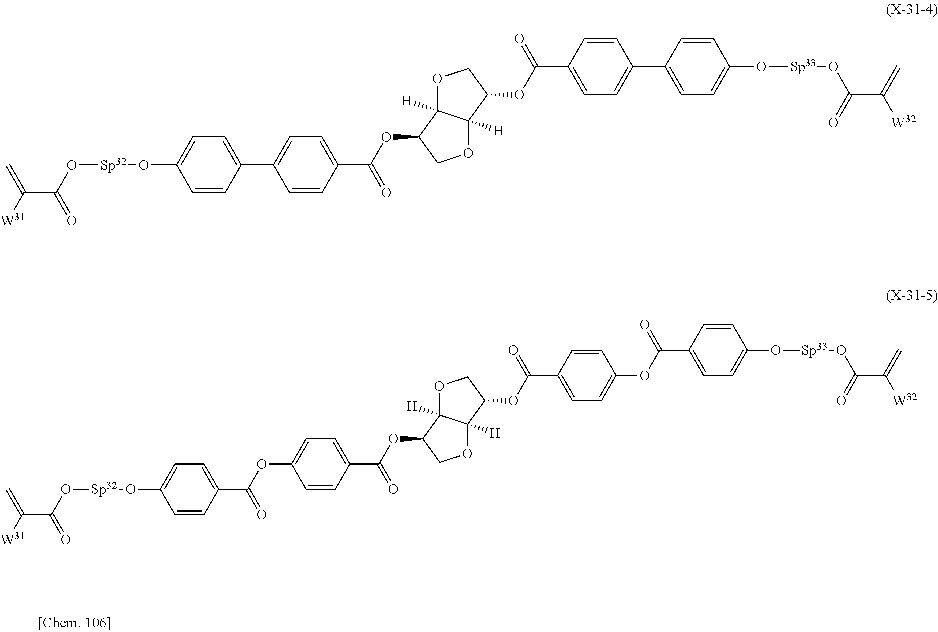

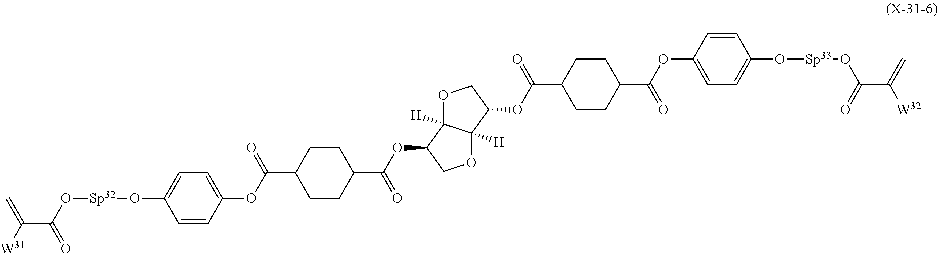

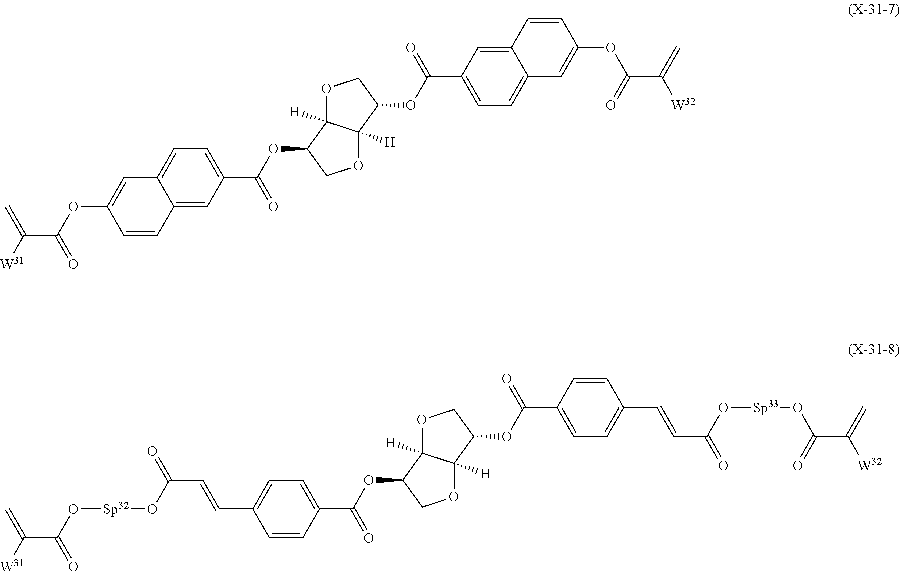

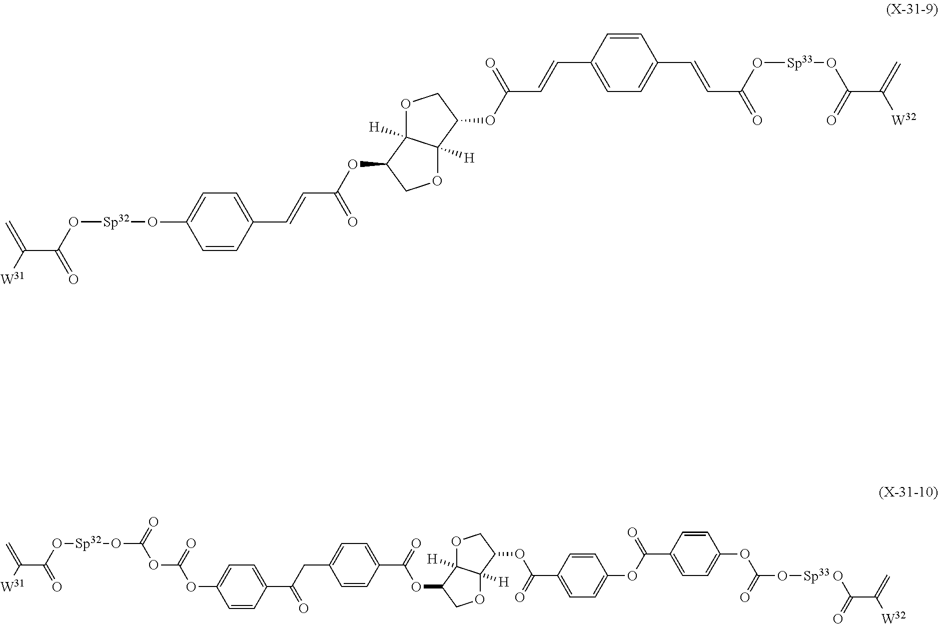

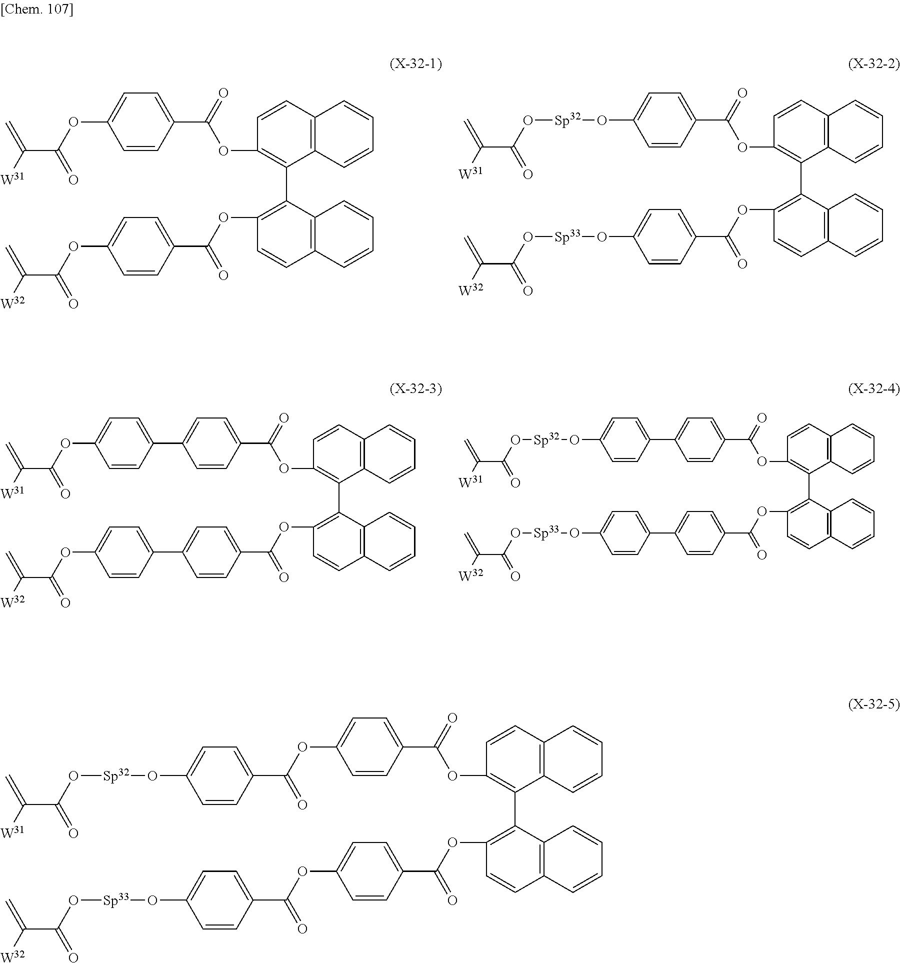

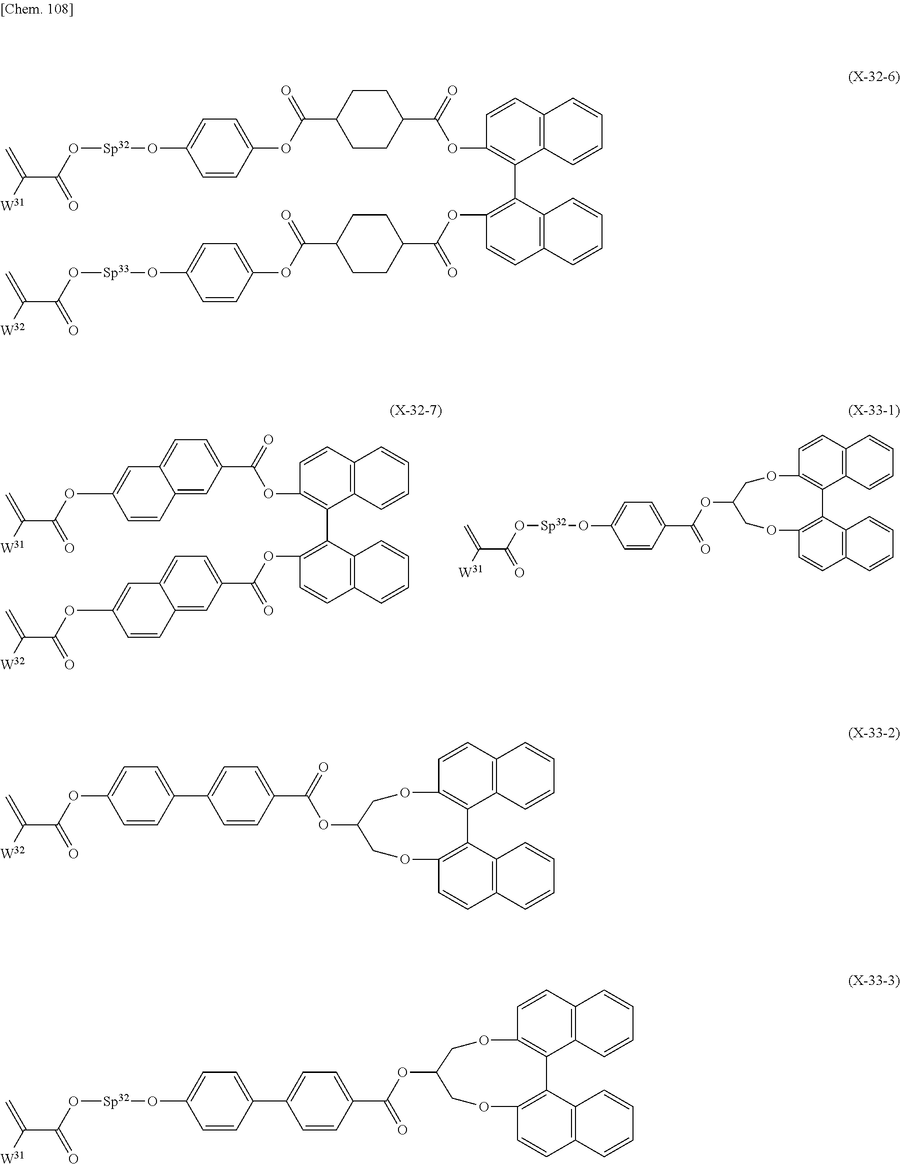

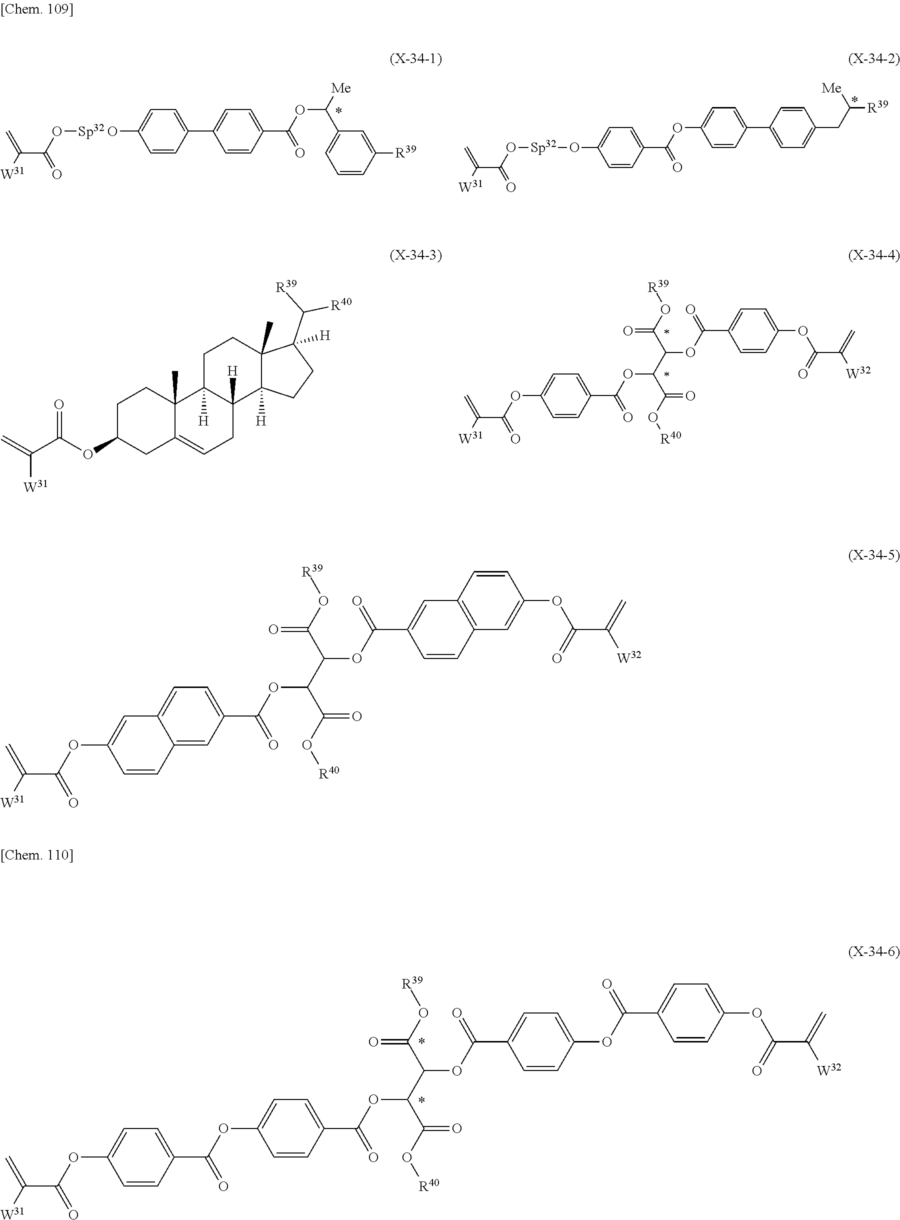

(In the formulas, W³¹ and W³² each independently represent a hydrogen atom, a fluorine atom, a methyl group, or a trifluoromethyl group, Sp³² and Sp³³ each independently represent an alkylene group having 2 to 18 carbon atoms, and R³⁹ and R⁴⁰ each represent a hydrogen atom, an alkyl group having 1 to 10 carbon atoms, or an alkoxy group having 1 to 10 carbon atoms.)

(Organic Solvent)

An organic solvent may be added to the composition of the present invention. The organic solvent to be used is not particularly limited, but an organic solvent by which the polymerizable compound exhibits good solubility is preferable, and an organic solvent which can be dried at a temperature of 100° C. or lower is preferable. Examples of such solvents include aromatic hydrocarbons such as toluene, xylene, cumene, mesitylene, and chlorobenzene, ester solvents such as methyl acetate, ethyl acetate, propyl acetate, and butyl acetate, ketone solvents such as methyl ethyl ketone, methyl isobutyl ketone, cyclohexanone, and cyclopentanone, ether solvents such as tetrahydrofuran, 1,2-dimethoxyethane, and anisole, amide solvents such as N,N-dimethylformamide and N-methyl-2-pyrrolidone, halogenated solvents such as chloroform, dichloromethane, and 1,2-dichloroethane, propylene glycol monomethyl ether acetate, diethylene glycol monomethyl ether acetate, γ-butyrolactone, and the like. These can be used alone or in combination of two or more kinds thereof, but it is preferable to use one or more of a ketone solvent, an ether solvent, an ester solvent, an aromatic hydrocarbon solvent, and a halogen solvent.

The composition used in the present invention can be applied onto the substrate if the composition is used as a solution of an organic solvent. A ratio of the organic solvent used is not particularly limited as long as an applied state is not significantly damaged thereby. The total content of the organic solvent contained in the composition solution is preferably 1% to 60% by mass, more preferably 3% to 55% by mass, and still more preferably 5% to 50% by mass.

In the case where the composition is dissolved in the organic solvent, it is preferable to perform heating and stirring in order to dissolve the composition uniformly. A heating temperature at the time of heating and stirring may be appropriately adjusted in consideration of the solubility of the composition in the organic solvent. From the viewpoint of productivity, the temperature is preferably 15° C. to 110° C., more preferably 15° C. to 105° C., still more preferably 15° C. to 100° C., and particularly preferably 20° C. to 90° C.

In the case where a solvent is added, it is preferable to perform stirring and mixing by a dispersion stirrer. As specific examples of the dispersion stirrer, a disperser having DISPAR, a propeller, a stirring blade such as a turbine blade, or the like, a paint shaker, a planetary stirrer, a shaking apparatus, a shaker, a rotary evaporator, a stirrer, or the like can be used. Other ultrasonic irradiation apparatuses can be used.

It is preferable that a stirring rotational speed at the time of adding the solvent is appropriately adjusted by the stirrer to be used. In order to obtain a uniform solution of the polymerizable composition, the stirring rotational speed is preferably 10 rpm to 1000 rpm, more preferably 50 rpm to 800 rpm, and particularly preferably 150 rpm to 600 rpm.

(Polymerization Inhibitor)

It is preferable to add a polymerization inhibitor to the polymerizable composition in the present invention. Examples of the polymerization inhibitor include a phenolic compound, a quinone compound, an amine compound, a thioether compound, a nitroso compound, and the like.

Examples of the phenolic compound include p-methoxyphenol, cresol, tert-butylcatechol, 3,5-di-tert-butyl-4-hydroxytoluene, 2,2′-methylenebis(4-methyl-6-tert-butylphenol), 2,2′-methylenebis(4-ethyl-6-tert-butylphenol), 4,4′-thiobis(3-methyl-6-tert-butylphenol), 4-methoxy-1-naphthol, 4,4′-dialkoxy-2,2′-bi-1-naphthol, and the like.

Examples of the quinone compound include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, diphenoquinone, and the like.

Examples of the amine compound include p-phenylenediamine, 4-aminodiphenylamine, N,N′-diphenyl-p-phenylenediamine, N-isopropyl-N′-phenyl-p-phenylenediamine, N-(1,3-dimethylbutyl)-N′-phenyl-p-phenylenediamine, N,N′-di-2-naphthyl-p-phenylenediamine, diphenylamine, N-phenyl-β-naphthylamine, 4,4′-dicumyl-diphenylamine, 4,4′-dioctyldiphenylamine, and the like.

Examples of the thioether compound include phenothiazine, distearyl thiodipropionate, and the like.

Examples of the nitroso compound include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, and the like, N,N-dimethyl-p-nitrosoaniline, p-nitrosodiphenylamine, N,N-diethyl-p-nitrosoaniline, N-nitrosoethanolamine, N-nitrosodibutylamine, N-nitroso-N-butyl-4-butanolamine, 1,1′-nitrosoiminobis(2-propanol), N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4,6-tri-tert-butylnitrosobenzene, N-nitroso-N-methyl-p-toluenesulfonamide, N-nitroso-N-ethylurethane, N-nitroso-N-propylurethane, 1-nitroso-2-naphthol, 2-nitroso-1-naphthol, 1-nitroso-2-naphthol-3,6-sodium sulfonate, 2-nitroso-1-naphthol-4-sodium sulfonate, 2-nitroso-5-methylaminophenol hydrochloride, 2-nitroso-5-methylaminophenol hydrochloride, and the like.

An amount of the polymerization inhibitor added is preferably from 0.01% to 1.0% by mass, and more preferably from 0.05% to 0.5% by mass with respect to the polymerizable composition.

(Antioxidant)

In order to enhance the stability of the polymerizable composition in the present invention, it is preferable to add an antioxidant or the like. Examples of such compound include hydroquinone derivatives, nitrosamine-based polymerization inhibitors, hindered phenol-based antioxidants, hindered amine-based antioxidants, and the like. More specific examples thereof include tert-butyl hydroquinone, methyl hydroquinone, “Q-1300” and “Q-1301” manufactured by Wako Pure Chemical Industries, Ltd., “IRGANOX1010”, “IRGANOX1035”, “IRGANOX1076”, “IRGANOX1098”, “IRGANOX1135”, “IRGANOX1330”, “IRGANOX1425”, “IRGANOX1520”, “IRGANOX1726”, “IRGANOX245”, “IRGANOX259”, “IRGANOX3114”, “IRGANOX3790”, “IRGANOX5057”, “IRGANOX565”, “TINUVIN PA144”, “TINUVIN765”, and “TINUVIN770DF” manufactured by BASF SE.

An amount of the antioxidant added is preferably 0.01% to 2.0% by mass and more preferably from 0.05% to 1.0% by mass with respect to the polymerizable composition.

(Photopolymerization Initiator)

The polymerizable composition in the present invention preferably contains a photopolymerization initiator. It is preferable that at least one photopolymerization initiator is contained. Specific examples thereof include “IRGACURE 651”, “IRGACURE 184”, “IRGACURE 907”, “IRGACURE 127”, “IRGACURE 369”, “IRGACURE 379”, “IRGACURE 819”, “IRGACURE 2959”, “IRGACURE 1800”, “IRGACURE 250”, “IRGACURE 754”, “IRGACURE 784”, “IRGACURE OXE01”, “IRGACURE OXE02”, “LUCIRIN TPO”, “DAROCUR 1173”, AND “DAROCUR MBF” manufactured by BASF SE, “ESACURE 1001M”, “ESCACURE KIPI50”, “SPEEDCURE BEM”, “SPEEDCURE BMS”, “SPEEDCURE MBP”, “SPEEDCURE PBZ”, “SPEEDCURE ITX”, “SPEEDCURE DETX”, “SPEEDCURE EBD”, “SPEEDCURE MBB”, and “SPEEDCURE BP” manufactured by Lambson Limited, “Kayacure DMBI” manufactured by Nippon Kayaku Co., Ltd., “TAZ-A” manufactured by Nihon SiberHegner K.K. (currently DKSH), “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919”, manufactured by ADEKA CORPORATION, and the like.

An amount of the photopolymerization initiator used is preferably 0.1% to 10% by mass and particularly preferably 0.5% to 5% by mass with respect to the polymerizable composition. These can be used alone or in combination of two or more kinds thereof. Sensitizers and the like may be added.

(Thermal Polymerization Initiator)

For the polymerizable composition of the present invention, a thermal polymerization initiator may be used together with the photopolymerization initiator. Specific examples thereof include “V-40” and “VF-096” manufactured by Wako Pure Chemical Industries, Ltd., “PERHEXYL D” and “PERHEXYL I” manufactured by NOF CORPORATION, and the like.

An amount of the thermal polymerization initiator used is preferably 0.1% to 10% by mass and particularly preferably 0.5% to 5% by mass with respect to the polymerizable composition. These can be used alone or in combination of two or more kinds thereof.

(Surfactant)

The polymerizable composition in the present invention may contain at least one surfactant in order to reduce unevenness in film thickness in the case where the composition is an optically anisotropic body. Examples of the surfactant that can be contained include alkyl carboxylate, alkyl phosphate, alkyl sulfonate, fluoroalkyl carboxylate, fluoroalkyl phosphate, fluoroalkyl sulfonate, polyoxyethylene derivatives, fluoroalkyl ethylene oxide derivatives, polyethylene glycol derivatives, alkyl ammonium salts, fluoroalkyl ammonium salts, and the like. A fluorine-containing surfactant is particularly preferable.

Specific examples thereof include “MEGAFACE F-110”, “MEGAFACE F-113”, “MEGAFACE F-120”, “MEGAFACE F-812”, “MEGAFACE F-142D”, “MEGAFACE F-144D”, “MEGAFACE F-150”, “MEGAFACE F-171”, “MEGAFACE F-173”, “MEGAFACE F-177”, “MEGAFACE F-183”, “MEGAFACE F-195”, “MEGAFACE F-824”, “MEGAFACE F-833”, “MEGAFACE F-114”, “MEGAFACE F-410”, “MEGAFACE F-493”, “MEGAFACE F-494”, “MEGAFACE F-443”, “MEGAFACE F-444”, “MEGAFACE F-445”, “MEGAFACE F-446”, “MEGAFACE F-470”, “MEGAFACE F-471”, “MEGAFACE F-474”, “MEGAFACE F-475”, “MEGAFACE F-477”, “MEGAFACE F-478”, “MEGAFACE F-479”, “MEGAFACE F-480SF”, “MEGAFACE F-482”, “MEGAFACE F-483”, “MEGAFACE F-484”, “MEGAFACE F-486”, “MEGAFACE F-487”, “MEGAFACE F-489”, “MEGAFACE F-172D”, “MEGAFACE F-178K”, “MEGAFACE F-178RM”, “MEGAFACE R-08”, “MEGAFACE R-30”, “MEGAFACE F-472SF”, “MEGAFACE BL-20”, “MEGAFACE R-61”, “MEGAFACE R-90”, “MEGAFACE ESM-1”, and “MEGAFACE MCF-350SF” (manufactured by DIC Corporation), “FTERGENT 100”, “FTERGENT 100C”, “FTERGENT 110”, “FTERGENT 150”, “FTERGENT 150CH”, “FTERGENT A”, “FTERGENT 100A-K”, “FTERGENT 501”, “FTERGENT 300”, “FTERGENT 310”, “FTERGENT 320”, “FTERGENT 400SW”, “FTX-400P”, “FTERGENT 251”, “FTERGENT 215M”, “FTERGENT 212MH”, “FTERGENT 250”, “FTERGENT 222F”, “FTERGENT 212D”, “FTX-218”, “FTX-209F”, “FTX-213F”, “FTX-233F”, “FTERGENT 245F”, “FTX-208G”, “FTX-240G”, “FTX-206D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FTX-750LL”, “FTX-730LS”, “FTX-730LM”, “FTX-730LL”, and “FTX-710LL” (manufactured by Neos Corporation), “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, and “BYK-SILCLEAN 3700” (manufactured by BYK Additives & Instruments), “TEGO RAD 2100”, “TEGO RAD 2200N”, “TEGO RAD 2250”, “TEGO RAD 2300”, “TEGO RAD 2500”, “TEGO RAD 2600”, and “TEGORAD2700” (manufactured byEvonik Industries), and the like.

An amount of the surfactant added is preferably 0.01% to 2% by mass and more preferably 0.05% to 0.5% by mass with respect to the polymerizable composition.

In the case where the polymerizable composition of the present invention is used as an optically anisotropic body, a tilt angle of an air interface can be effectively decreased by using the above surfactant.

The polymerizable composition of the present invention has an effect of effectively decreasing the tilt angle of the air interface in the case where the composition is an optically anisotropic body. Examples thereof other than the above surfactant include a compound having a repeating unit represented by General Formula (X-41) and having a weight average molecular weight of 100 or higher.

[Chem. 111]

CR⁴¹R⁴²—CR⁴³R⁴⁴ (X-41)

(In the formulas, R⁴¹, R⁴², R⁴³, and R⁴⁴ each independently represent a hydrogen atom, a fluorine atom, a chlorine atom, or a linear alkyl group or a branched alkyl group having 1 to 20 carbon atoms, and an arbitrary hydrogen atom in the alkyl group may be substituted with a fluorine atom.)

Preferable examples of the compound represented by General Formula (X-41) include polyethylene, polypropylene, polyisobutylene, paraffin, liquid paraffin, chlorinated polypropylene, chlorinated paraffin, chlorinated liquid paraffin, and the like.

The compound represented by General Formula (X-41) is preferably added in a step of mixing a polymerizable compound to an organic solvent, followed by heating and stirring so as to prepare a polymerizable solution, but the compound may be added in the subsequent step of mixing the polymerization initiator to the polymerizable solution, or may be added in both steps.

An amount of the compound added represented by General Formula (X-41) is preferably 0.01% to 1% by mass and more preferably 0.05% to 0.5% by mass with respect to the polymerizable liquid crystal composition solution.

It is preferable that a chain transfer agent is added to the polymerizable liquid crystal composition solution in the present invention in order to further improve adhesiveness to the substrate in the case where the composition is an optically anisotropic body. As the chain transfer agent, a thiol compound is preferable, a monothiol compound, a dithiol compound, a trithiol compound, and a tetrathiol compound are more preferable, and a trithiol compound is still more preferable. Specifically, compounds represented by Formulas (X-51-1) to (X-51-12) are more preferable.

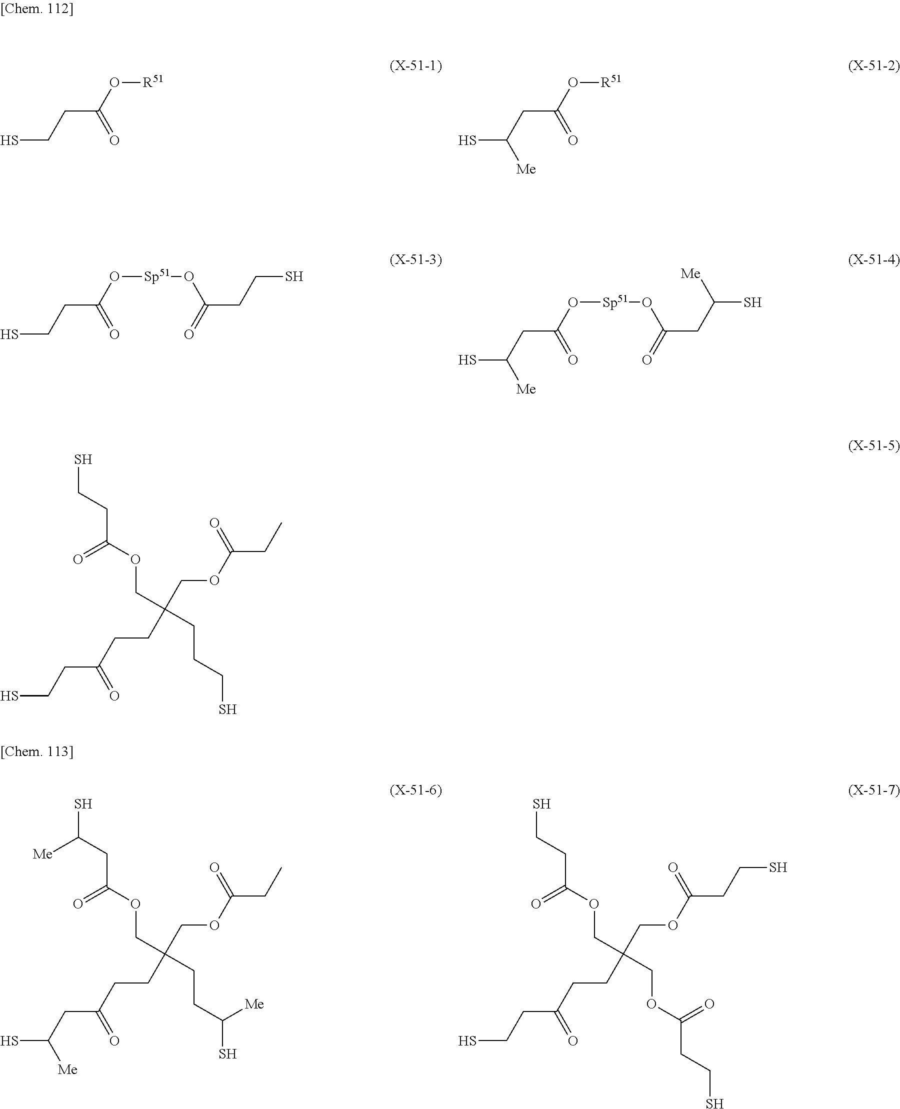

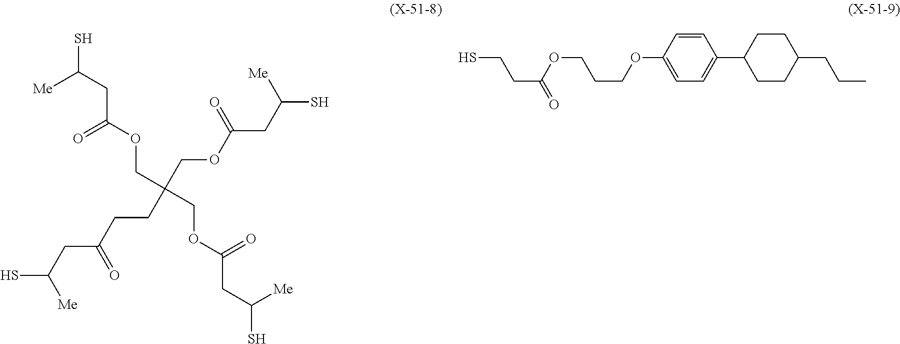 [SMILES: CC(S)CC(=O)CCC(COC(=O)CC(C)S)(COC(=O)CC(C)S)COC(=O)CC(C)S ; CCCC1CCC(c2ccc(OCCCOC(=O)CCS)cc2)CC1]

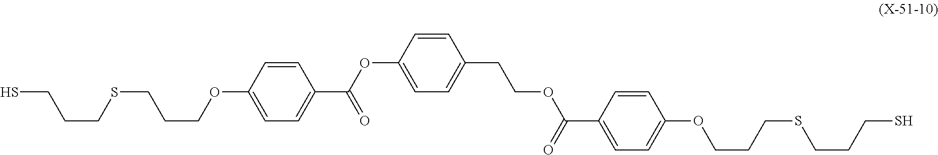 [SMILES: O=C(OCCc1ccc(OC(=O)c2ccc(OCCCSCCCS)cc2)cc1)c1ccc(OCCCSCCCS)cc1]

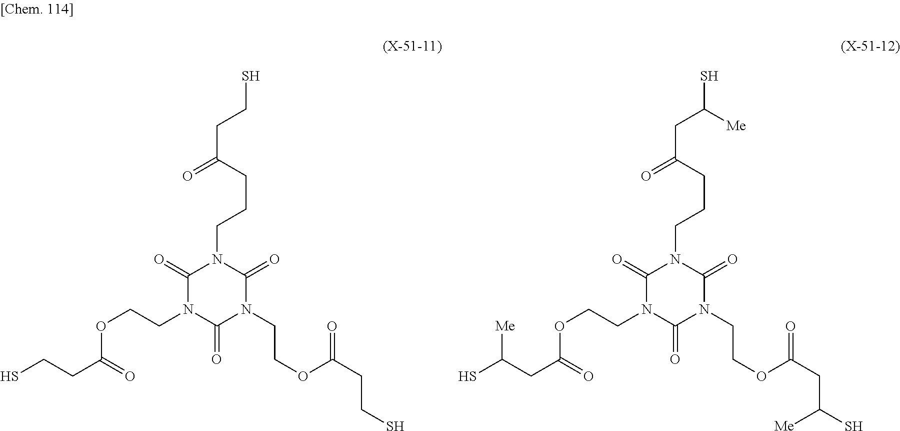 [SMILES: O=C(CCS)CCCn1c(=O)n(CCOC(=O)CCS)c(=O)n(CCOC(=O)CCS)c1=O ; CC(S)CC(=O)CCCn1c(=O)n(CCOC(=O)CC(C)S)c(=O)n(CCOC(=O)CC(C)S)c1=O]

(In the formulas, R⁵¹ each independently represent a linear alkyl group or a branched alkyl group having 1 to 20 carbon atoms in which one —CH₂— or two or more non-adjacent —CH₂—'s may be independently substituted with —O—, —S—, —CO—, —COO—, —OCO—, or —CH═CH—, and Sp⁵¹ each independently represent a linear alkylene group or a branched alkylene group having 2 to 20 carbon atoms in which one —CH₂— or two or more non-'s —CH₂— may be independently substituted with —O—, —S—, —CO—, —COO—, —OCO—, or —CH═CH—.)

The chain transfer agent is preferably added in a step of mixing the polymerizable liquid crystal compound to an organic solvent, followed by heating and stirring so as to prepare a polymerizable solution, but the agent may be added in the subsequent step of mixing the polymerization initiator to the polymerizable solution, or may be added in both steps.

An amount of the chain transfer agent added is preferably 0.5% to 10% by mass and more preferably 1.0% to 5.0% by mass with respect to the polymerizable liquid crystal composition.

For adjusting physical properties, it is also possible to add a liquid crystal compound which is not polymerizable, or a polymerizable compound which is non-liquid crystalline, and the like, as required. The polymerizable compound which is non-liquid crystalline is preferably added in a step of mixing apolymerizable compound to an organic solvent, followed by heating and stirring so as to prepare a polymerizable solution, but a liquid crystal compound or the like which is not polymerizable may be added in the subsequent step of mixing the polymerization initiator to the polymerizable solution, or may be added in both steps. An amount of these compounds added is preferably 20% by mass or lower, more preferably 10% by mass or lower, and still more preferably 5% by mass or lower with respect to the polymerizable composition.

To the mixture or the polymerizable composition of the present invention, other additives such as thixo agents, ultraviolet absorbents, infrared absorbents, antioxidants, and surface treatment agents may be added to the extent that the alignment ability of the liquid crystal is not significantly lowered.

The total content of the mixture in the polymerizable composition is preferably 5.0% by mass or higher, more preferably 10.0% by mass or higher, and still more preferably 15.0% by mass or higher, or preferably 90.0% by mass or lower and more preferably 85.0% by mass or lower with respect to the total content of the polymerizable composition.

(Method for Preparing Mixture Satisfying Expression (1))

In order to obtain a mixture satisfying Expression (1), for example, there is a method in which a purification degree of the compound having a mesogenic group is adjusted and a mixture satisfying Expression 1 is finally obtained. The purification degree of the compound having a mesogenic group can be adjusted by performing purification as necessary in a step of synthesizing the compound having a mesogenic group. A value of the yellowness index (YI) becomes lower as a purification degree of the compound becomes higher. Purification can be appropriately carried out in each step of synthesis, and examples of purification methods include chromatography, recrystallization, distillation, sublimation, reprecipitation, adsorption, liquid separation processing, dispersion washing, and the like. In the case of using a purification agent, examples of the purification agent include silica gel, alumina, activated carbon, activated clay, celite, zeolite, mesoporous silica, carbon nanotube, carbon nanohorn, binchotan, charcoal, graphene, ion exchange resin, acid clay, silicon dioxide, diatomaceous earth, pearlite, cellulose, an organic polymer, a porous gel, and the like.

(Method for Preparing Optically Anisotropic Body)

(Optically Anisotropic Body)

The optically anisotropic body prepared by using the polymerizable composition of the present invention is an optically anisotropic body to which a substrate, an alignment film if necessary, and a polymer of apolymerizable composition are laminated in order.

The substrate used for the optically anisotropic body of the present invention is a substrate generally used for a liquid crystal device, a display, an optical component, and an optical film, and is not particularly limited as long as a material thereof is a material having heat resistance capable of withstanding heating during drying after application of the polymerizable composition of the present invention. Examples of such a substrate include an organic material such as a glass substrate, a metal substrate, a ceramic substrate, and a plastic substrate. In particular, in the case where the substrate is an organic material, examples thereof include cellulose derivatives, polyolefins, polyesters, polyolefins, polycarbonates, polyacrylates, polyarylates, polyethersulfones, polyimides, polyphenylene sulfides, polyphenylene ethers, nylons, polystyrenes, and the like. Among these, plastic substrates such as polyesters, polystyrenes, polyolefins, cellulose derivatives, polyarylates, and polycarbonates are preferable.

For improving applying properties and adhesiveness of the polymerizable composition of the present invention, a surface treatment of these substrates may be carried out. Examples of the surface treatment include ozone treatment, plasma treatment, corona treatment, silane coupling treatment, and the like. In order to adjust the transmittance and the reflectance of light, an organic thin film, an inorganic oxide thin film, a metal thin film, or the like is provided on the surface of the substrate by a method such as vapor deposition. Alternatively, in order to give optical added value, the substrate may be a pickup lens, a rod lens, an optical disc, a phase difference film, a light diffusing film, a color filter, or the like. Among these, a pickup lens, a phase difference film, a light diffusing film, and a color filter which have higher added value are preferable.

The substrate may be subjected to a general alignment treatment or may be provided with an alignment film so that the polymerizable composition is aligned in the case where the polymerizable composition of the present invention is applied and dried. Examples of the alignment treatment include stretching treatment, rubbing treatment, polarization ultraviolet visible light irradiation treatment, ion beam processing, and the like. In the case of using an alignment film, a conventionally known alignment film may be used. Examples of such an alignment film include a compound such as polyimide, polysiloxane, polyamide, polyvinyl alcohol, polycarbonate, polystyrene, polyphenylene ether, polyarylate, polyethylene terephthalate, polyethersulfone, epoxy resin, epoxy acrylate resin, acrylic resin, a coumarin compound, a chalcone compound, a cinnamate compound, a fulgide compound, an anthraquinone compound, an azo compound, and an aryl ethene compounds. The compound subjected to the alignment treatment by rubbing is preferably a compound by which the crystallization of the material is promoted by adding a heating step during the alignment treatment or after the alignment treatment. Among the compounds subjected to the alignment treatment other than rubbing, it is preferable to use photoalignment materials.

(Applying)

As the method of obtaining an optically anisotropic body of the present invention, known conventional methods such as an applicator method, a bar coating method, a spin coating method, a roll coating method, a direct gravure coating method, a reverse gravure coating method, a flexo coating method, an inkjet method, a die coating method, a cap coating method, a dip coating method, a slit coating method, and the like may be performed. The polymerizable composition may be dried after applying.

(Polymerization Step)

The polymerization operation of the polymerizable liquid crystal composition of the present invention is generally carried out by irradiation with light such as ultraviolet rays or heating in a state where the liquid crystal compound of the polymerizable liquid crystal composition is horizontally aligned, vertically aligned, hybrid aligned, or cholesteric aligned (planar aligned) to the substrate. In the case where the polymerization is carried out by light irradiation, specifically to irradiate with an ultraviolet light having a wavelength of 390 nm or lower is preferable and to irradiate with an ultraviolet light having a wavelength of 250 to 370 nm is most preferable. However, in the case where the polymerizable composition is decomposed by the ultraviolet light of 390 nm or lower, it may be preferable to carry out polymerization treatment with ultraviolet light of 390 nm or higher. It is preferable that this light is a diffused light and is an unpolarized light.

(Polymerization Method)

As a method of polymerizing a polymerizable liquid crystal composition of the present invention, a method of irradiating with an active energy ray, a thermal polymerization, or the like are exemplified, but the method of irradiating with the active energy ray is preferable since the reaction proceeds at room temperature without heating, and among them, the method of irradiating with light such as ultraviolet rays is preferable since the operation is simple. The temperature during irradiation is a temperature at which the polymerizable liquid crystal composition of the present invention may maintain liquid crystal phases and is preferably 30° C. or lower, if possible, in order to avoid the induction of the thermal polymerization of the polymerizable liquid crystal composition. In addition, during a temperature elevating step, the liquid crystal composition usually shows a liquid crystal phase within a range from an N—I transition temperature to C (solid phase)—N (nematic) transition temperature (hereinafter, abbreviated as C—N transition temperature.). On the other hand, the liquid crystal composition is in a thermodynamically non-equilibrium state, and thus the liquid crystal state may be maintained without solidification even at C-N transition temperature or lower during a temperature lowering step. This state is referred to as a supercooled state. In the present invention, a liquid crystal composition that is in the supercooled state also maintains the liquid crystal phase. Specifically, to irradiate with the ultraviolet light having a wavelength of 390 nm or lower is preferable, and to irradiate with light having a wavelength of 250 to 370 nm is most preferable. However, in the case where the polymerizable composition is decomposed with the ultraviolet light of 390 nm or lower, it may be preferable to carry out polymerization treatment with ultraviolet light of 390 nm or higher. It is preferable that this light is a diffused light and is an unpolarized light. The intensity of the ultraviolet ray irradiation is preferably in a range of 0.05 kW/m² to 10 kW/m². In particular, a range of 0.2 kW/m² to 2 kW/m² is preferable. In the case where the intensity of the ultraviolet ray is less than 0.05 kW/m², it takes a lot of time to complete the polymerization. On the other hand, if the intensity is greater than 2 kW/m², the liquid crystal molecules of the polymerizable liquid crystal composition tend to be photo-decomposed, and a lot of polymerization heat is generated, the temperature during polymerization increases, and the order parameter of the polymerizable liquid crystal changes, and thus there is a possibility that the deviation of the phase difference of the film occurs after polymerization.

An optically anisotropic body having a plurality of regions having different alignment directions may be obtained by changing the alignment state of the unpolymerized part by applying the electric field, the magnetic field, the temperature, or the like and then polymerizing the unpolymerized part after only a specific part using mask is polymerized by the ultraviolet ray irradiation.

Further, an optically anisotropic body having a plurality of regions having different alignment directions may be obtained by regulating the alignment of the polymerizable liquid crystal composition of the unpolymerized state by previously applying the electric field, the magnetic field, the temperature, or the like to the composition and then polymerizing the unpolymerized part by irradiation with light from the mask while maintaining the state, when polymerizing only a specific part using mask by the ultraviolet ray irradiation.

The optically anisotropic body obtained by polymerizing the polymerizable liquid crystal composition of the present invention may be used alone as an optically anisotropic body which is peeled off from the substrate and may also be used as an optically anisotropic body as it is which is not peeled off from the substrate. In particular, since other members are hardly contaminated, it is useful in the case where the optically anisotropic body is used as a substrate to be layered or is used to be bonded to another substrate.

(Applications)

The polymer obtained by polymerizing the polymerizable liquid crystal composition of the application of the present invention in a state of being in a horizontal alignment, a vertical alignment, a hybrid alignment, or a cholesteric alignment, may be used as an optical compensation film, a phase difference film, a film with expanded viewing angle, a film with enhanced luminance, a reflective film, a polarizing film, and an optical information recording material as an optically anisotropic body having alignment properties. Further, the polymer may be used as an adhesive having heat dissipation properties, a sealant, a heat dissipation sheet, and inks for security printing.

### EXAMPLES

Hereinafter, the present invention will be described with reference to synthesis examples, examples, and comparative examples, but the present invention is not limited thereto. Unless otherwise specified, “parts” and “%” are on a mass basis. Compounds represented by Formulas (I-A-1) to (I-A-5), Formulas (I-B-1) to (I-B-4), and Formulas (I-C-1) to (I-C-9) were used as target compounds for evaluation.

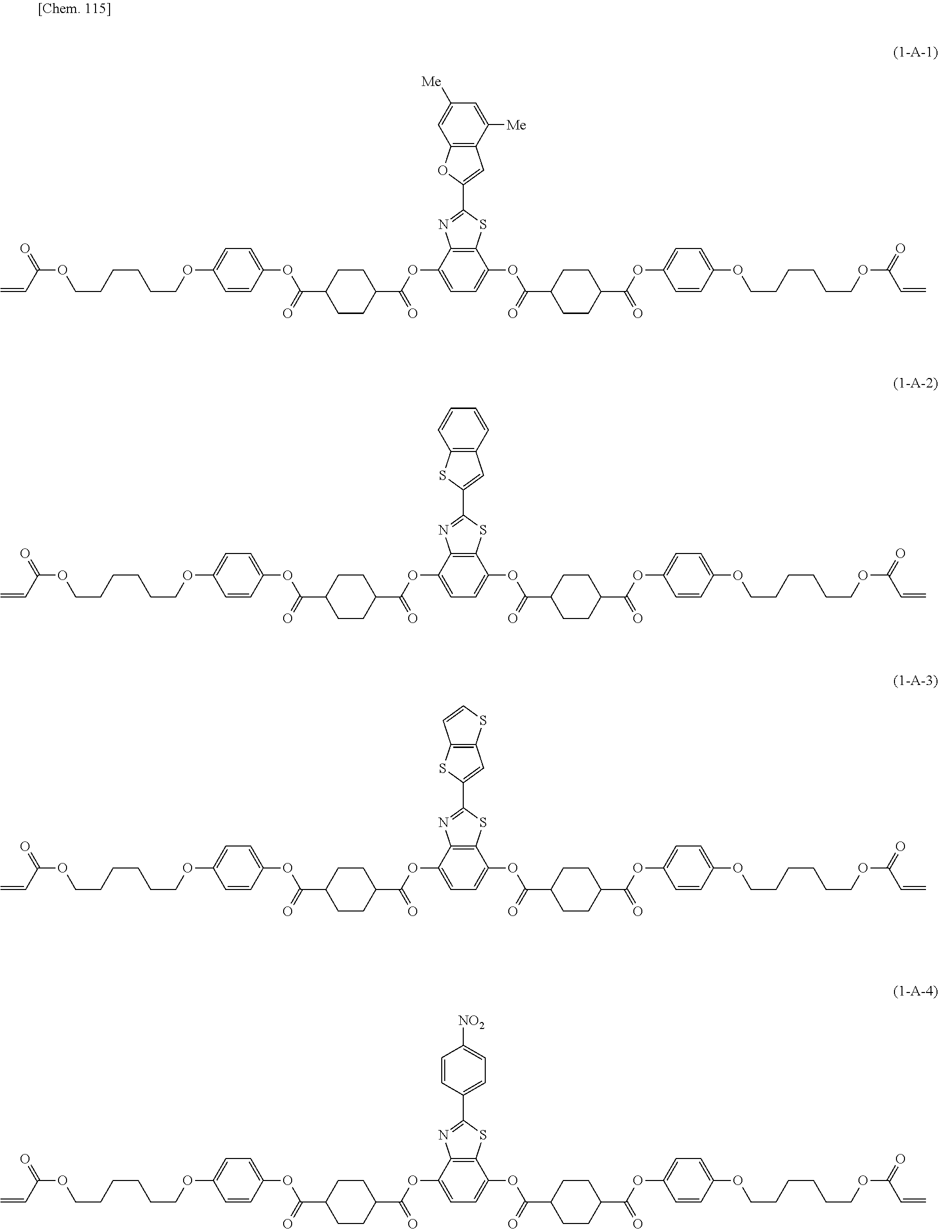

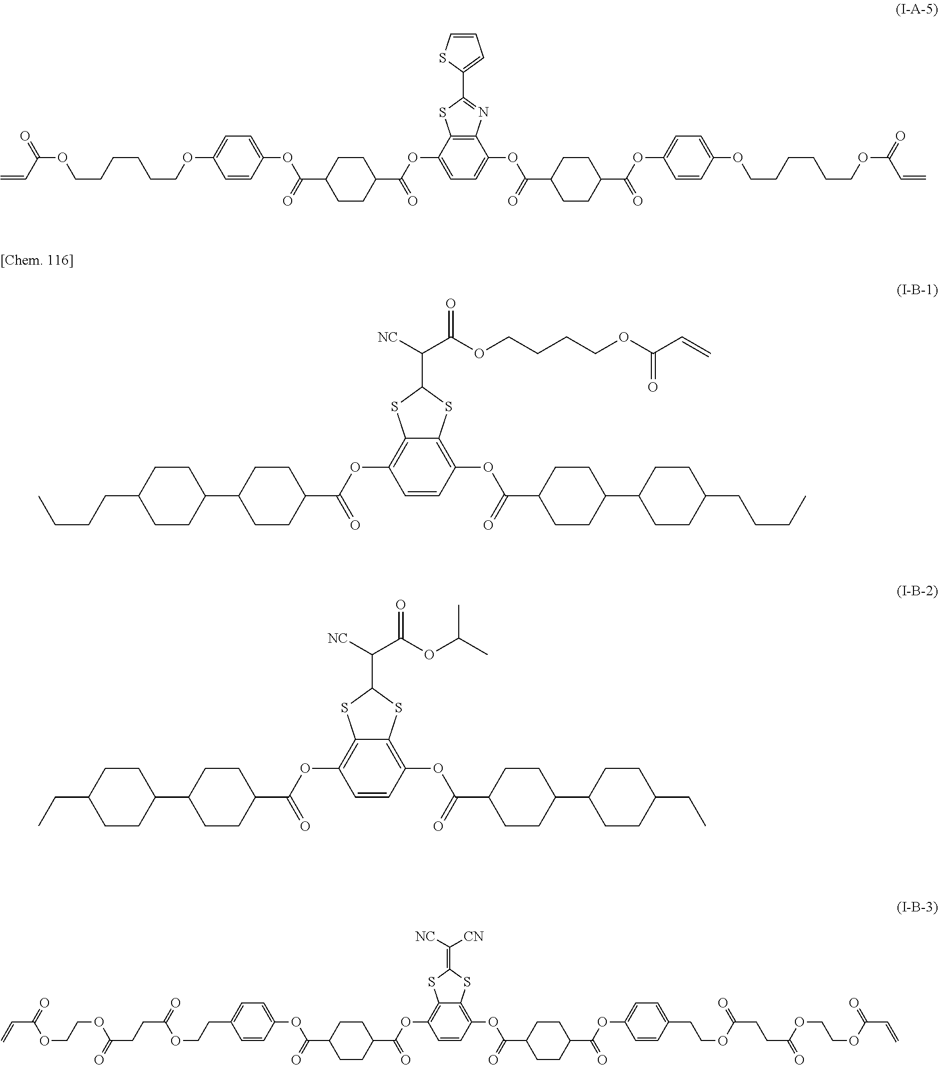

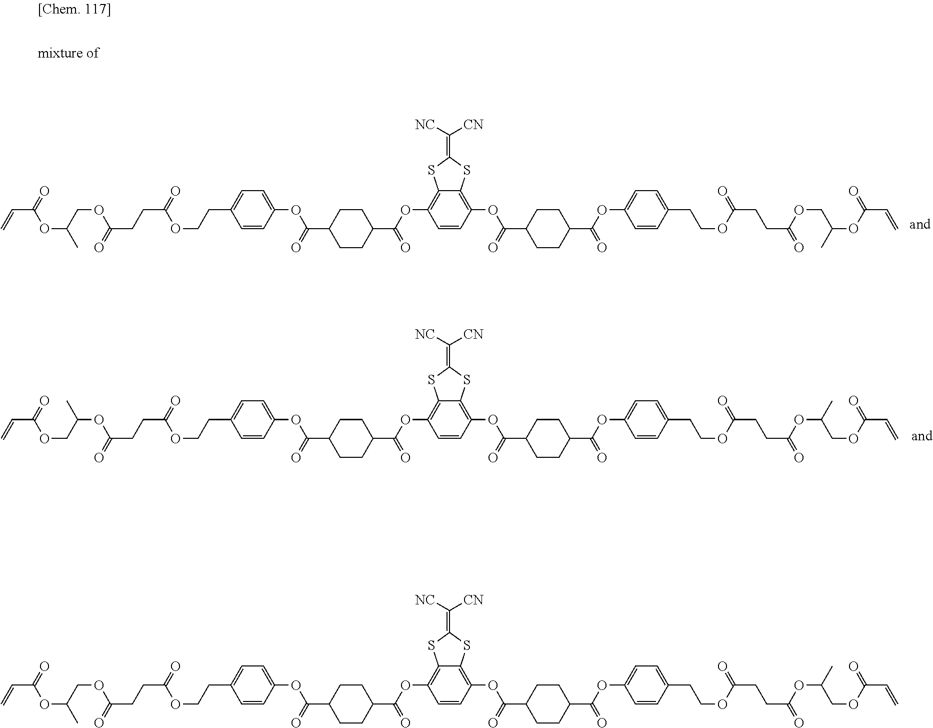

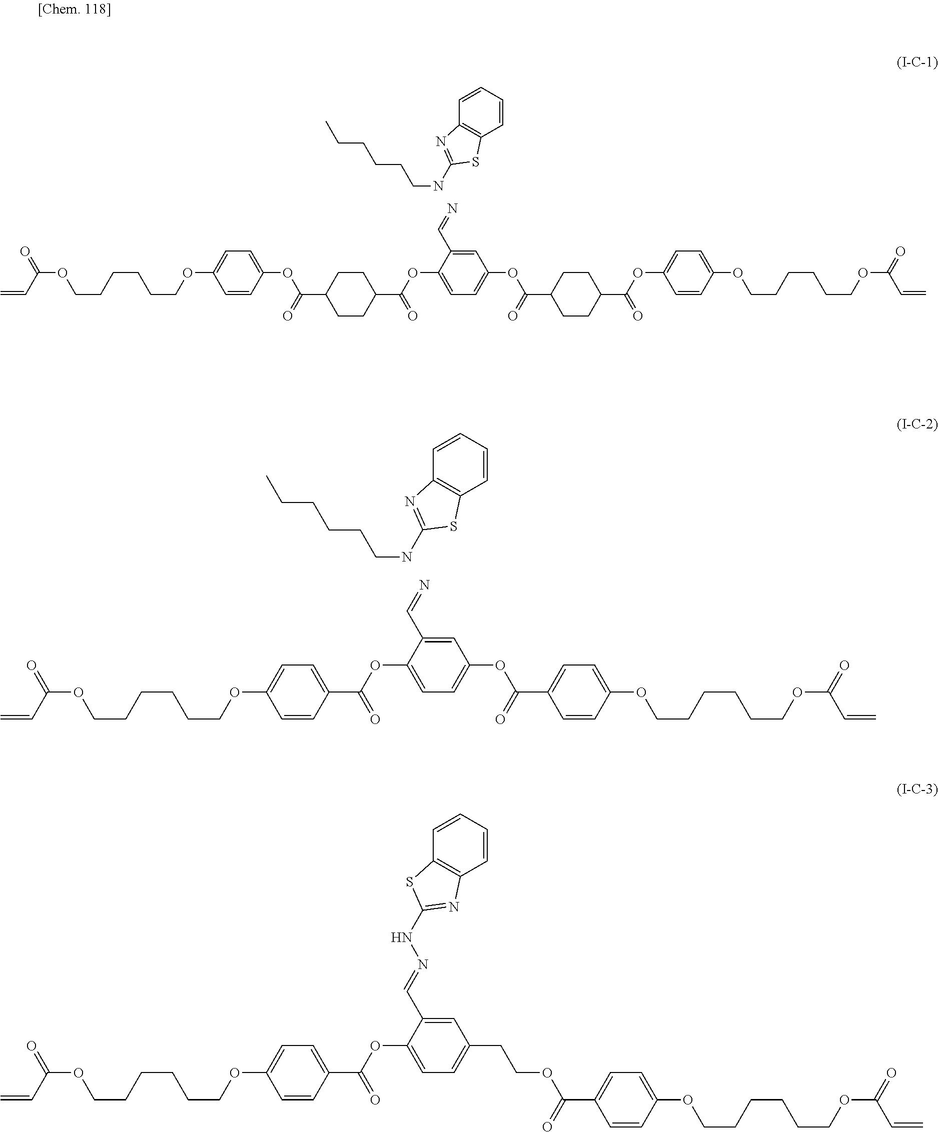

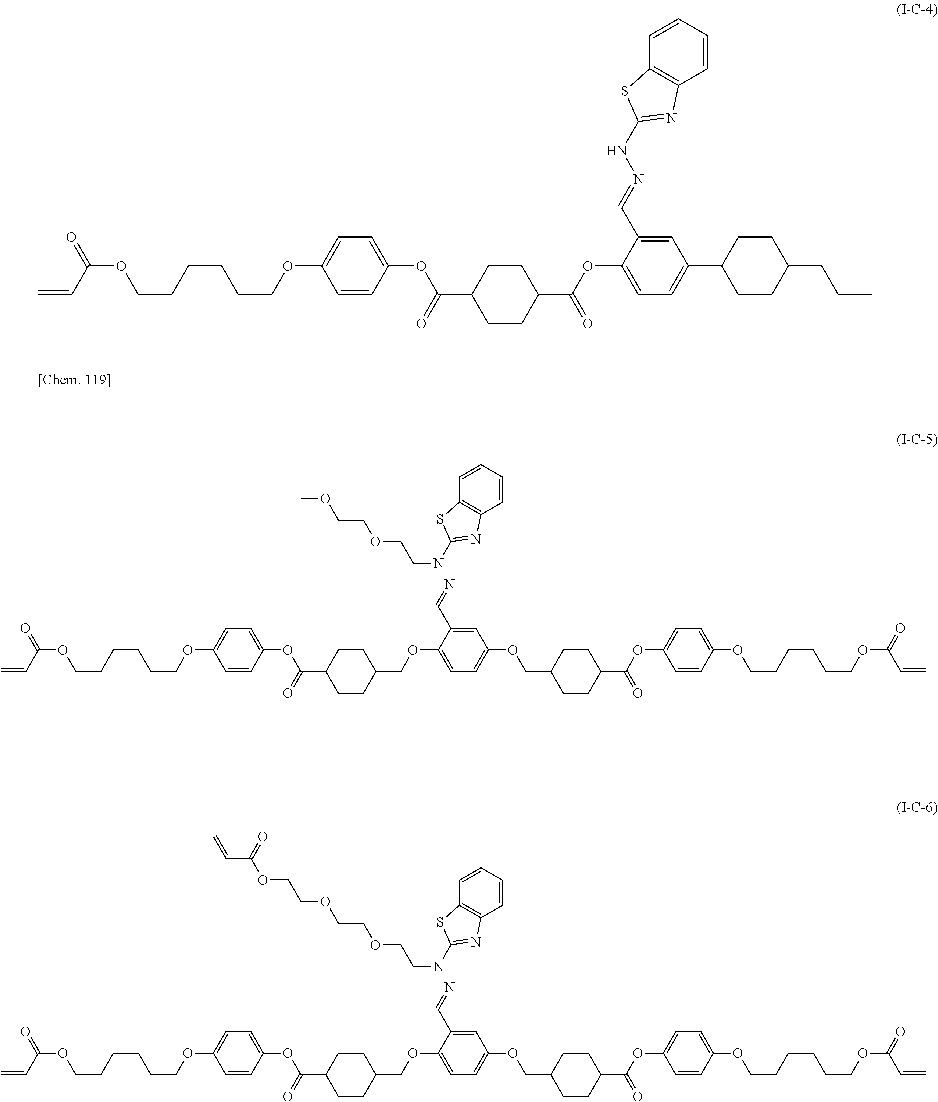

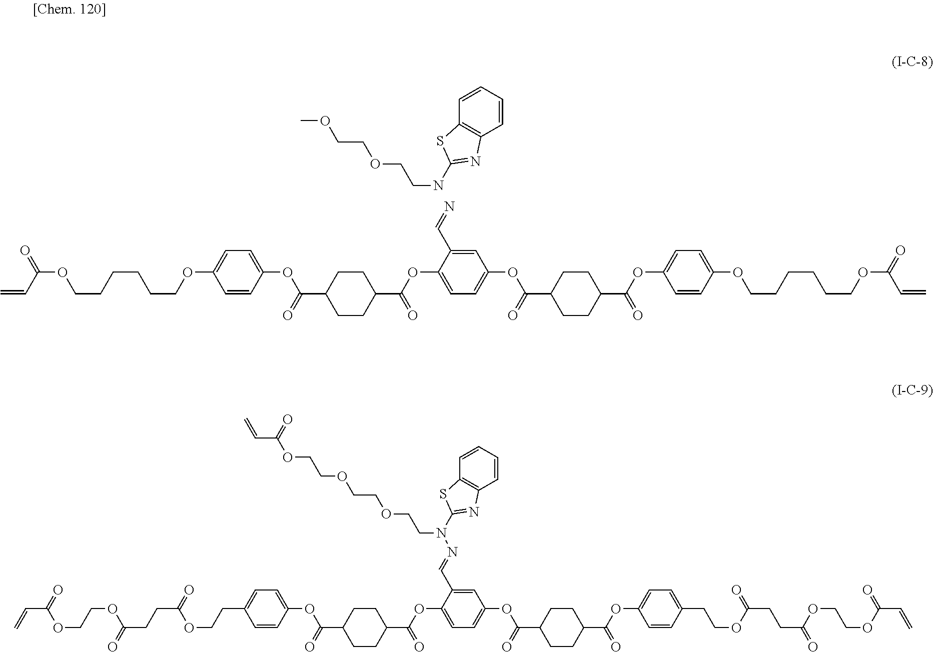

The crude material before purification of the compounds represented by Formulas (I-A-1) to (I-A-3) was prepared according to the method described in JP-A-2011-207765, the crude material before purification of the compounds represented by Formulas (I-A-4) and (I-A-5) was prepared according to the method described in JP-A-2010-031223, the crude material before purification of the compound represented by Formula (I-B-1) was prepared according to the method described in JP-A-2008-273925, the crude material before purification of the compound represented by Formula (I-B-2) was prepared according to the method described in JP-A-2008-107767, the crude material before purification of the compounds represented by Formulas (I-B-3) and (I-B-4) was prepared according to the method described in JP-A-2016-081035, the crude material before purification of the compound represented by Formula (I-C-1) was prepared according to the method described in WO2014/010325 A1, and the crude material before purification of the compound represented by Formula (I-C-2) was prepared according to the method described in WO2012/147904 A1. In the present invention, the crude material before purification means a substance before purification obtained by only distilling off a solvent from a reaction solution.

### (Example 0-1) Preparation of Compound Represented by Formula (I-C-3)

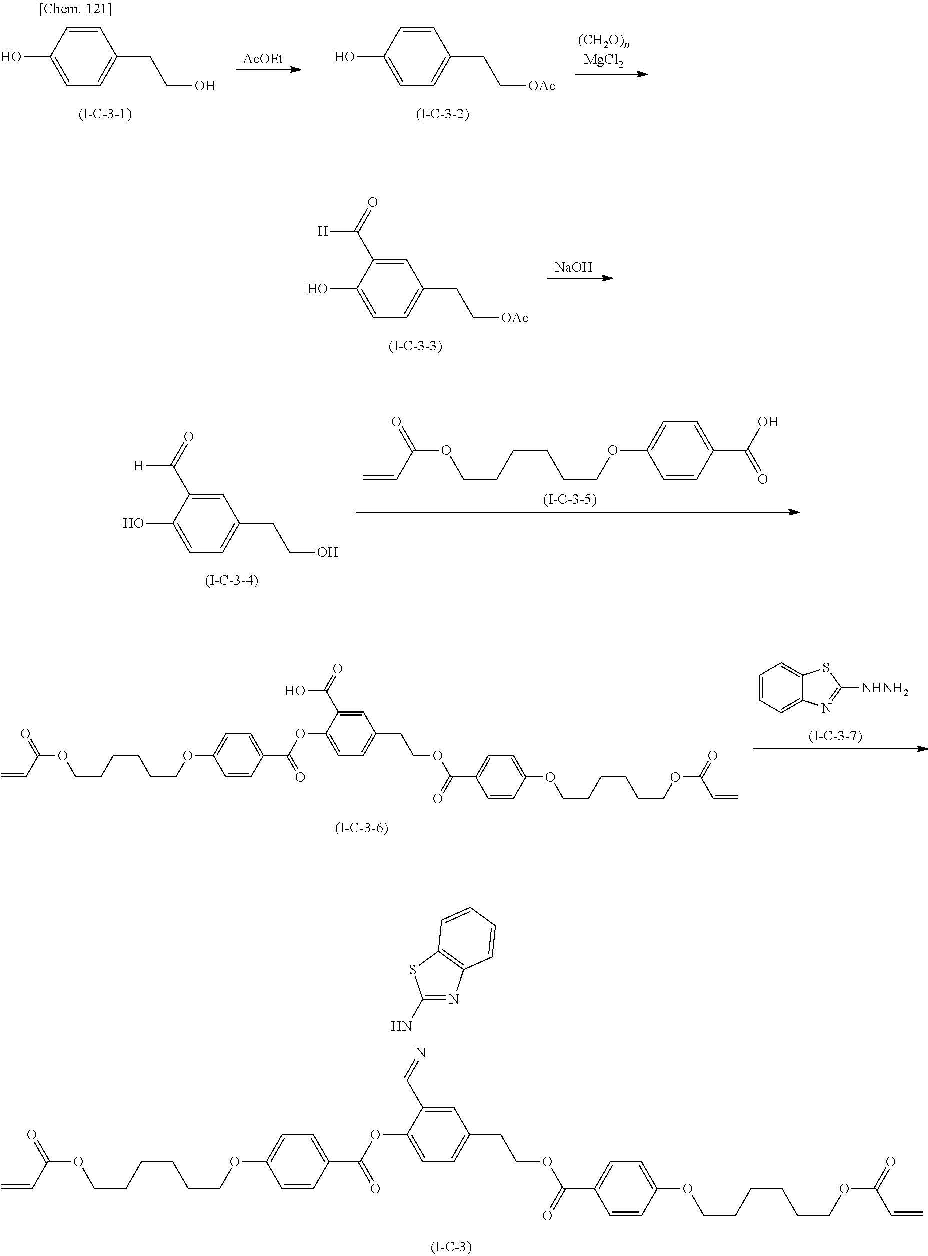

7.00 g of a compound represented by Formula (I-C-3-1), 0.96 g of p-toluenesulfonic acid monohydrate, and 65 mL of ethyl acetate were added into a reactor equipped with the Dean-Stark apparatus and a condenser, and heated under reflux. During the reaction, while appropriately removing the solvent for reaction, the operation of adding the solvent in the same amount as the amount of the removed solvent was repeated. After washing with a 5% aqueous sodium bicarbonate solution and a saline solution, purification was carried out by column chromatography (alumina), and thus, 9.08 g of a compound represented by Formula (I-C-3-2) was obtained.

9.08 g of the compound represented by Formula (I-C-3-2), 4.56 g of paraformaldehyde, 7.24 g of magnesium chloride, 36 mL of acetonitrile, and 18 mL of triethylamine were added into a reactor equipped with the Dean-Stark apparatus and a condenser and heated under ref lux. During the reaction, while appropriately removing the solvent for reaction, the operation of adding acetonitrile and triethylamine in the same amount as the amount of the removed solvent was repeated. The mixture was diluted with ethyl acetate and washed with 5% hydrochloric acid and a saline solution. Purification was carried out by column chromatography (silica gel), and thus, 9.71 g of a compound represented by Formula (I-C-3-3) was obtained.

9.71 g of the compound represented by Formula (I-C-3-3), 29 mL of methanol, and 15 mL of a 25% aqueous sodium hydroxide solution were added into the reactor, and heated while stirring at 60° C. The mixture was diluted with ethyl acetate and washed with 10% hydrochloric acid and a saline solution. Purification was carried out by column chromatography (alumina), and thus, 6.77 g of a compound represented by Formula (I-C-3-4) was obtained.

1.40 g of the compound represented by Formula (I-C-3-4), 4.93 g of a compound represented by Formula (I-C-3-5), 0.50 g of N,N-dimethylaminopyridine, and 70 mL of dichloromethane were added into a reactor under a nitrogen atmosphere. While cooling with ice, 2.55 g of diisopropylcarbodiimide was added dropwise, and the mixture was stirred at room temperature. The precipitate was filtered, and the solvent was distilled off. Purification was carried out by column chromatography (silica gel), and thus, 2.41 g of a compound represented by Formula (I-C-3-6) was obtained.

2.41 g of the compound represented by Formula (I-C-3-6), 0.56 g of a compound represented by Formula (I-C-3-7), 0.01 g of (±)-10-camphorsulfonic acid, 20 mL of tetrahydrofuran, and 10 mL of ethanol were added into a reactor and stirred. The solvent was distilled off, and thus, 1.70 g of the crude material of the compound represented by Formula (I-C-3) before purification was obtained. Measurement values after purification are shown.

¹H NMR (CDCl₃) δ 1.50 (m, 8H), 1.65-1.80 (m, 4H), 1.80-1.97 (m, 4H), 3.15 (t, 2H), 4.01 (t, 2H), 4.17 (t, 2H), 4.31 (t, 2H), 4.40 (t, 2H), 4.57 (t, 2H), 5.83 (dd, 2H), 6.13 (dd, 2H), 6.42 (dd, 2H), 6.87 (d, 2H), 6.96 (d, 2H), 7.12-7.18 (m, 2H), 7.34 (d, 1H), 7.48 (d, 1H), 7.58 (d, 1H), 7.99-8.02 (m, 5H), 8.12 (d, 2H)ppm.

Phase transition temperature (5° C./min temperature rise) C, 112 I

### (Example 0-2) Preparation of Compound Represented by Formula (I-C-4)

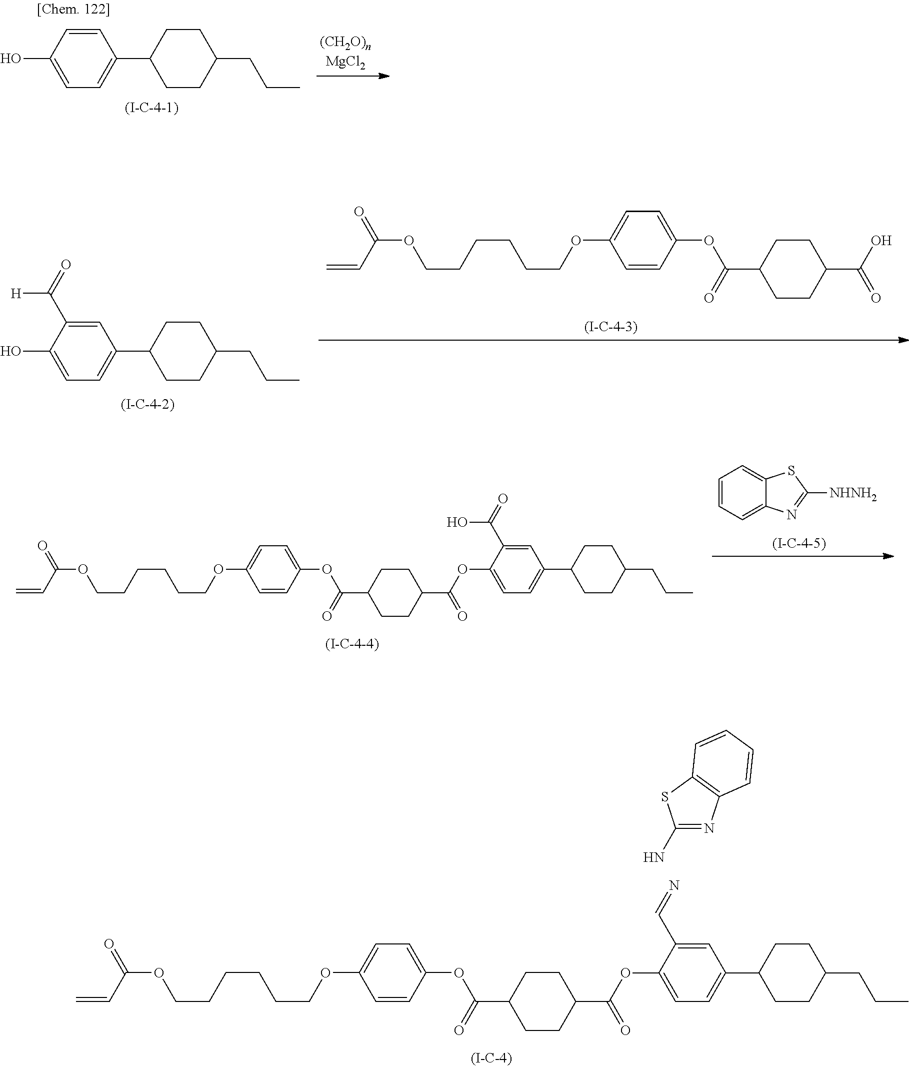

8.00 g of a compound represented by Formula (I-C-4-1), 3.30 g of paraformaldehyde, 5.23 g of magnesium chloride, 39 mL of tetrahydrofuran, and 26 mL of triethylamine were added into a reactor equipped with the Dean-Stark apparatus and a condenser and heated under reflux. During the reaction, while appropriately removing the solvent for reaction, the operation of adding tetrahydrofuran and triethylamine in the same amount as the amount of the removed solvent was repeated. The mixture was diluted with ethyl acetate and washed with 5% hydrochloric acid and a saline solution. Purification was carried out by column chromatography (silica gel), and thus, 8.95 g of a compound represented by Formula (I-C-4-2) was obtained.

A compound represented by Formula (I-C-4-3) was prepared by the method described in JP-A-2010-31223. 2.94 g of the compound represented by Formula (I-C-4-2), 5.00 g of the compound represented by Formula (I-C-4-3), 0.02 g of N,N-dimethylaminopyridine, and 40 mL of dichloromethane were added into a reactor under a nitrogen atmosphere. While cooling with ice, 1.81 g of diisopropylcarbodiimide was added dropwise, and the mixture was stirred at room temperature. The precipitate was filtered, and the solvent was distilled off. Methanol was added to precipitate a solid, followed by dispersedly washing and filtration. Purification was carried out by column chromatography (silica gel) and recrystallization, and thus, 4.70 g of a compound represented by Formula (I-C-4-4) was obtained.

1.50 g of the compound represented by Formula (I-C-4-4), 0.38 g of a compound represented by Formula (I-C-4-5), 0.01 g of (±)-10-camphorsulfonic acid, 20 mL of tetrahydrofuran, and 10 mL of ethanol were added into a reactor and stirred. The solvent was distilled off, and thus, 1.23 g of the crude material before purification of the compound represented by Formula (I-C-4) was obtained. Measurement values after purification are shown.

¹H NMR (CDCl₃) δ 0.92 (t, 3H), 1.07 (q, 2H), 1.24-2.06 (m, 27H), 2.35 (m, 2H), 2.55 (t, 1H), 3.95 (t, 2H), 4.18 (t, 2H), 5.83 (dd, 1H), 6.13 (dd, 1H), 6.42 (dd, 1H), 6.88 (d, 2H), 6.98 (m, 3H), 7.19-7.26 (m, 2H), 7.35 (m, 1H), 7.51 (m, 1H), 7.68 (m, 1H), 7.89 (m, 1H), 8.08 (m, 1H)ppm.

Phase transition temperature (5° C./min temperature rise) C, 117 N, 220 I

### (Example 0-3) Preparation of Compound Represented by Formula (I-C-5)

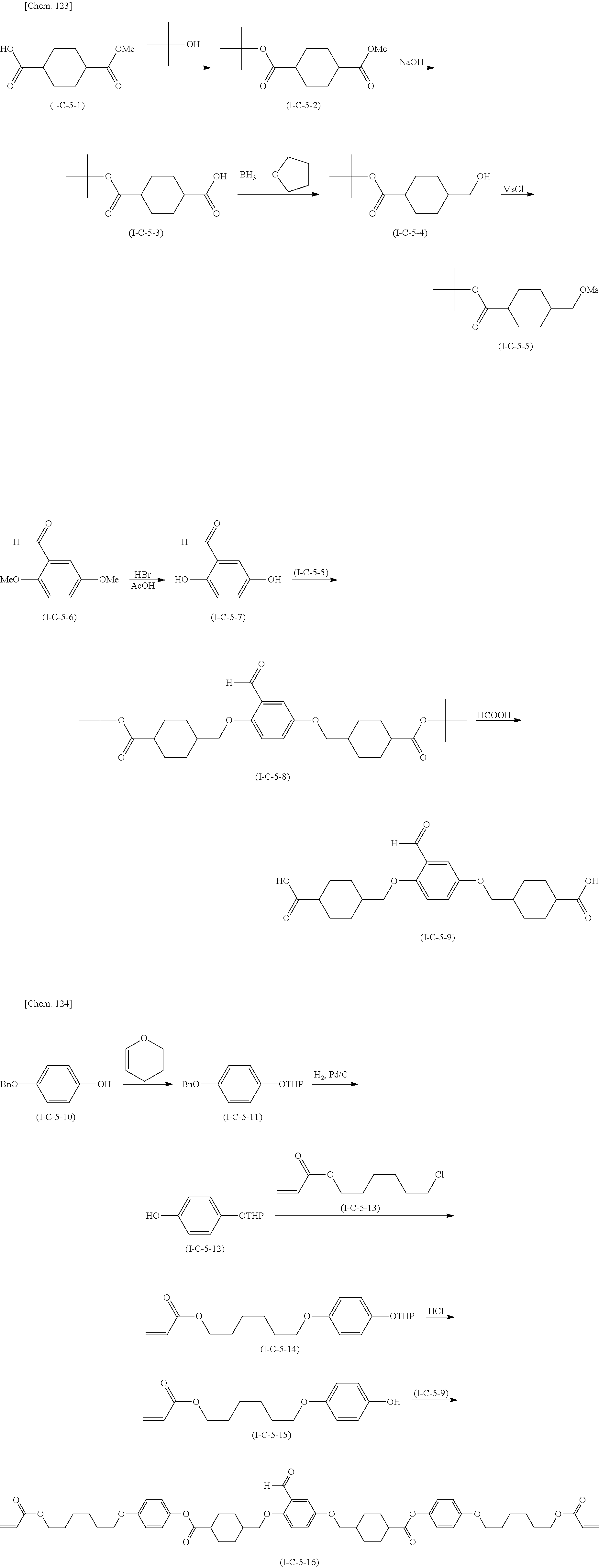

20.0 g of a compound represented by Formula (I-C-5-1), 9.6 g of tert-butyl alcohol, 0.7 g of 4-dimethylaminopyridine, and 160 mL of dichloromethane were added into a reactor under a nitrogen atmosphere. While cooling with ice, 16.3 g of diisopropylcarbodiimide was added dropwise, and the mixture was stirred at room temperature for 8 hours. The precipitate was removed by filtration and washed with 5% hydrochloric acid and a saline solution. Purification was carried out by column chromatography (silica gel, dichloromethane/hexane), and thus, 24.7 g of a compound represented by Formula (I-C-5-2) was obtained.

24.7 g of the compound represented by Formula (I-C-5-2), 200 mL of methanol, and 33 mL of a 25% aqueous sodium hydroxide solution were added into a reactor and stirred at room temperature for 8 hours. After neutralizing with 5% hydrochloric acid, the mixture was extracted with ethyl acetate and dried over sodium sulfate, and thus, 22.1 g of a compound represented by Formula (I-C-5-3) was obtained.

20.0 g of the compound represented by Formula (I-C-5-3) and 120 mL of tetrahydrofuran were added into a reactor under a nitrogen atmosphere. While cooling with ice, 105 mL of a borane-tetrahydrofuran complex (1 mol/L) was added dropwise, and the mixture was stirred for 2 hours. After adding dropwise 100 mL of 5% hydrochloric acid, the mixture was subjected to a liquid separation processing with 200 mL of ethyl acetate. After drying over with sodium sulfate, the solvent was distilled off, and thus, 16.9 g of a compound represented by Formula (I-C-5-4) was obtained.

16.9 g of the compound represented by Formula (I-C-5-4), 7.5 g of pyridine, and 100 mL of dichloromethane were added into a reactor under a nitrogen atmosphere. While cooling with ice, 10.8 g of methanesulfonyl chloride was added dropwise, and the mixture was stirred at room temperature for 24 hours. After pouring into 5% hydrochloric acid, a liquid separation processing was carried out. Purification was carried out by column chromatography (silica gel, dichloromethane), and thus, 20.7 g of a compound represented by Formula (I-C-5-5) was obtained.

20.0 g of a compound represented by Formula (I-C-5-6), 60 mL of 48% hydrobromic acid, and 60 mL of acetic acid were added into a reactor under a nitrogen atmosphere, and the mixture was heated under reflux for 6 hours. After cooling, the mixture was subjected to a liquid separation processing with 200 mL of ethyl acetate. Purification was carried out by column chromatography (alumina, ethyl acetate), and thus, 14.6 g of a compound represented by Formula (I-C-5-7) was obtained.

1.0 g of the compound represented by Formula (I-C-5-7), 4.2 g of the compound represented by Formula (I-C-5-5), 3.8 g of potassium phosphate, and 20 mL of N,N-dimethylformamide were added into a reactor under a nitrogen atmosphere, and the mixture was heated while stirring at 90° C. for 8 hours. The reaction solution was poured into 100 mL of water, and the precipitated solid was filtered and washed with water. Purification was carried out by column chromatography (silica gel, dichloromethane) and recrystallization (dichloromethane/methanol), and thus, 3.1 g of a compound represented by Formula (I-C-5-8) was obtained.

3.1 g of the compound represented by Formula (I-C-5-8), 30 mL of dichloromethane, and 30 mL of formic acid were added into a reactor under a nitrogen atmosphere, and the mixture was heated while stirring at 40° C. for 8 hours. After distilling off the solvent, 30 mL of diisopropyl ether was added so as to be stirred, and the precipitate was filtered. The obtained solid was washed with diisopropyl ether, and thus, 2.2 g of a compound represented by Formula (I-C-5-9) was obtained.

10.0 g of a compound represented by Formula (I-C-5-10), 0.7 g of pyridinium p-toluenesulfonate, and 100 mL of dichloromethane were added into a reactor. While cooling with ice, 4.6 g of 3,4-dihydro-2H-pyran was added dropwise, and the mixture was stirred at room temperature for 7 hours. After washing with a 5% aqueous sodium bicarbonate solution and a saline solution, purification was carried out by column chromatography (alumina, dichloromethane), and thus, 13.5 g of a compound represented by Formula (I-C-5-11) was obtained.

13.5 g of a compound represented by Formula (I-C-5-11), 0.1 g of 5% palladium on carbon, 50 mL of tetrahydrofuran, and 50 mL of ethanol were added into a pressure-resistant vessel. The mixture was heated while stirring for 8 hours at 50° C. at a hydrogen pressure of 0.5 MPa. After filtration of the catalyst, the solvent was distilled off, and thus, 8.8 g of a compound represented by Formula (I-C-5-12) was obtained.

15.0 g of the compound represented by Formula (I-C-5-12), 17.7 g of a compound represented by Formula (I-C-5-13), 16.0 g of potassium carbonate, and 90 mL of N,N-dimethylformamide were added into a reactor, and the mixture was heated while stirring at 90° C. for 20 hours. 150 mL of dichloromethane was added to perform a liquid separation processing. Purification was carried out by column chromatography (silica gel, dichloromethane), and thus, 24.2 g of a compound represented by Formula (I-C-5-14) was obtained.

24.2 g of the compound represented by Formula (I-C-5-14), 80 mL of tetrahydrofuran, and 80 mL of methanol were added into a reactor. 1 mL of concentrated hydrochloric acid was added, and the mixture was stirred at room temperature for 10 hours. After distilling off the solvent, the mixture was subjected to a liquid separation processing with 150 mL of ethyl acetate. Purification was carried out by column chromatography (alumina, ethyl acetate) and recrystallization (ethyl acetate/hexane), and thus, 17.4 g of a compound represented by Formula (I-C-5-15) was obtained.

1.9 g of the compound represented by Formula (I-C-5-9), 2.4 g of the compound represented by Formula (I-C-5-15), 0.06 g of N,N-dimethylaminopyridine, and 20 mL of dichloromethane were added into a reactor under a nitrogen atmosphere. While cooling with ice, 2.2 g of 1-ethyl-3-(3-dimethylaminopropyl)carbodiimide hydrochloride was added, and the mixture was stirred at room temperature for 8 hours. The reaction solution was washed with 5% hydrochloric acid and a saline solution. Purification was carried out by column chromatography (silica gel, dichloromethane) and recrystallization (dichloromethane/methanol), and thus, 3.3 g of a compound represented by Formula (I-C-5-16) was obtained.

A hydrazine monohydrate and ethanol were added into a reactor under a nitrogen atmosphere. A compound represented by Formula (I-C-5-17) was added and the mixture was heated while stirring. The solvent was distilled off, and thus, a mixture containing a compound represented by Formula (I-C-5-18) was obtained.

A mixture containing a compound represented by Formula (I-C-5-19), 1,2-dimethoxyethane, triethylamine, the compound represented by formula (I-C-5-18) was added into a reactor under a nitrogen atmosphere, and the mixture was heated while stirring. The mixture was diluted with dichloromethane and washed with water and a saline solution. Purification was carried out by column chromatography (silica gel, hexane/ethyl acetate), and thus, a compound represented by Formula (I-C-5-20) was obtained.

3.3 g of the compound represented by Formula (I-C-5-16), 1.0 g of the compound represented by Formula (I-C-5-20), 0.5 g of (±)-10-camphorsulfonic acid, 30 mL of tetrahydrofuran, and 15 mL of ethanol was added into a nitrogen-purged reactor, and the mixture was heated while stirring at 50° C. for 8 hours. After distilling off the solvent, methanol was added to crystallize and filter the mixture. Purification was carried out by column chromatography (silica gel, dichloromethane) and recrystallization (dichloromethane/methanol), and thus, 2.9 g of the compound represented by Formula (I-C-5) was obtained.

Transition temperature (temperature rise 5° C./min): C, 85 N, 128 I

¹H NMR (CDCl₃) δ 1.22-1.28 (m, 4H), 1.44-1.47 (m, 8H), 1.60-1.82 (m, 12H), 1.90 (m, 2H), 2.07 (t, 4H), 2.24 (d, 4H), 2.53 (m, 2H), 3.30 (s, 3H), 3.50 (t, 2H), 3.66 (t, 2H), 3.85-3.89 (m, 6H), 3.93 (t, 4H), 4.17 (t, 4H), 4.53 (t, 2H), 5.82 (d, 2H), 6.13 (q, 2H), 6.40 (d, 2H), 6.83-6.90 (m, 6H), 6.95-6.98 (m, 4H), 7.14 (t, 1H), 7.32 (t, 1H), 7.52 (t, 1H), 7.67 (t, 2H), 8.33 (s, 1H)ppm.

### (Example 0-4) Preparation of Compound Represented by Formula (I-C-6)

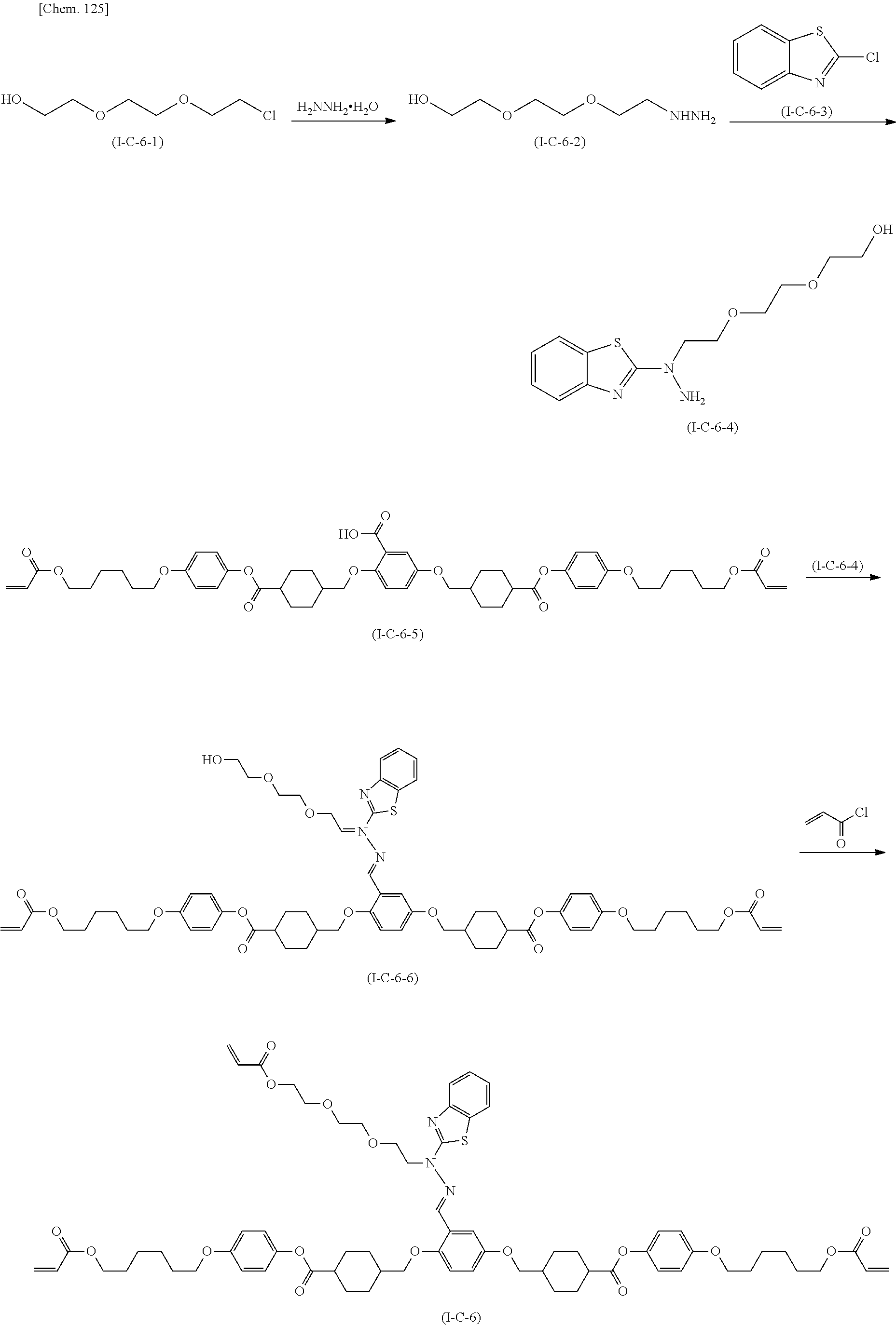

A hydrazine monohydrate and ethanol were added into a nitrogen-purged reactor. A compound represented by Formula (I-C-6-1) was added dropwise and heated while stirring. The mixture was concentrated, and thus, a mixture containing a compound represented by Formula (I-C-6-2) was obtained.

A mixture containing a compound represented by Formula (I-C-6-3), 1,2-dimethoxyethane, triethylamine, and the compound represented by Formula (I-C-6-2) was added into a reactor under a nitrogen atmosphere, and the mixture was heated while stirring. The mixture was diluted with dichloromethane and washed with water and a saline solution. Purification was carried out by column chromatography (silica gel, hexane/ethyl acetate), and thus, a compound represented by Formula (I-C-6-4) was obtained.

A compound represented by Formula (I-C-6-5), the compound represented by Formula (I-C-6-4), (±)-10-camphorsulfonic acid, tetrahydrofuran, and ethanol were added into a reactor, and heated while stirring. The solvent was distilled off, and purification was carried out by column chromatography (silica gel) and recrystallization, and thus, a compound represented by Formula (I-C-6-6) was obtained.

The compound represented by Formula (I-C-6-6), N-ethyldiisopropylamine, and dichloromethane were added into a reactor under a nitrogen atmosphere. Acryloyl chloride was added while cooling with ice, and the mixture was stirred. After performing a general postprocessing, purification was carried out by column chromatography (silica gel) and recrystallization, and thus, the compound represented by Formula (I-C-6) was obtained.

Transition temperature (temperature rise 5° C./min) C, 71 N, 115 I

¹H NMR (CDCl₃) δ 1.19-1.29 (m, 4H), 1.41-1.82 (m, 22H), 1.91 (m, 2H), 2.08 (m, 4H), 2.24 (m, 4H), 2.53 (m, 2H), 3.62 (m, 3H), 3.67 (m, 2H), 3.84-3.90 (m, 5H), 3.94 (t, 4H), 4.15-4.19 (m, 6H), 4.53 (t, 2H), 5.76 (dd, 1H), 5.82 (dd, 2H), 6.08 (dd, 1H), 6.12 (dd, 2H), 6.37 (dd, 1H), 6.40 (dd, 2H), 6.84-6.90 (m, 6H), 6.95-6.98 (m, 4H), 7.14 (t, 1H), 7.32 (t, 1H), 7.53 (d, 1H), 7.65 (d, 1H), 7.69 (d, 1H), 8.34 (s, 1H)ppm.

LCMS: 1244 [M+1]

### (Example 0-5) Preparation of Compound Represented by Formula (I-C-7)

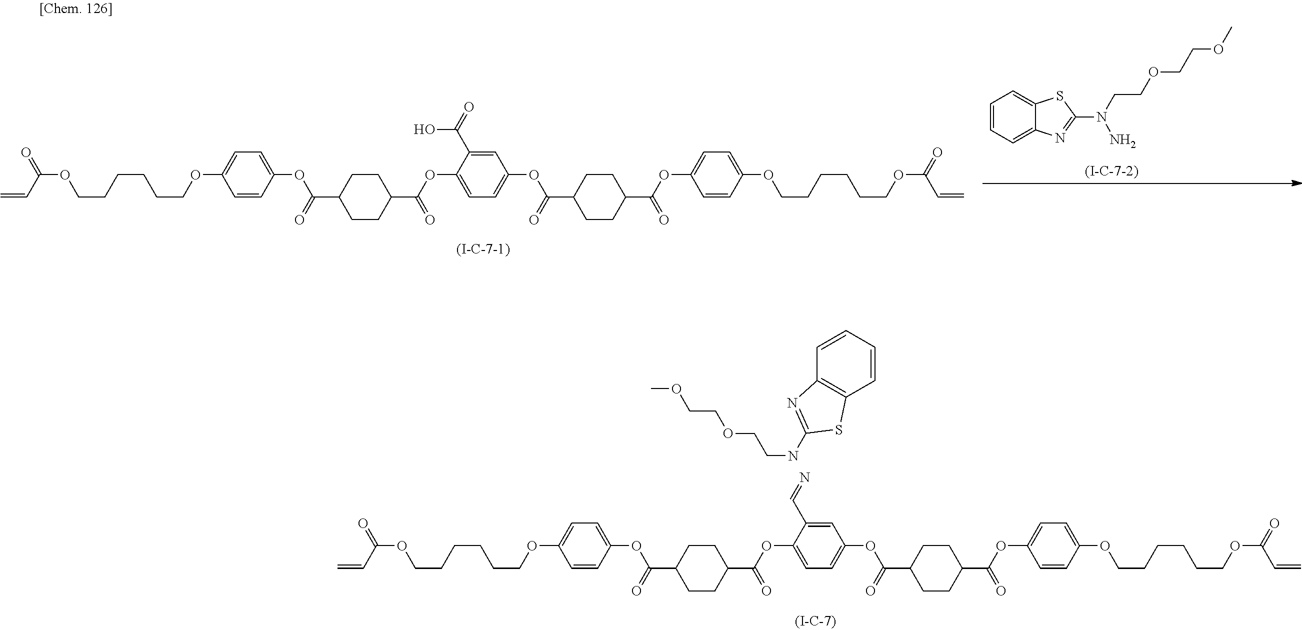

A compound represented by Formula (I-C-7-1) was prepared by the method described in WO2014-010325 A1. In the same manner as in Example 0-3 except that the compound represented by Formula (I-C-5-16) was replaced by the compound represented by Formula (I-C-7-1), the compound represented by Formula (I-C-7) was prepared.

LCMS: 1188 [M+1]

### (Example 0-6) Preparation of Compound Represented by Formula (I-C-8)

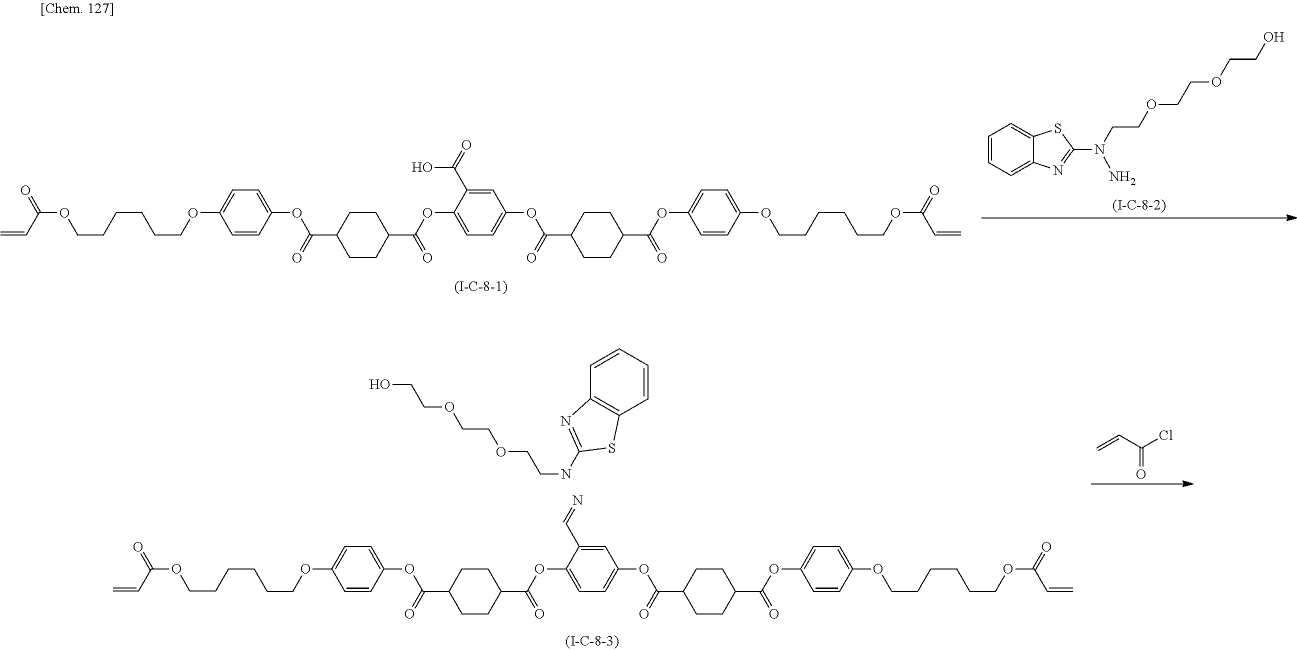

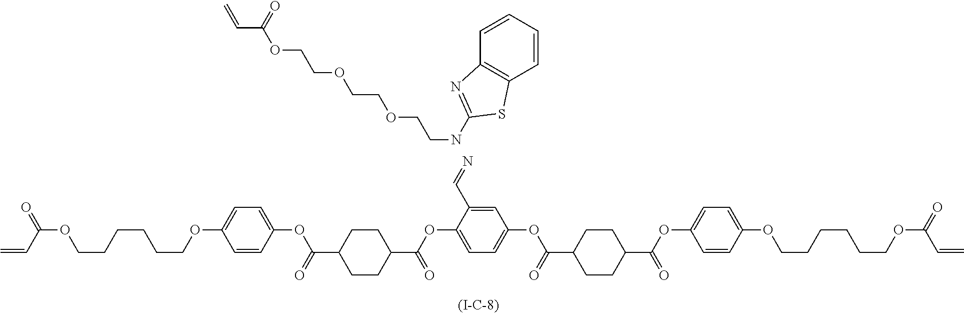

In the same manner as in Example 0-4 except that the compound represented by Formula (I-C-6-5) was replaced by the compound represented by Formula (I-C-8-1), the compound represented by Formula (I-C-8) was prepared.

LCMS: 1272 [M+1]

### (Example 0-7) Preparation of Compound Represented by Formula (I-C-9)

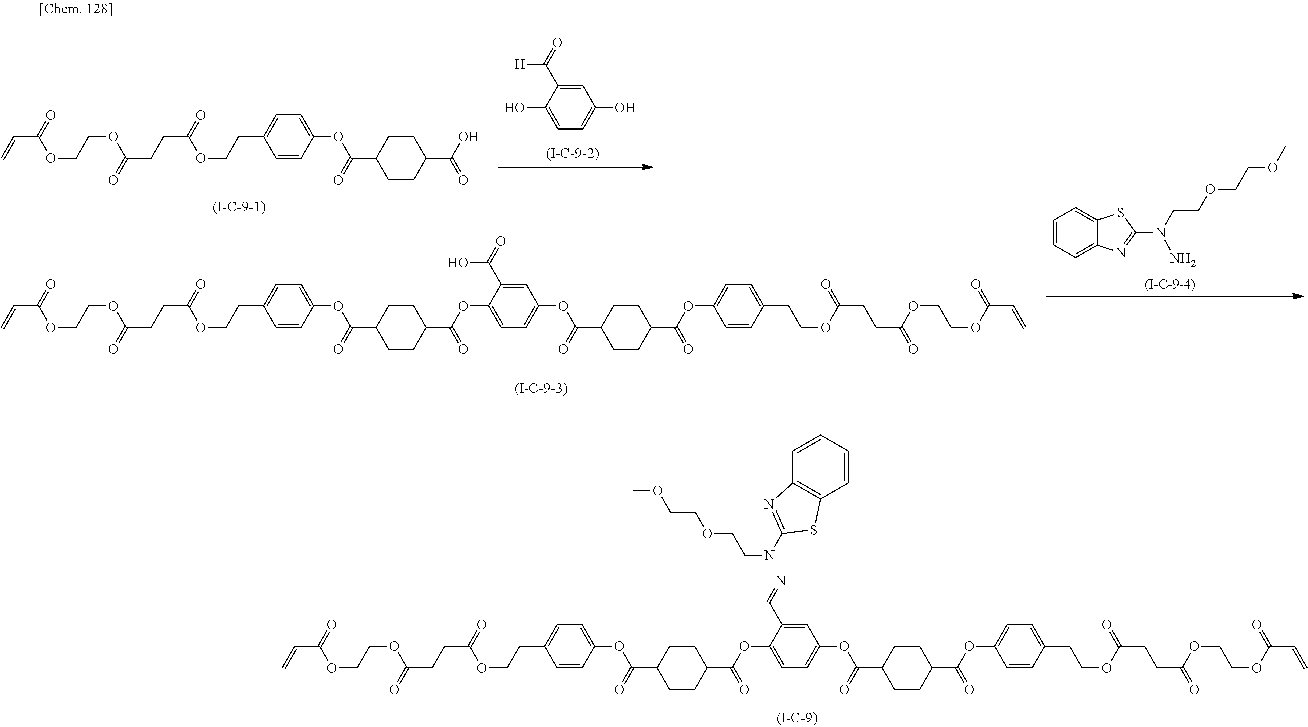

A compound represented by Formula (I-C-9-1) was prepared by the method described in JP-A-2016-081035. In the same manner as in Example 0-1 except that the compound represented by Formula (I-C-3-5) was replaced by the compound represented by Formula (I-C-9-1), a compound represented by Formula (I-C-9-3) was prepared. Next, in the same manner as in Example 0-3 except that the compound represented by Formula (I-C-5-16) was replaced by the compound represented by Formula (I-C-9-3), the compound represented by Formula (I-C-9) was prepared.

LCMS: 1332 [M+1]

### Examples 1 to 30 and Comparative Examples 1 to 20

As a mixture containing the compounds represented by Formulas (I-A-1) to (I-A-4), Formulas (I-B-1) and (I-B-2), and Formulas (I-C-1) to (I-C-4), mixtures having different degrees of purification were prepared. The crude material obtained by the above method was subjected to one or a plurality of predetermined steps selected from the following purification methods, or amounts of a purification agent and a solvent used are appropriately adjusted, and thus, mixtures having different values of YI were obtained.

(Purification Method)

(Purification Method 1)

Methanol was added to a mixture of the purification target to crystallize. The crystals were filtered and redissolved in chloroform. Activated carbon was added to the obtained solution, and the solution was stirred at room temperature for 1 hour. After filtration, the solvent was distilled off to ⅓ and methanol was added thereto while stirring. The precipitated solid was filtered and dried, and thus, a mixture was obtained.

(Purification Method 2)

Methanol was added to a mixture of the purification target to crystallize. The crystals were filtered and redissolved in chloroform. Methanol was added to the obtained solution while stirring. The precipitated solid was filtered and dried, and thus, a mixture was obtained.

(Purification Method 3)

A mixture of the purification target was dissolved in ethyl acetate and the solvent was distilled off. Methanol was added thereto, and the mixture was cooled so as to crystallize. The precipitated solid was filtered and dried, and thus, a mixture was obtained.

(Purification Method 4)

A mixture of the purification target was dissolved in a mixed solvent of dichloromethane and methanol, and purified by column chromatography (silica gel), and thus, a mixture was obtained.

(Purification Method 5)

A mixture of the purification target was dissolved in ethyl acetate, and the mixture was washed with water. After drying an organic layer with anhydrous sodium sulfate, the solvent was distilled off. The mixture was dissolved in a mixed solvent of toluene and ethyl acetate and purified by column chromatography (silica gel). Therefore, a mixture was obtained.

(Purification Method 6)

A mixture of the purification target was dissolved in ethyl acetate, and the mixture was washed with water. After drying an organic layer with anhydrous sodium sulfate, the solvent was distilled off. The mixture was dissolved in a mixed solvent of hexane and ethyl acetate and purified by column chromatography (silica gel). Therefore, a mixture was obtained.

(Purification Method 7)

A mixture of the purification target was dissolved in dichloromethane, activated carbon was added thereto, and the mixture was heated while stirring. The activated carbon was removed by filtration and the solvent was distilled off. Column chromatography (silica gel and alumina) and recrystallization were carried out, and thus, a mixture was obtained.

(Purification Method 8)

A mixture of the purification target was dissolved in a mixed solvent of dichloromethane and hexane and purified by column chromatography (silica gel and alumina). Therefore, a mixture was obtained.

(Purification Method 9)

A mixture of the purification target was dissolved in a mixed solvent of dichloromethane and acetone, activated charcoal was added thereto, and the mixture was heated while stirring. The activated carbon was removed by filtration, the solvent was distilled off, and thus, a mixture was obtained.

(Purification Method 10)

A mixture of the purification target was dissolved in toluene, silica gel and alumina were added thereto, and the mixture was stirred at room temperature for 1 hour. Silica gel and alumina were removed by filtration, and the solvent was distilled off. Therefore, a mixture was obtained.

(Purification Method 11)

A mixture of the purification target was dispersed in methanol and stirred at room temperature for 1 hour. Filtration and drying were carried out, and thus, a mixture was obtained.

(Purification Method 12)

A mixture of the purification target was dispersed in ethanol and stirred at room temperature for 1 hour. Filtration and drying were carried out, and thus, a mixture was obtained.

(Purification Method 13)

A mixture of the purification target was dispersed in hexane and stirred at room temperature for 1 hour. Filtration and drying were carried out, and thus, a mixture was obtained.

<Measurement of YI/Δn>

A yellowness index of the mixture containing the compounds of the evaluation targets was measured as follows.

The mixture of the measurement target was dissolved in acetonitrile so as to become a 20 ppm solution. In the case where the mixture was not dissolved in acetonitrile, a chloroform solution was used as a solvent. The solution was put into a transparent cell having an optical path length of 1 cm, and a yellowness index was calculated using a spectrophotometer.

A refractive index anisotropy of the compound was measured as follows. A compound (10%, 20%, or 30%) having a mesogenic group was mixed to a host liquid crystal consisting of a compound represented by Formula (a) (25%), a compound represented by Formula (b) (25%), a compound represented by Formula (c) (25%), and a compound represented by Formula (d) (25%) so as to be used as a liquid crystal composition.

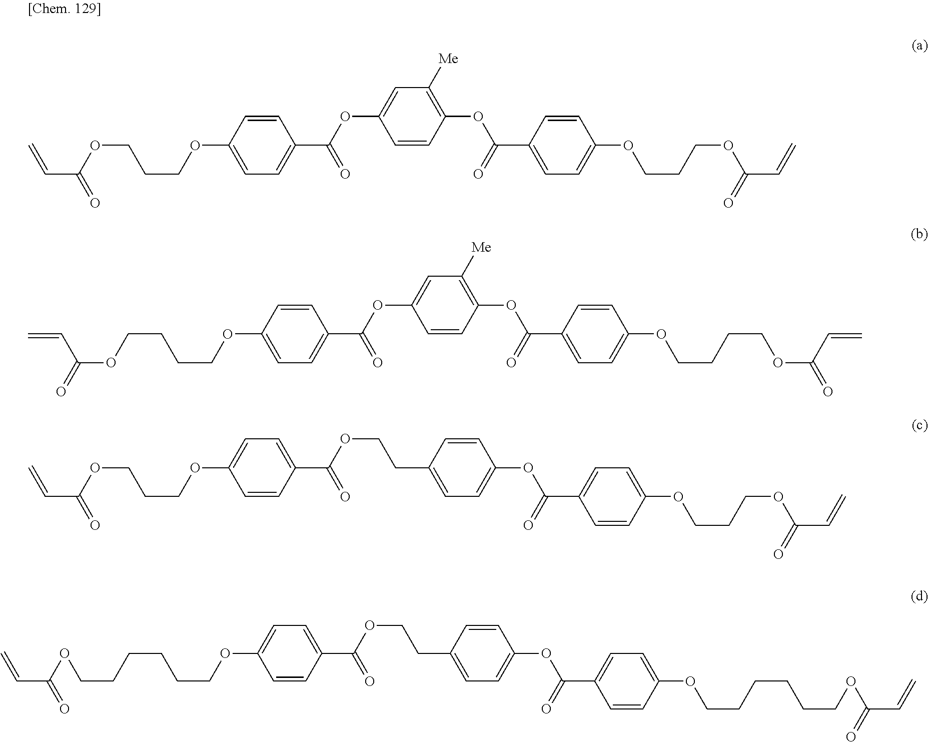

A glass substrate provided with a polyimide alignment film was used and two glass substrates were combined so that rubbing directions of the polyimide alignment films become parallel to each other, and thus, a glass cell was prepared. After injecting the liquid crystal composition into the glass cell, the film was cured by irradiation with ultraviolet light (illuminance: 800 mJ/cm²), and then the film was peeled off from the glass cell. Thereafter, “ne” and “no” of the film were measured with an Abbe refractometer, and a refractive index anisotropy (Δn) extrapolated such that the compound having a mesogenic group becomes 100% by mass was calculated.

A value of YI/Δn was calculated by dividing the yellowness index of each obtained mixture by the value of Δn of each compound.

<Measurement of Compound Content>

A content of the compound in each mixture containing the compound of the evaluation target was calculated. Each mixture and an internal standard substance were mixed precisely, and ¹H NMR was measured using a solution dissolved in a deuterium solvent. From the relationship between a peak area, a sample mass, and a molecular weight derived from the compound, and a peak area, a sample mass, and a molecular weight derived from the internal standard substance, the content of the compound in each mixture was calculated in the obtained spectrum. As the internal standard substance, a 1,4-BTMSB-d₄ standard substance or a DSS-d₆ standard substance (TraceSure manufactured by Wako Pure Chemical Industries, Ltd.) was used.

In Comparative Example 1, Comparative Example 3, and Comparative Example 6, the same purification method as that of the preparation method of each compound described in JP-A-2011-207765 was carried out. In Comparative Example 8, the same purification method as that of the preparation method of the compound described in JP-A-2010-031223 was carried out. In Comparative Example 9, the same purification method as that of the preparation method of the compound described in JP-A-2008-273925 was carried out. In Comparative Example 11, the same purification method as that of the preparation method of the compound described in JP-A-2008-107767 was carried out. In Comparative Example 13, the same purification method as that of the preparation method of the compound described in WO2014/010325 A1 was carried out. In Comparative Example 15, the same purification method as that of the preparation method of the compound described in WO2012/147904 A1 was carried out. YI/Δn, a yield from the crude material in the purification step, and a compound content of each mixture containing the compound of the evaluation target are shown in the table below.

TABLE 1

| | | | | | Purification | Compound |
|---|---|---|---|---|---|---|
| | Compound | Δn | YI | YI/Δn | yield | content |
| Comparative Example 1 | I-A-1 | 0.059 | 0.02 | 0.3 | 78% | 99.8% |
| Example 1 | | | 0.16 | 2.7 | 82% | 98.2% |
| Example 2 | | | 6.20 | 105.1 | 85% | 90.4% |
| Example 3 | | | 15.30 | 259.3 | 94% | 82.0% |
| Comparative Example 2 | | | 30.10 | 510.2 | 92% | 78.5% |
| Comparative Example 3 | I-A-2 | 0.059 | 0.02 | 0.3 | 62% | 99.9% |
| Example 4 | | | 0.12 | 2.0 | 68% | 99.7% |
| Example 5 | | | 0.40 | 6.8 | 70% | 97.2% |
| Example 6 | | | 15.00 | 254.2 | 94% | 92.0% |
| Comparative Example 4 | | | 29.70 | 503.4 | 90% | 85.6% |
| Comparative Example 5 | I-A-3 | 0.067 | 0.02 | 0.3 | 58% | 99.7% |
| Example 7 | | | 0.07 | 1.0 | 60% | 98.7% |
| Example 8 | | | 2.20 | 32.8 | 75% | 96.0% |
| Example 9 | | | 33.10 | 494.0 | 97% | 92.6% |
| Comparative Example 6 | | | 34.20 | 510.4 | 91% | 91.2% |
| Comparative Example 7 | I-A-4 | 0.056 | 0.02 | 0.4 | 66% | 99.8% |
| Example 10 | | | 0.04 | 0.7 | 67% | 99.4% |
| Example 11 | | | 8.40 | 150.0 | 88% | 94.6% |
| Example 12 | | | 27.50 | 491.1 | 98% | 92.1% |
| Comparative Example 8 | | | 28.70 | 512.5 | 97% | 91.0% |
| Comparative Example 9 | I-B-1 | 0.047 | 0.02 | 0.4 | 79% | 99.7% |
| Example 13 | | | 0.30 | 6.4 | 81% | 97.7% |
| Example 14 | | | 2.00 | 42.6 | 85% | 90.6% |
| Example 15 | | | 23.10 | 491.5 | 96% | 80.1% |
| Comparative Example 10 | | | 24.40 | 519.1 | 94% | 78.2% |

TABLE 2

| | | | | | Purification | Compound |
|---|---|---|---|---|---|---|
| | Compound | Δn | YI | YI/Δn | yield | content |
| Comparative Example 11 | I-B-2 | 0.046 | 0.02 | 0.4 | 54% | 99.8% |
| Example 16 | | | 0.03 | 0.7 | 56% | 99.6% |
| Example 17 | | | 4.20 | 91.3 | 67% | 97.6% |
| Example 18 | | | 22.10 | 480.4 | 97% | 79.2% |
| Comparative Example 12 | | | 23.70 | 515.2 | 96% | 77.1% |
| Comparative Example 13 | I-C-1 | 0.074 | 0.03 | 0.4 | 88% | 99.9% |
| Example 19 | | | 0.12 | 1.6 | 89% | 99.6% |
| Example 20 | | | 4.40 | 59.5 | 92% | 86.5% |
| Example 21 | | | 35.60 | 481.1 | 98% | 79.0% |
| Comparative Example 14 | | | 39.00 | 527.0 | 93% | 76.0% |
| Comparative Example 15 | I-C-2 | 0.105 | 0.04 | 0.4 | 71% | 99.7% |
| Example 22 | | | 0.20 | 1.9 | 73% | 97.8% |
| Example 23 | | | 5.50 | 52.4 | 82% | 85.1% |
| Example 24 | | | 52.00 | 495.2 | 96% | 78.0% |
| Comparative Example 16 | | | 55.20 | 525.7 | 95% | 76.0% |
| Comparative Example 17 | I-C-3 | 0.053 | 0.02 | 0.4 | 35% | 99.8% |
| Example 25 | | | 0.15 | 2.8 | 48% | 98.5% |
| Example 26 | | | 4.00 | 75.5 | 72% | 87.0% |
| Example 27 | | | 26.10 | 492.5 | 98% | 78.1% |
| Comparative Example 18 | | | 27.40 | 517.0 | 95% | 77.2% |
| Comparative Example 19 | I-C-4 | 0.056 | 0.02 | 0.4 | 12% | 99.8% |
| Example 28 | | | 0.04 | 0.7 | 75% | 99.6% |
| Example 29 | | | 2.00 | 35.7 | 80% | 91.0% |
| Example 30 | | | 8.10 | 144.6 | 96% | 80.4% |
| Comparative Example 20 | | | 28.70 | 512.5 | 96% | 75.0% |

From the tables, it can be understood that in Comparative Example 1, Comparative Example 3, Comparative Example 5, and the like in which the values of YI/Δn are smaller than 0.5, the purification yields are low to moderate yields. On the other hand, it can be understood that in the examples in which the values of YI/Δn are 0.5 or more, the yield increases as the value of YI/Δn increases, while in Comparative Example 2, Comparative Example 4, Comparative Example 6, and the like in which the values of YI/Δn are greater than 500, the yield decreases. In any of the above mixtures, in the mixture of which the values of YI/Δn are 0.5 or more and 500 or less, a decrease in yield could be suppressed.

### Examples 31 to 57 and Comparative Examples 21 to 38

The polyimide solution of the alignment film was applied onto a glass substrate having a thickness of 0.7 mm by a spin coating method, dried at 100° C. for 10 minutes, and then baked at 200° C. for 60 minutes, and thus, a coating film was obtained. The obtained coating film was subjected to a rubbing treatment. The rubbing treatment was performed using a commercially available rubbing apparatus.

A coating solution was prepared by adding 1% of a photopolymerization initiator, IRGACURE 907 (manufactured by BASF SE), 0.1% of 4-methoxyphenol, and 80% of chloroform to each mixture containing the compound of the evaluation target. This coating solution was applied onto a rubbed glass substrate by a spin coating method, dried for 2 minutes at the temperature shown in the table below, and irradiated with ultraviolet light at an intensity of 40 mW/cm² for 25 seconds using a high pressure mercury lamp, thereby preparing a film of the evaluation target. Thus, 20 sheets of the films of the evaluation target were prepared for each mixture. For evaluating a repellence degree, ten sheets of the 20 sheets of the films prepared were used.

Next, the remaining ten films of the 20 sheets of the films prepared were irradiated with light of 100 J at 50 mW/cm² at 25° C. using a xenon lamp irradiation tester (SUNTEST XLS manufactured by Atlas). For each of the obtained films, alignment defects were evaluated.

<Evaluation on Repellence Degree>

Each of the ten sheets of the films prepared was divided into regions of 10 squares×10 squares, and by observing with a polarized light microscopy, the number (%) of squares in which the repellence occurred was generated is measured, and an average value of the numbers with respect to the ten sheets was calculated.

<Alignment Defect>

With respect to each of the ten sheets of the films prepared, the number of alignment defects generated was measured with a polarized light microscopy, and the total thereof was calculated.

The evaluation was not carried out on the compound represented by Formula (I-C-3), because the compound did not exhibit a liquid crystal phase by itself. Values of YI/Δn are values which are measured by the measurement method described in <Measurement of YI/Δn> above, with respect to the mixture containing the compound of the evaluation target. The results are shown in the tables below.

TABLE 3

| | | Drying | | | Alignment |
|---|---|---|---|---|---|
| | Compound | temperature | YI/Δn | Repellence | defect |
| Comparative | I-A-1 | 140° C. | 0.3 | 1.1% | 6 |
| Example 21 | | | | | |
| Example 31 | | | 2.7 | 0.4% | 3 |
| Example 32 | | | 105.1 | 0.0% | 0 |
| Example 33 | | | 259.3 | 0.6% | 4 |
| Comparative | | | 510.2 | 2.2% | 13 |
| Example 22 | | | | | |
| Comparative | I-A-2 | 150° C. | 0.3 | 1.5% | 16 |
| Example 23 | | | | | |
| Example 34 | | | 2.0 | 0.4% | 4 |
| Example 35 | | | 6.8 | 0.0% | 1 |
| Example 36 | | | 254.2 | 0.3% | 5 |
| Comparative | | | 503.4 | 1.3% | 12 |
| Example 24 | | | | | |
| Comparative | I-A-3 | 220° C. | 0.3 | 1.2% | 8 |
| Example 25 | | | | | |
| Example 37 | | | 1.0 | 0.8% | 3 |
| Example 38 | | | 32.8 | 0.1% | 1 |
| Example 39 | | | 494.0 | 0.7% | 5 |
| Comparative | | | 510.4 | 2.4% | 14 |
| Example 26 | | | | | |
| Comparative | I-A-4 | 80° C. | 0.4 | 1.9% | 15 |
| Example 27 | | | | | |
| Example 40 | | | 0.7 | 0.5% | 3 |
| Example 41 | | | 150.0 | 0.0% | 2 |
| Example 42 | | | 491.1 | 0.7% | 9 |
| Comparative | | | 512.5 | 3.4% | 13 |
| Example 28 | | | | | |
| Comparative | I-B-1 | 140° C. | 0.4 | 2.2% | 12 |
| Example 29 | | | | | |
| Example 43 | | | 6.4 | 0.4% | 4 |
| Example 44 | | | 42.6 | 0.0% | 0 |
| Example 45 | | | 491.5 | 1.8% | 3 |
| Comparative | | | 519.1 | 3.0% | 17 |
| Example 30 | | | | | |

TABLE 4

| | | Drying | | | Alignment |
|---|---|---|---|---|---|
| | Compound | temperature | YI/Δn | Repellence | defect |
| Comparative | I-B-2 | 140° C. | 0.4 | 1.4% | 7 |
| Example 31 | | | | | |
| Example 46 | | | 0.7 | 0.6% | 5 |
| Example 47 | | | 91.3 | 0.1% | 1 |
| Example 48 | | | 480.4 | 0.8% | 3 |
| Comparative | | | 515.2 | 3.5% | 16 |
| Example 32 | | | | | |
| Comparative | I-C-1 | 120° C. | 0.4 | 1.1% | 11 |
| Example 33 | | | | | |
| Example 49 | | | 1.6 | 0.8% | 3 |
| Example 50 | | | 59.5 | 0.1% | 0 |
| Example 51 | | | 481.1 | 0.7% | 5 |
| Comparative | | | 527.0 | 1.7% | 14 |
| Example 34 | | | | | |
| Comparative | I-C-2 | 100° C. | 0.4 | 1.3% | 7 |
| Example 35 | | | | | |
| Example 52 | | | 1.9 | 0.4% | 4 |
| Example 53 | | | 52.4 | 0.0% | 2 |
| Example 54 | | | 495.2 | 0.9% | 3 |
| Comparative | | | 525.7 | 4.1% | 19 |
| Example 36 | | | | | |
| Comparative | I-C-4 | 100° C. | 0.4 | 1.7% | 16 |
| Example 37 | | | | | |
| Example 55 | | | 2.8 | 0.3% | 4 |
| Example 56 | | | 75.5 | 0.0% | 0 |
| Example 57 | | | 492.5 | 0.9% | 4 |
| Comparative | | | 517.0 | 2.5% | 15 |
| Example 38 | | | | | |

It can be understood from the above table that the repellence is unlikely to be generated and the alignment defects after irradiation with light occur less in the films of the present invention.

<Preparation of Host Liquid Crystal>

Host liquid crystals (X-A) to (X-E) each were produced by mixing some of compounds represented by Formulas (X-1-1) to (X-1-6) and Formulas (X-2-1) to (X-2-4) according to the ratio shown in the table below. A yellowness index of each host liquid crystal was obtained by dissolving the host liquid crystal in acetonitrile so as to become a 20 ppm solution. The solution was put into a transparent cell having an optical path length of 1 cm, and the yellowness index was calculated using a spectrophotometer. The value obtained by the measurement was divided by a refractive index anisotropy (Δn) of the host liquid crystal, thereby obtaining YI/Δn of the host liquid crystal.

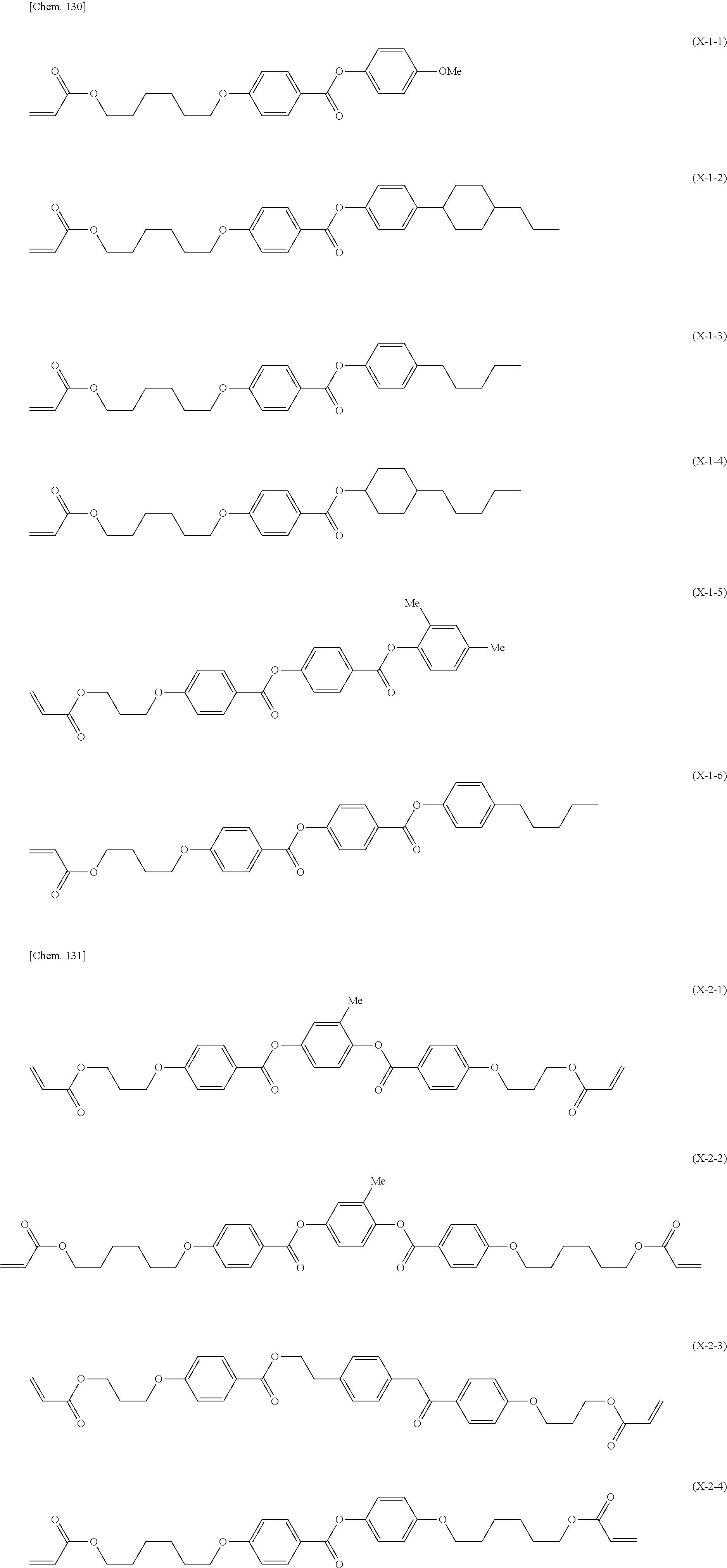

TABLE 5

| | Host liquid crystal | | | | |
|---|---|---|---|---|---|
| Compound | X-A | X-B | X-C | X-D | X-E |
| X-1-1 | 30% | | | | |
| X-1-2 | 10% | | | 20% | |
| X-1-3 | | 30% | | 20% | |
| X-1-4 | | 30% | 20% | | |
| X-1-5 | | | | | 20% |
| X-1-6 | | | 20% | | |
| X-2-1 | 30% | 10% | 30% | 30% | 30% |
| X-2-2 | 30% | | 30% | 30% | |
| X-2-3 | | 30% | | | |
| X-2-4 | | | | | 50% |
| YI of composition | 0.01 | 0.01 | 0.01 | 0.01 | 0.01 |
| Δn of composition | 0.148 | 0.139 | 0.160 | 0.153 | 0.154 |
| YI/Δn of composition | 0.1 | 0.1 | 0.1 | 0.1 | 0.1 |

### Examples 58 to 72 and Comparative Examples 39 to 48

The polyimide solution of the alignment film was applied onto a glass substrate having a thickness of 0.7 mm by a spin coating method, dried at 100° C. for 10 minutes, and then baked at 200° C. for 60 minutes, and thus, a coating film was obtained. The obtained coating film was subjected to the rubbing treatment. The rubbing treatment was performed using a commercially available rubbing apparatus.

30% of a mixture containing the compound represented by Formula (I-A-1), 50% of a mixture containing the compound represented by Formula (I-A-2), 30% of a mixture containing the compound represented by Formula (I-A-3), 40% of a mixture containing the compound represented by Formula (I-B-1), or 15% of a mixture containing the compound represented by Formula (I-C-1) was respectively added to the host liquid crystal (X-A), and thus, the following liquid crystal compositions were obtained. 3% of a photopolymerization initiator, IRGACURE 907 (manufactured by BASF SE), 0.1% of 4-methoxyphenol, and 80% of chloroform were added to each of the obtained liquid crystal compositions, and thus, a coating solution was prepared. This coating solution was applied onto the rubbed glass substrate by a spin coating method, dried for 2 minutes at the temperature shown in the table below, and irradiated with ultraviolet light at an intensity of 40 mW/cm² for 25 seconds using a high pressure mercury lamp, thereby preparing a film of the evaluation target. Repellence degree and alignment defect of each of the obtained films were evaluated by the same method as described above. Values of YI/Δn are values which are measured by the measurement method described in <Measurement of YI/Δn> above, with respect to the mixture containing the compound of the evaluation target (hereinafter, the same applies). The results are shown in the tables below.

TABLE 6

| | | Drying | | Amount | | Alignment |
|---|---|---|---|---|---|---|
| | Compound | temperature | YI/Δn | added | Repellence | defect |
| Host liquid crystal X-A | Blank | 80° C. | 8.9 | | 0.0% | 0 |
| Comparative Example 39 | I-A-1 | 80° C. | 0.3 | 30% | 1.8% | 6 |
| Example 58 | | | 2.7 | 30% | 0.5% | 5 |
| Example 59 | | | 105.1 | 30% | 0.1% | 0 |
| Example 60 | | | 259.3 | 30% | 0.5% | 3 |
| Comparative Example 40 | | | 510.2 | 30% | 2.6% | 13 |
| Comparative Example 41 | I-A-2 | 80° C. | 0.3 | 50% | 1.2% | 11 |
| Example 61 | | | 2.0 | 50% | 0.4% | 4 |
| Example 62 | | | 6.8 | 50% | 0.0% | 1 |
| Example 63 | | | 254.2 | 50% | 0.8% | 5 |
| Comparative Example 42 | | | 503.4 | 50% | 1.1% | 15 |
| Comparative Example 43 | I-A-3 | 80° C. | 0.3 | 30% | 1.4% | 9 |
| Example 64 | | | 1.0 | 30% | 0.4% | 5 |
| Example 65 | | | 32.8 | 30% | 0.1% | 2 |
| Example 66 | | | 494.0 | 30% | 0.9% | 4 |
| Comparative Example 44 | | | 510.4 | 30% | 3.0% | 16 |
| Comparative Example 45 | I-B-1 | 80° C. | 0.4 | 40% | 2.0% | 12 |
| Example 67 | | | 6.4 | 40% | 0.9% | 3 |
| Example 68 | | | 42.6 | 40% | 0.0% | 1 |
| Example 69 | | | 491.5 | 40% | 0.8% | 7 |
| Comparative Example 46 | | | 519.1 | 40% | 3.0% | 14 |
| Comparative Example 47 | I-C-1 | 80° C. | 0.4 | 15% | 2.1% | 12 |
| Example 70 | | | 1.6 | 15% | 0.8% | 4 |
| Example 71 | | | 59.5 | 15% | 0.1% | 2 |
| Example 72 | | | 481.1 | 15% | 1.2% | 5 |
| Comparative Example 48 | | | 527.0 | 15% | 3.2% | 14 |

It can be understood from the above table that the repellence is unlikely to be generated and the alignment defects after irradiation with light occur less in the films of the present invention.

### Examples 73 to 87 and Comparative Examples 49 to 58

5% of a mixture containing the compound represented by Formula (I-A-4), 10% of a mixture containing the compound represented by Formula (I-B-2), 20% of the mixture containing the compound represented by Formula (I-C-2), 60% of a mixture containing the compound represented by Formula (I-C-3), or 30% of a mixture containing the compound represented by Formula (I-C-4) was respectively added to the host liquid crystal (X—B), and thus, the following liquid crystal compositions were obtained. Films of the evaluation target were prepared by the same method as described above, and repellence degree and alignment defect thereof were evaluated. The results are shown in the table below.

TABLE 7

| | | Drying | | Amount | | Alignment |
|---|---|---|---|---|---|---|
| | Compound | temperature | YI/Δn | added | Repellence | defect |
| Host liquid crystal X-B | Blank | 80° C. | 8.6 | | 0.0% | 1 |
| Comparative Example 49 | I-A-4 | 80° C. | 0.4 | 5% | 1.1% | 12 |
| Example 73 | | | 0.7 | 5% | 0.4% | 3 |
| Example 74 | | | 150.0 | 5% | 0.2% | 0 |
| Example 75 | | | 491.1 | 5% | 0.5% | 7 |
| Comparative Example 50 | | | 512.5 | 5% | 2.5% | 12 |
| Comparative Example 51 | I-B-2 | 80° C. | 0.4 | 10% | 1.1% | 6 |
| Example 76 | | | 0.7 | 10% | 0.4% | 3 |
| Example 77 | | | 91.3 | 10% | 0.0% | 1 |
| Example 78 | | | 480.4 | 10% | 0.3% | 8 |
| Comparative Example 52 | | | 515.2 | 10% | 2.6% | 14 |
| Comparative Example 53 | I-C-2 | 80° C. | 0.4 | 20% | 2.2% | 12 |
| Example 79 | | | 1.9 | 20% | 0.3% | 5 |
| Example 80 | | | 52.4 | 20% | 0.2% | 2 |
| Example 81 | | | 495.2 | 20% | 1.8% | 5 |
| Comparative Example 54 | | | 525.7 | 20% | 2.5% | 12 |
| Comparative Example 55 | I-C-3 | 80° C. | 0.4 | 60% | 1.3% | 7 |
| Example 82 | | | 2.8 | 60% | 0.6% | 5 |
| Example 83 | | | 75.5 | 60% | 0.1% | 2 |
| Example 84 | | | 492.5 | 60% | 0.3% | 8 |
| Comparative Example 56 | | | 517.0 | 60% | 4.6% | 15 |
| Comparative Example 57 | I-C-4 | 80° C. | 0.4 | 30% | 2.1% | 13 |
| Example 85 | | | 0.7 | 30% | 0.6% | 4 |
| Example 86 | | | 35.7 | 30% | 0.0% | 1 |
| Example 87 | | | 144.6 | 30% | 1.8% | 3 |
| Comparative Example 58 | | | 512.5 | 30% | 2.8% | 16 |

It can be understood from the above table that the repellence is unlikely to be generated and the alignment defects after irradiation with light occur less in the films of the present invention.

### Examples 88 to 102 and Comparative Examples 59 to 68

30% of a mixture containing the compound represented by Formula (I-A-2), 10% of a mixture containing the compound represented by Formula (I-A-3), 50% of a mixture containing the compound represented by Formula (I-B-1), 10% of a mixture containing the compound represented by Formula (I-C-1), or 55% of a mixture containing the compound represented by Formula (I-C-2) was respectively added to the host liquid crystal (X—C), and thus, the following liquid crystal compositions were obtained. Films of the evaluation target were prepared by the same method as described above, and repellence degrees and alignment defects thereof were evaluated. The results are shown in the table below.

TABLE 8

| | | Drying | | Amount | | Alignment |
|---|---|---|---|---|---|---|
| | Compound | temperature | YI/Δn | added | Repellence | defect |
| Host liquid crystal X-C | Blank | 80° C. | 8.3 | | 0.0% | 0 |
| Comparative Example 59 | I-A-2 | 80° C. | 0.3 | 30% | 1.1% | 15 |
| Example 88 | | | 2.0 | 30% | 0.3% | 4 |
| Example 89 | | | 6.8 | 30% | 0.0% | 1 |
| Example 90 | | | 254.2 | 30% | 0.4% | 4 |
| Comparative Example 60 | | | 503.4 | 30% | 1.6% | 17 |
| Comparative Example 61 | I-A-3 | 80° C. | 0.3 | 10% | 1.3% | 12 |
| Example 91 | | | 1.0 | 10% | 0.6% | 4 |
| Example 92 | | | 32.8 | 10% | 0.2% | 1 |
| Example 93 | | | 494.0 | 10% | 0.9% | 6 |
| Comparative Example 62 | | | 510.4 | 10% | 2.9% | 16 |
| Comparative Example 63 | I-B-1 | 80° C. | 0.4 | 50% | 1.8% | 8 |
| Example 94 | | | 6.4 | 50% | 0.7% | 5 |
| Example 95 | | | 42.6 | 50% | 0.2% | 2 |
| Example 96 | | | 491.5 | 50% | 0.9% | 4 |
| Comparative Example 64 | | | 519.1 | 50% | 6.7% | 19 |
| Comparative Example 65 | I-C-1 | 80° C. | 0.4 | 10% | 2.7% | 15 |
| Example 97 | | | 1.6 | 10% | 0.8% | 5 |
| Example 98 | | | 59.5 | 10% | 0.0% | 1 |
| Example 99 | | | 481.1 | 10% | 1.2% | 3 |
| Comparative Example 66 | | | 527.0 | 10% | 2.6% | 16 |
| Comparative Example 67 | I-C-2 | 80° C. | 0.4 | 55% | 1.9% | 8 |
| Example 100 | | | 1.9 | 55% | 0.7% | 3 |
| Example 101 | | | 52.4 | 55% | 0.2% | 1 |
| Example 102 | | | 495.2 | 55% | 0.8% | 7 |
| Comparative Example 68 | | | 525.7 | 55% | 5.4% | 17 |

It can be understood from the above table that the repellence is unlikely to be generated and the alignment defects after irradiation with light occur less in the films of the present invention.

### Examples 103 to 117 and Comparative Examples 69 to 78

70% of a mixture containing a compound represented by Formula (I-A-4), 50% of a mixture containing a compound represented by Formula (I-B-2), 90% of a mixture containing the compound represented by Formula (I-C-1), 5% of a mixture containing the compound represented by Formula (I-C-3), or 25% of a mixture containing the compound represented by Formula (I-C-4) was respectively added to the host liquid crystal (X-D), and thus, the following liquid crystal compositions were obtained. Films of the evaluation target were prepared by the same method as described above, and repellence degrees and alignment defects thereof were evaluated. The results are shown in the table below.

TABLE 9

| | | Drying | | Amount | | Alignment |
|---|---|---|---|---|---|---|
| | Compound | temperature | YI/Δn | added | Repellence | defect |
| Host liquid crystal X-D | Blank | 80° C. | 8.6 | | 0.0% | 0 |
| Comparative Example 69 | I-A-4 | 80° C. | 0.4 | 70% | 1.8% | 9 |
| Example 103 | | | 0.7 | 70% | 0.9% | 4 |
| Example 104 | | | 150.0 | 70% | 0.2% | 2 |
| Example 105 | | | 491.1 | 70% | 0.7% | 5 |
| Comparative Example 70 | | | 512.5 | 70% | 7.0% | 14 |
| Comparative Example 71 | I-B-2 | 80° C. | 0.4 | 50% | 1.6% | 7 |
| Example 106 | | | 0.7 | 50% | 0.8% | 4 |
| Example 107 | | | 91.3 | 50% | 0.1% | 1 |
| Example 108 | | | 480.4 | 50% | 0.7% | 8 |
| Comparative Example 72 | | | 515.2 | 50% | 4.4% | 16 |
| Comparative Example 73 | I-C-1 | 80° C. | 0.4 | 90% | 7.8% | 13 |
| Example 109 | | | 1.6 | 90% | 0.7% | 4 |
| Example 110 | | | 59.5 | 90% | 0.2% | 2 |
| Example 111 | | | 481.1 | 90% | 1.7% | 5 |
| Comparative Example 74 | | | 527.0 | 90% | 7.5% | 21 |
| Comparative Example 75 | I-C-3 | 80° C. | 0.4 | 5% | 1.3% | 6 |
| Example 112 | | | 2.8 | 5% | 0.4% | 3 |
| Example 113 | | | 75.5 | 5% | 0.0% | 0 |
| Example 114 | | | 492.5 | 5% | 0.3% | 3 |
| Comparative Example 76 | | | 517.0 | 5% | 2.9% | 13 |
| Comparative Example 77 | I-C-4 | 80° C. | 0.4 | 25% | 1.3% | 14 |
| Example 115 | | | 0.7 | 25% | 0.4% | 3 |
| Example 116 | | | 35.7 | 25% | 0.1% | 1 |
| Example 117 | | | 144.6 | 25% | 0.8% | 9 |
| Comparative Example 78 | | | 512.5 | 25% | 4.1% | 17 |

It can be understood from the above table that the repellence is unlikely to be generated and the alignment defects after irradiation with light occur less in the films of the present invention.

### Examples 118 to 132 and Comparative Examples 79 to 88

50% of a mixture containing the compound represented by Formula (I-A-2), 40% of a mixture containing a compound represented by Formula (I-A-3), 60% of a mixture containing the compound represented by Formula (I-A-4), 15% of a mixture containing the compound represented by Formula (I-C-3), and 5% of a mixture containing the compound represented by Formula (I-C-4) was respectively added to the host liquid crystal (X-E), and thus, the following liquid crystal compositions were obtained. Films of the evaluation target were prepared by the same method as described above, and repellence degree and alignment defect thereof were evaluated. The results are shown in the table below.

TABLE 10

| | | Drying | | Amount | | Alignment |
|---|---|---|---|---|---|---|
| | Compound | temperature | YI/Δn | added | Repellence | defect |
| Host liquid crystal X-E | Blank | 80° C. | 9.1 | | 0.0% | 1 |
| Comparative Example 79 | I-A-2 | 80° C. | 0.3 | 50% | 1.3% | 15 |
| Example 118 | | | 2.0 | 50% | 0.6% | 4 |
| Example 119 | | | 6.8 | 50% | 0.1% | 1 |
| Example 120 | | | 254.2 | 50% | 0.7% | 5 |
| Comparative Example 80 | | | 503.4 | 50% | 1.9% | 16 |
| Comparative Example 81 | I-A-3 | 80° C. | 0.3 | 40% | 2.0% | 18 |
| Example 121 | | | 1.0 | 40% | 0.7% | 5 |
| Example 122 | | | 32.8 | 40% | 0.1% | 1 |
| Example 123 | | | 494.0 | 40% | 0.4% | 6 |
| Comparative Example 82 | | | 510.4 | 40% | 3.5% | 17 |
| Comparative Example 83 | I-A-4 | 80° C. | 0.4 | 60% | 1.8% | 6 |
| Example 124 | | | 0.7 | 60% | 0.7% | 3 |
| Example 125 | | | 150.0 | 60% | 0.1% | 0 |
| Example 126 | | | 491.1 | 60% | 0.4% | 7 |
| Comparative Example 84 | | | 512.5 | 60% | 4.1% | 14 |
| Comparative Example 85 | I-C-3 | 80° C. | 0.4 | 15% | 3.0% | 12 |
| Example 127 | | | 2.8 | 15% | 0.6% | 3 |
| Example 128 | | | 75.5 | 15% | 0.0% | 0 |
| Example 129 | | | 492.5 | 15% | 1.2% | 5 |
| Comparative Example 86 | | | 517.0 | 15% | 2.3% | 16 |
| Comparative Example 87 | I-C-4 | 80° C. | 0.4 | 5% | 1.1% | 6 |
| Example 130 | | | 0.7 | 5% | 0.3% | 3 |
| Example 131 | | | 35.7 | 5% | 0.0% | 0 |
| Example 132 | | | 144.6 | 5% | 0.4% | 3 |
| Comparative Example 88 | | | 512.5 | 5% | 2.5% | 11 |

It can be understood from the above table that the repellence is unlikely to be generated and the alignment defects after irradiation with light occur less in the films of the present invention.

### Examples 133 to 156 and Comparative Examples 89 to 104

Evaluation on repellence degree and evaluation on alignment defect were carried out in the same manner as in Examples 31 to 57 and Comparative Examples 21 to 38. The results are shown in the table below.

TABLE 11

| | | Drying | | | Alignment |
|---|---|---|---|---|---|
| | Compound | temperature | YI/Δn | Repellence | defect |
| Comparative | I-A-5 | 80° C. | 0.4 | 1.8% | 14 |
| Example 89 | | | | | |
| Example 133 | | | 0.9 | 0.6% | 4 |
| Example 134 | | | 180.4 | 0.1% | 3 |
| Example 135 | | | 473.2 | 0.7% | 10 |
| Comparative | | | 508.9 | 2.5% | 15 |
| Example 90 | | | | | |
| Comparative | I-B-3 | 120° C. | 0.4 | 1.5% | 6 |
| Example 91 | | | | | |
| Example 136 | | | 0.7 | 0.7% | 5 |
| Example 137 | | | 113.0 | 0.1% | 1 |
| Example 138 | | | 460.9 | 0.9% | 3 |
| Comparative | | | 502.2 | 3.4% | 15 |
| Example 92 | | | | | |
| Comparative | I-B-4 | 120° C. | 0.4 | 1.4% | 7 |
| Example 93 | | | | | |
| Example 139 | | | 0.9 | 0.7% | 4 |
| Example 140 | | | 119.6 | 0.1% | 1 |
| Example 141 | | | 439.1 | 0.9% | 5 |
| Comparative | | | 532.6 | 3.3% | 17 |
| Example 94 | | | | | |
| Comparative | I-C-5 | 80° C. | 0.4 | 2.3% | 12 |
| Example 95 | | | | | |
| Example 142 | | | 1.1 | 0.9% | 4 |
| Example 143 | | | 44.6 | 0.1% | 0 |
| Example 144 | | | 180.4 | 1.6% | 4 |
| Comparative | | | 501.8 | 3.1% | 15 |
| Example 96 | | | | | |
| Comparative | I-C-6 | 80° C. | 0.4 | 2.3% | 14 |
| Example 97 | | | | | |
| Example 145 | | | 0.9 | 1.0% | 3 |
| Example 146 | | | 37.5 | 0.0% | 1 |
| Example 147 | | | 162.5 | 1.6% | 4 |
| Comparative | | | 517.9 | 3.2% | 15 |
| Example 98 | | | | | |

TABLE 12

| | | Drying | | | Alignment |
|---|---|---|---|---|---|
| | Compound | temperature | YI/Δn | Repellence | defect |
| Comparative | I-C-7 | 80° C. | 0.4 | 2.2% | 16 |
| Example 99 | | | | | |
| Example 148 | | | 1.3 | 1.0% | 3 |
| Example 149 | | | 41.1 | 0.1% | 1 |
| Example 150 | | | 157.1 | 1.6% | 5 |
| Comparative | | | 535.7 | 3.1% | 17 |
| Example 100 | | | | | |
| Comparative | I-C-8 | 80° C. | 0.4 | 2.3% | 16 |
| Example 101 | | | | | |
| Example 151 | | | 1.1 | 0.9% | 5 |
| Example 152 | | | 41.1 | 0.1% | 2 |
| Example 153 | | | 164.3 | 1.9% | 5 |
| Comparative | | | 508.9 | 2.5% | 19 |
| Example 102 | | | | | |
| Comparative | I-C-9 | 80° C. | 0.4 | 2.6% | 18 |
| Example 103 | | | | | |
| Example 154 | | | 0.9 | 0.7% | 5 |
| Example 155 | | | 55.4 | 0.0% | 2 |
| Example 156 | | | 80.4 | 1.5% | 5 |
| Comparative | | | 508.9 | 3.0% | 17 |
| Example 104 | | | | | |

It can be understood from the above table that the repellence is unlikely to be generated and the alignment defects after irradiation with light occur less in the films of the present invention.

### Examples 157 to 180 and Comparative Examples 105 to 120

50% of a mixture containing the compound represented by Formula (I-A-5), 40% of a mixture containing the compound represented by Formula (I-B-3), 60% of a mixture containing the compound represented by Formula (I-B-4), 15% of a mixture containing the compound represented by Formula (I-C-5), 5% of a mixture containing the compound represented by Formula (I-C-6), 15% of a mixture containing the compound represented by Formula (I-C-7), 5% of a mixture containing the compound represented by Formula (I-C-8), or 15% of a mixture containing the compound represented by Formula (I-C-9) was respectively added to the host liquid crystal (X-E), and thus, the following liquid crystal compositions were obtained. Films of the evaluation target were prepared by the same method as described above, and repellence degrees and alignment defects thereof were evaluated. The results are shown in the table below.

TABLE 13

| | | Drying | | Amount | | Alignment |
|---|---|---|---|---|---|---|
| | Compound | temperature | YI/Δn | added | Repellence | defect |
| Host liquid crystal X-E | Blank | 80° C. | 0.1 | | 0.0% | 1 |
| Comparative Example 105 | I-A-5 | 80° C. | 0.4 | 50% | 1.5% | 12 |
| Example 157 | | | 0.9 | 50% | 0.8% | 5 |
| Example 158 | | | 180.4 | 50% | 0.1% | 1 |
| Example 159 | | | 473.2 | 50% | 0.7% | 5 |
| Comparative Example 106 | | | 508.9 | 50% | 1.6% | 13 |
| Comparative Example 107 | I-B-3 | 80° C. | 0.4 | 40% | 1.6% | 15 |
| Example 160 | | | 0.7 | 40% | 0.6% | 4 |
| Example 161 | | | 113.0 | 40% | 0.1% | 1 |
| Example 162 | | | 460.9 | 40% | 0.4% | 7 |
| Comparative Example 108 | | | 502.2 | 40% | 2.9% | 16 |
| Comparative Example 109 | I-B-4 | 80° C. | 0.4 | 60% | 1.5% | 7 |
| Example 163 | | | 0.9 | 60% | 0.6% | 3 |
| Example 164 | | | 119.6 | 60% | 0.1% | 0 |
| Example 165 | | | 439.1 | 60% | 0.4% | 8 |
| Comparative Example 110 | | | 532.6 | 60% | 3.6% | 12 |
| Comparative Example 111 | I-C-5 | 80° C. | 0.4 | 15% | 2.2% | 13 |
| Example 166 | | | 1.1 | 15% | 0.6% | 3 |
| Example 167 | | | 44.6 | 15% | 0.0% | 0 |
| Example 168 | | | 180.4 | 15% | 1.3% | 5 |
| Comparative Example 112 | | | 501.8 | 15% | 2.4% | 14 |
| Comparative Example 113 | I-C-6 | 80° C. | 0.4 | 5% | 1.2% | 7 |
| Example 169 | | | 0.9 | 5% | 0.3% | 3 |
| Example 170 | | | 37.5 | 5% | 0.1% | 1 |
| Example 171 | | | 162.5 | 5% | 0.4% | 4 |
| Comparative Example 114 | | | 517.9 | 5% | 2.3% | 11 |

TABLE 14

| | | Drying | | Amount | | Alignment |
|---|---|---|---|---|---|---|
| | Compound | temperature | YI/Δn | added | Repellence | defect |
| Host liquid crystal X-E | Blank | 80° C. | 0.1 | | 0.0% | 1 |
| Comparative Example 115 | I-C-7 | 80° C. | 0.4 | 15% | 2.8% | 15 |
| Example 172 | | | 1.3 | 15% | 0.7% | 5 |
| Example 173 | | | 41.1 | 15% | 0.2% | 2 |
| Example 174 | | | 157.1 | 15% | 1.6% | 4 |
| Comparative Example 116 | | | 535.7 | 15% | 2.6% | 16 |
| Comparative Example 117 | I-C-8 | 80° C. | 0.4 | 5% | 1.9% | 10 |
| Example 175 | | | 1.1 | 5% | 0.9% | 4 |
| Example 176 | | | 41.1 | 5% | 0.2% | 1 |
| Example 177 | | | 164.3 | 5% | 0.9% | 4 |
| Comparative Example 118 | | | 508.9 | 5% | 2.5% | 13 |
| Comparative Example 119 | I-C-9 | 80° C. | 0.4 | 15% | 2.4% | 12 |
| Example 178 | | | 0.9 | 15% | 0.8% | 3 |
| Example 179 | | | 55.4 | 15% | 0.2% | 0 |
| Example 180 | | | 80.4 | 15% | 1.9% | 5 |
| Comparative Example 120 | | | 508.9 | 15% | 2.6% | 15 |

It can be understood from the above table that the repellence is unlikely to be generated and the alignment defects after irradiation with light occur less in the films of the present invention.

Based on the above results, it can be understood that in the mixture of which the value of YI/Δn is 0.5 or more and 500 or less, the generation of the repellence is suppressed and the alignment properties after irradiation with light are favorable.

1. A mixture comprising a compound which is reverse wavelength dispersive or low wavelength dispersive and has at least one mesogenic group, the mixture satisfying Expression (1):
0.5≤YI/Δn≤500 Expression (1)
wherein YI represents a yellowness index of the compound and Δn represents a refractive index anisotropy at a wavelength of 550 nm in the case of being formed into a film.

2. The mixture according to claim 1,
wherein the compound having a mesogenic group has a polymerizable group.

3. A composition comprising the mixture according to claim 1.

4. A composition comprising the mixture according to claim 1,
wherein a total content of the mixture is 5.0% by mass to 90.0% by mass.

5. A liquid crystal composition comprising the mixture according to claim 1.

6. A polymer obtained by polymerizing a polymerizable composition containing the mixture according to claim 1.

7. An optically anisotropic body obtained by polymerizing a polymerizable composition containing the mixture according to claim 1.

8. A phase difference film obtained by polymerizing a polymerizable composition containing the mixture according to claim 1.

9. A display device having the optically anisotropic body according to claim 7.

10. An optical element having the optically anisotropic body according to claim 7.

11. A light-emitting device having the optically anisotropic body according to claim 7.

12. A printed material having the optically anisotropic body according to claim 7.

13. An optical information recording apparatus having the optically anisotropic body according to claim 7.
